(19) United States
(12) Patent Application Publication
(10) Pub. No.: US 2022/0368180 A1
(43) Pub. Date: Nov. 17, 2022

(54) UNIQUE METHOD OF HARNESSING ENERGY FROM THE MAGNETIC DOMAINS FOUND IN FERROMAGNETIC AND PARAMAGNETIC MATERIALS

(71) Applicant: HOLCOMB SCIENTIFIC RESEARCH LIMITED, DUBLIN (IE)

(72) Inventor: ROBERT RAY HOLCOMB, SARASOTA, FL (US)

(21) Appl. No.: 17/765,992

(22) PCT Filed: Oct. 4, 2019
(86) PCT No.: PCT/EP2019/076967

§ 371 Date: Apr. 1, 2022

(51) Int. Cl. H02K 1/24; H02K 3/18; H02K 16/04; H02K 19/16

(52) U.S. Cl. CPC H02K 1/24; H02K 3/18; H02K 16/04; H02K 19/16

(57) ABSTRACT

The present disclosure relates to a power generator and method of generating AC or DC power, including the removal of reverse torque and utilizing the electromagnetic coils of a generator stator to harvest the inherent energy available in the magnetic domains of ferromagnetic and paramagnetic materials of pole pieces of a generator rotor. The method comprises: determining an excitation cycle based on a target frequency of the power generator; executing the excitation cycle by providing a current to one or more wires of the generator according to a predefined sequence to align magnetic domains of the salient pole pieces of the generator rotor to produce an evolving magnetic flux field; and routing a resultant current, generated by the magnetic flux field, to a power output. Systems and apparatuses disclosed herein comprise means for carrying out the same.

### FIELD OF THE INVENTION

Systems and methods of generation of an electric alternating current (AC) or direct current (DC) by the removal of reverse torque from an electric power generating machine and utilizing the electromagnetic coils of a rotor and stator to harvest the inherent energy available in the rotor magnetic domains of ferromagnetic and paramagnetic materials.

### BACKGROUND

Rapid depletion of the earth's fossil fuel sources along with environmental pollution of land, air and water with simultaneous climate changes makes obvious the clear and urgent need for alternative energy supplies which are efficient, require no fossil fuels and are non-polluting.

All standard generators in use today require by definition, 1 horsepower of kinetic energy input to generate 746 watts of electrical energy.

This relationship of mechanical horsepower to electrical watts involves derived units of power which have evolved from observations and measurements on physical and electrical machines (as well as horses!)

A standard generator requires, by definition, 1 hp to generate 746 watts plus enough additional horsepower to turn the physical mechanisms of the rotor at proper speed to maintain the desired frequency. The hp required to spin the mechanism is usually about 0.2 hp in a standard generator to generate 746 watts for a total 1.2 horsepower to generate 746 watts, although only 0.2 hp of that energy is used to actually generate electrical power. The remaining 1 hp which is equal to 746 watts is required to overcome the reverse torque or so-called “back EMF”.

The “back EMF” or “reverse torque” of all rotary generators in use today can best be described by reference to “Lenz's Law” which in summary states that when an EMF is generated by a change in magnetic flux according to Faraday's Law, the polarity of the induced EMF is such that it produces a current whose magnetic field opposes the magnetic flux which produces it. The induced magnetic field inside any loop of wire always acts to keep the magnetic flux in the loop constant. If the B field is increasing the induced magnetic field acts in equal and opposite direction to it, if it is decreasing the induced magnetic field acts in the direction of the applied field with equal force. In all standard generators, the rotor is stationed inside the coil loops of the stator, therefore the rotor generates a current in the stator which in turn generates a magnetic field which is equal in force and opposite in polarity, hence reverse torque is a product of the design or design flaw of all standard generators. Due to the reverse torque, about 85% more mechanical energy is required to turn the rotor than is required to generate power.

There is therefore a need to provide systems and methods which overcome at least some of these problems found in the prior art.

### SUMMARY

Consistent with the present disclosure, systems and methods are provided for a generator with a design which eliminates reverse torque along with systems and methods for harvesting the energy from the magnetic domains of ferromagnetic and paramagnetic material and particularly electrical steel.

According to a first aspect of the invention there is provided a solid-state electromagnetic rotor, comprising:
a plurality of salient pole pieces arranged around a supporting structure wherein a first end of each salient pole piece is attached to the support structure and a second end of each salient pole piece points outward away from the supporting structure, wherein the pole pieces include ferromagnetic and/or paramagnetic materials;
a plurality of wires wound around each salient pole piece; and
an excitation circuit configured to provide a current to the wires according to a predefined sequence to align magnetic domains of the salient pole pieces to produce a magnetic flux field, such that the current provided to the wires according to the predefined sequence provides a moving polar magnetic field in the form of distinct magnetic poles as desired to accomplish power generation, wherein the field strength of the moving polar magnetic field is proportional to the density of the magnetic domains of the salient pole piece material.

Preferably the plurality of salient pole pieces are divided into N-groups.

Advantageously the salient pole pieces within each group are configured to be sequentially excited each for a predetermined amount of time and/or with a predefined delay between excitations of salient pole pieces in each group to achieve a target frequency of an excitation cycle.

Advantageously the wires wound around each salient pole piece include an inner wire proximal to the supporting structure and an outer wire distal to the supporting structure, wherein the inner wire and the outer wire are excited so that the salient pole piece forms a dipole magnet.

Preferably the excitation circuit comprises an electronic gating system.

According to a second aspect of the invention there is provided a power generator comprising the above-mentioned solid-state electromagnetic rotor, and further comprising:
an electric power generator stator having a stator housing; and
wherein the solid-state electromagnetic rotor is disposed in, or around, and attached to the stator housing, such that the magnetic flux field generated by the solid-state electromagnetic rotor excites the stator coils and produces electric power.

Ideally the stator further comprises a cavity or radial surface, and further comprising stator wires configured to direct power to an output port.

Preferably the cavity of the stator is configured to receive the solid-state electromagnetic rotor.

Advantageously the power generator further comprises a processor configured to execute one or more of:
determining an excitation cycle based on a desired target frequency of the power generator; and
switching the excitation circuit connected to the wires wound around the salient pole pieces to excite the wires to align the magnetic domains of the plurality of salient pole pieces according to a predefined sequence such that the magnetic domains of a salient pole piece in an N^{th} group of the N-groups of salient pole pieces are aligned in a first polarity in a first half of the excitation cycle and aligned in a second polarity in a second half of the excitation cycle.
Advantageously the processor is further configured to receive a signal from a solid-state frequency generator and determine the target frequency of the power generator based on the signal.
Further advantageously the processor is configured to sequentially switch on and off a plurality of switching elements of the excitation circuit within the excitation cycle.
Advantageously a portion of the output power from the power generator is fed back into the excitation circuit.
Advantageously a portion of the output power is routed to an energy storage device.
Preferably the energy storage device comprises one or a combination of a battery and a capacitor.
Preferably the power generator further comprises:
   a plurality of the electric power generator stator, wherein each electric power generator stator of the plurality of the electric power generator stators comprises a stator housing; and
   a plurality of the solid-state electromagnetic rotor each placed into and/or attached to each of the stator housings, concentrically in an alternating manner either rotor-stator-rotor-stator or stator-rotor-stator-rotor.
Preferably the stator housing comprises a motor stator housing.
Further preferably the motor stator housing comprises a four-pole electric motor stator housing.
Advantageously the four-pole electric motor stator housing comprises a rotor insert, wherein the rotor insert is wound with conductors in the winding pattern of a four-pole generator.
Further advantageously the four-pole electric motor stator housing comprises a motor stator winding with a four-pole motor winding pattern.
Ideally the motor stator winding is connected in the pattern of a four-pole electric motor.
Advantageously the four-pole electric motor is configured to generate a four-pole rotating magnetic field at a predefined frequency.
Preferably the predefined frequency is 1800 rpm for 60 Hz power from the power generator and 1500 rpm for 50 Hz power from the power generator.
Preferably the four-pole rotating magnetic field generates 3-phase voltage in the rotor insert.
Advantageously the power generator further comprises an oscillating modulator for stabilizing voltage and power output of the power generator. The oscillator modulator may comprise the four-pole electric motor stator housing containing the rotor insert, wherein the rotor insert is wound with conductors in the winding pattern of a four-pole generator, connected in either a “high-wye” hook-up, a “low-wye” hook-up or a delta hook-up.
Preferably the leads from the rotor hook-up of the oscillator modulator are connected with a plurality of capacitors; and the motor stator is connected to a 3-phase output of the power generator.
Advantageously the 3-phase voltage and current from the rotor insert oscillates into and out of the capacitors across the leads, thereby stabilizing the power output of the power generator.
According to a third aspect of the invention there is provided a method of generating power using the above-mentioned power generator, comprising the steps of:
   determining an excitation cycle based on a target frequency of the power generator;
   executing the excitation cycle by providing a current to one or more of the wires according to a predefined sequence to align magnetic domains of the salient pole pieces of the rotor to produce an evolving magnetic flux field; and
   routing a resultant current, generated by the magnetic flux field, to a power output; wherein the strength of the magnetic flux field is evolving and increasing as the magnetic domains align; and
wherein the maximum strength of the evolving magnetic flux field is at least four times greater than the strength of the electromagnetic alignment field providing the energy for the moving magnetic poles which power the stator.
Advantageously the method further comprises the step of routing a portion of the resultant current to the energy storage device.
Advantageously the method further comprises routing a portion of the output power from the power generator back into the excitation circuit.

In the case of the generator of the current invention, the rotors are solid state and do not rotate, the magnetic poles rotate, therefore there is no reverse torque or pole to pole magnetic drag between the rotor and the stator. This induced pole in the stator piece is induced by current flow, it is in no way responsible for a current flow, as is evidenced by the fact that the generator reaches full voltage prior to current going to an electrical load.

In the case of the current invention it only requires energy to excite the rotor to generate the rotating magnetic poles. Therefore the system takes the power required and cycles it back to drive the generator and the remaining power is usable electric power to be used for whatever purpose is required.

The current through the rotor coils forms relatively weak magnetic poles which align the magnetic domains of the metal to form powerful moving sequenced rotating magnetic poles which generates more power from the magnetic domains than is required to align the fields. Therefore, in the invention of the present disclosure, the harvested energy from the moving magnetic fields as the domains are aligned allows more usable electric energy output than energy input for the system.

The solid state rotor of the present disclosure is virtually free of reverse torque due to five design changes when compared to the standard electric rotary generators found in the prior art:
1. The rotor of the solid state system has no moving parts;
2. The rotor does not rotate in the stator cavity;
3. The magnetic poles rotate in proper frequency and sequence to generate the desired electric power output;
4. The solid state rotor can be used to retrofit any standard generator, single-phase, two-phase or three-phase;
5. Rotors and stators can be radially laminated to improve power and efficiency.
   On Nov. 17, 2017 Dr. Robert R. Holcomb filed a patent application in the European Patent Office (EPO) titled “Solid-State Multi-Pole and Uni-Pole Electric Generator Rotor for AC/DC Electric Generators” in which he described the use of a static rotor with a rotating magnetic field. This disclosure described the use of this device for the elimination of reverse torque or back EMF. It also described the efficiency performance as being apparently greater than 1 (>1). This finding allowed the generator to operate in a self-sustained fashion. The disclosure did not explain the mechanism of input energy to allow an output of more energy than the apparent input energy. This mechanism is addressed in the present disclosure. The input to output energy does balance when the energy harvested from the magnetic domains of the ferromagnetic material of the electrical steel is put into the energy equation.
   The device in the present disclosure which generates the rotating magnetic field is referred to as a rotor even though it does not rotate, it emits a rotating magnetic field in the form of distinct magnetic poles, therefore it will be referred to herein as a rotor.

The system of the present disclosure does not conform to the classical definition of an electric power generator (Webster Dictionary Definition of Electric Generator: ‘A machine by which mechanical energy is changed into electrical energy’). The classical generator operates by using a main driver to produce mechanical energy which spins a magnetized rotor. The magnetic flux from the rotor pushes electrons through the stator coils and out to the electric load. The present disclosure generates and propagates a polar magnetic field, the flux from which pushes electrons through the stator coils out to an electric load. The magnetic field rotates but the physical member (the rotor) which generates the magnetic poles remains static. Therefore, since this system does not conform to the classical definition of any existing electric power generating system, it shall hereafter be referred to as The Holcomb Energy System (HES).

Embodiments consistent with the present disclosure include systems and methods for one or more electric generator rotors which may be solid-state and may provide the majority of the magnetic flux required to excite the stator. The standing salient poles of the present disclosure are excited by a relatively weak electromagnetic pole. The current to generate this relatively weak magnetic pole is taken from the output of the generator stator. When these standing poles are excited by the relatively weak electromagnetic fields emanating from the electromagnetic coil, these weak fields align the magnetic domains of the electrical steel in a single direction. The magnetic domains are formed by the electron spin of unpaired electrons of the atoms of the electrical steel or other suitable material. Therefore, the majority of the energy to run this solid-state generator is contributed by the electron spin of unpaired electrons which form magnetic domains and are aligned by the relatively weak fields of the salient pole electromagnetic coil. As these domains are coming into alignment they produce a very strong magnetic flux which induces the voltage and current flow in the stator coils.

These ferromagnetic and paramagnetic materials produce atomic moments that exhibit very strong interactions. These interactions are produced by electronic exchange forces and result in a parallel or anti-parallel alignment of the atomic moments. Exchange forces are very large, equivalent to a field on the order of 1,000 Tesla or approximately 100 million times the strength of the earth's magnetic field. The saturation magnetization of materials is the maximum induced magnetic moment that can be obtained in a magnetic field (H.sat). Beyond this saturation point the field, further increases in the weak aligning magnetic field will not yield further increase in magnetization. Saturation occurs when all of the available magnetic domains have been aligned. Ferromagnetic materials exhibit parallel alignment of moments resulting in large net magnetization even in the presence of relatively weak electromagnetic poles which are bringing about the alignments.

In accordance with some exemplary embodiments, a system is provided for generating power by removal of reverse torque. Reverse torque accounts for about 80% of the load in a standard generator and this load must be overcome by the prime mover. The generator of the present disclosure is solid-state and the majority of the moving magnetic flux is provided by the progressive and evolving alignment of magnetic domains within the rotor electrical steel salient poles, therefore it is very efficient. The only power required to operate the generator is that which is necessary to excite the weak magnetic poles which are responsible for aligning the rotor magnetic pole domains. Therefore, the generator operates with a complete energy balance.

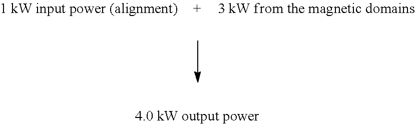

The above summary equation accounts for all of the significant energy of the system and the input and output energy is completely balanced.

For example, a solid-state electromagnetic rotor, consistent with the present disclosure, may include a plurality of salient pole pieces arranged around a supporting structure wherein a first end of each salient pole piece is attached to the support structure and a second end of each salient pole piece points outward or inward away from the supporting structure and wires are wound around each salient pole piece such that when the wires of the plurality of salient pole pieces are sequentially excited by an excitation circuit, the salient pole pieces are energized by a relatively weak electrical current which provides a relatively weak magnetic pole which in turn aligns the magnetic domains of the poles thereby providing a strong moving polar magnetic field in the form of distinct magnetic poles as desired to accomplish power generation.

In accordance with an aspect, a method is disclosed for removing reverse torque from a rotary electric generator that includes replacement of the conventional dipole or multipole spinning rotor with a unipole, dipole or multipole static solid-state rotor insert which creates distinct rotating magnetic poles. These magnetic poles are generated by exciting the wires wrapped around the electrical steel of the poles. The relatively weak magnetic poles created by the electrical excitation aligns the magnetic domains of the electrical steel or other suitable materials. The powerful moving field created by aligning the magnetic domains generates electric power without rotating the physical rotor body. Since the rotor does not physically rotate, there is no energy consuming interaction between the rotor poles and the magnetic poles induced in the stator piece as the generator is connected to an electric load. Nor does the generator require energy to spin a rotor at the proper speed required to maintain the desired frequency. The majority of the input magnetic energy evolves from alignment of the magnetic domains of the metal poles.

The current disclosure is designed to harvest relatively unlimited amounts of electric energy from ferromagnetic and paramagnetic materials. The current disclosure is a redesign of the electric power generator in the form of a solid-state rotary but not limited to rotary power generator. This design eliminates reverse torque found in electric power generators and taps into the power of the magnetic domains of electrical steel (but not confined to electrical steel) as an energy source to power the generator. In the case of electrical steel of the present disclosure, the ratio of magnetic permeability μ (H/M) of air is 1.2567×10⁻⁶ H/M and the magnetic permeability of electrical steel is 5.0×10⁻³ H/M. Therefore the relative permeability of electrical steel compared to air is 4,000 max. μ/μ₀. Electromagnetic permeability of a material is related to the number of magnetic domains per unit volume of the material.
Magnetic domain is a region within a paramagnetic or ferromagnetic material in which the magnetization is a uniform direction. This means that the individual magnetic moments of the atoms are aligned with one another. The regions separating the domains are called domain walls, where the induced magnetization rotates coherently from the direction in one domain to that in the next domain.
In the current disclosure the electromagnetic poles are formed by the polar direction of the domains being aligned by the relatively weak magnetic fields of the magnetic coil of the standing poles. As the domains are aligned the power of the moving magnetic field evolves primarily from the aligned domains which are formed by the electron spin of atoms in the metal or other appropriate material. Therefore the energy used to power this electric power generating machine is provided by the unpaired electron spin of the atoms making up the ferromagnetic, paramagnetic or other appropriate material which make up the standing poles.
The factors which affect the apparent strength of an electromagnet are:
1. Number of turns on the coil of wire which are wrapped around the core.
2. Strength of the current applied to the coil.
3. The material of the core.
This is related to the relative number of magnetic domains per unit volume.

The removal of reverse torque by the design of a solid-state electric power generator allows AC or DC generators to operate with 400-500% increased efficiency. This design change alone allows the generator to operate as a standard generator would operate but only requires 20% of the input power which is required by an operating standard generator and yet the newly designed generator maintains the same 100% output.

In the case of the present disclosure the majority of the input energy to power the generator is contributed by the peculiar electron spin pattern of the paramagnetic metal or other suitable material used in constructing the generator rotor and stator. The material with high magnetic flux permeability has a large number of magnetic domains as compared to materials of low magnetic permeability.

This system generates electric power according to Faraday's Law. The induced voltage in a coil is proportional to the product of its number of loops, the cross-section area of each loop, and the rate at which the magnetic field changes within those loops as well as the flux density of the changing fields.

In the current disclosure, the rotor is static, i.e. non-rotating, and therefore reverse torque (back EMF) is not an issue. The induced pole in the stator is induced by the current flow in the stator coils. This current is generated by a series of standing poles which are sequentially excited by the current produced by the primary generator and routed by the solid-state relays to the appropriate rotor coil. The excited coil aligns the magnetic domains of the standing pole and the moving magnetic field is formed as the magnetic domains are aligned. The magnetic domains provide the moving flux density to induce the voltage and current in the stator. The computer actuated system generates four distinct magnetic poles (N, S, N, S) which rotates at 1800 rpm's and generates 3-phase 60 hz power or at 1500 rpm's generates 3-phase 50 hz power. The frequency is controlled by the onboard computer sequencing system.

Before explaining certain embodiments of the present disclosure in detail, it is to be understood that the disclosure is not limited to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the conception and features upon which this disclosure is based may readily be utilized as a basis for designing other structures, methods, and systems for carrying out the several purposes of the present disclosure. Furthermore, the claims should be regarded as including such equivalent constructions insofar as they do not depart from the spirit and scope of the present disclosure.

### BRIEF DESCRIPTION OF THE DRAWINGS

FIG. 1 is a diagram illustrating a cross-sectional end view of an exemplary rotor laminate revealing salient pole pieces and flux sleeve, according to an embodiment of the present disclosure.

FIG. 2 is a diagram illustrating a cross-sectional end view of an exemplary rotor laminate revealing salient pole pieces, flux iron and pole piece windings, consistent with embodiments of the present disclosure.

FIG. 3 is a diagram illustrating a cross-sectional end view of an exemplary rotor laminate revealing salient pole pieces with angulation in a clockwise fashion and pole piece windings, consistent with embodiments of the present disclosure.

FIG. 4 is a diagram illustrating an end view of an exemplary solid state rotor revealing 16 wound salient poles as well as a flux return insert, consistent with embodiments of the present disclosure.

FIG. 5 is a diagram illustrating an end view of an exemplary solid state rotor with pole windings and excitation polarity sequencing circuits demonstrated for all 16 salient poles through a four-pole, 60 Hz cycle—pulse #1, consistent with embodiments of the present disclosure.

FIG. 6 is a diagram illustrating an end view of an exemplary solid state rotor with pole windings and excitation polarity sequencing circuits demonstrated for all 16 salient poles through a four-pole, 60 Hz cycle—pulse #2, consistent with embodiments of the present disclosure.

FIG. 7 is a diagram illustrating an end view of an exemplary solid state rotor with pole windings and excitation polarity sequencing circuits demonstrated for all 16 salient poles through a four-pole, 60 Hz cycle—pulse #3, consistent with embodiments of the present disclosure.

FIG. 8 is a diagram illustrating an end view of an exemplary solid state rotor with pole windings and excitation polarity sequencing circuits demonstrated for all 16 salient poles through a four-pole, 60 Hz cycle—pulse #4, consistent with embodiments of the present disclosure.

FIG. 9 is a diagram illustrating an end view of an exemplary solid state rotor with pole windings and excitation polarity sequencing circuits demonstrated for all 16 salient poles through a four-pole, 60 Hz cycle—pulse #5, consistent with embodiments of the present disclosure.

FIG. 10 is a diagram illustrating an end view of an exemplary solid state rotor with pole windings and excitation polarity sequencing circuits demonstrated for all 16 salient poles through a four-pole, 60 Hz cycle—pulse #6, consistent with embodiments of the present disclosure.

FIG. 11 is a diagram illustrating an end view of an exemplary solid state rotor with pole windings and excitation polarity sequencing circuits demonstrated for all 16 salient poles through a four-pole, 60 Hz cycle—pulse #7, consistent with embodiments of the present disclosure.

FIG. 12 is a diagram illustrating an end view of an exemplary solid state rotor with pole windings and excitation polarity sequencing circuits demonstrated for all 16 salient poles through a four-pole, 60 Hz cycle—pulse #8, consistent with embodiments of the present disclosure.

FIG. 13 is a diagram illustrating an end view of an exemplary solid state rotor with pole windings and excitation polarity sequencing circuits demonstrated for all 16 salient poles through a four-pole, 60 Hz cycle—pulse #9, consistent with embodiments of the present disclosure.

FIG. 14 is a diagram illustrating an end view of an exemplary solid state rotor with pole windings and excitation polarity sequencing circuits demonstrated for all 16 salient poles through a four-pole, 60 Hz cycle—pulse #10, consistent with embodiments of the present disclosure.

FIG. 15 is a diagram illustrating an end view of an exemplary solid state rotor with pole windings and excitation polarity sequencing circuits demonstrated for all 16 salient poles through a four-pole, 60 Hz cycle—pulse #11, consistent with embodiments of the present disclosure.

FIG. 16 is a diagram illustrating an end view of an exemplary solid state rotor with pole windings and excitation polarity sequencing circuits demonstrated for all 16 salient poles through a four-pole, 60 Hz cycle—pulse #12, consistent with embodiments of the present disclosure.

FIG. 17 is a diagram illustrating an end view of an exemplary solid state rotor with pole windings and excitation polarity sequencing circuits demonstrated for all 16 salient poles through a four-pole, 60 Hz cycle—pulse #13, consistent with embodiments of the present disclosure.

FIG. 18 is a diagram illustrating an end view of an exemplary solid state rotor with pole windings and excitation polarity sequencing circuits demonstrated for all 16 salient poles through a four-pole, 60 Hz cycle—pulse #14, consistent with embodiments of the present disclosure.

FIG. 19 is a diagram illustrating an end view of an exemplary solid state rotor with pole windings and excitation polarity sequencing circuits demonstrated for all 16 salient poles through a four-pole, 60 Hz cycle—pulse #15, consistent with embodiments of the present disclosure.

FIG. 20 is a diagram illustrating an end view of an exemplary solid state rotor with pole windings and excitation polarity sequencing circuits demonstrated for all 16 salient poles through a four-pole, 60 Hz cycle—pulse #16, consistent with embodiments of the present disclosure.

FIG. 21 is a diagram illustrating an end view of an exemplary solid state rotor with pole windings and excitation polarity sequencing circuits demonstrated for all 16 salient poles through a four-pole, 60 Hz cycle—pulse #1, consistent with embodiments of the present disclosure.

FIG. 22 is a diagram illustrating a cross-sectional end view of the stator laminate and rotor laminate members according to an embodiment of the present disclosure.

FIG. 23 is a diagram illustrating two cross-sectional end views of the inner rotor laminate, the stator laminate and the outer rotor laminate members in combination, consistent with embodiments of the present disclosure.

FIG. 24 is a diagram illustrating a cross-section end oblique elevation of the inner rotor laminates, the stator laminates and the outer rotor laminates, pressed and ready to insulate and wind, consistent with embodiments of the present disclosure.

FIG. 25 is a diagram illustrating a cross-sectional end view of the stator/rotor laminates with a depiction of the evolving magnetic flux field generated by the aligned magnetic domains of the metal as they are aligned, consistent with embodiments of the present disclosure.

FIG. 26 is a diagram illustrating a cross-sectional end view of the stator/rotor laminates with a depiction of the evolving magnetic flux field generated by the alignment of the magnetic domains of the metal as they are further aligned in comparison to FIG. 25, consistent with embodiments of the present disclosure.

FIG. 27 is a diagram illustrating a cross-sectional end view of the stator/rotor laminates with a depiction of the evolving magnetic flux field generated by the alignment of the magnetic domains of the metal as they are further aligned in comparison to FIG. 26, consistent with embodiments of the present disclosure.

FIG. 28 is a diagram illustrating a cross-sectional end view of the stator/rotor laminates with a depiction of the evolving magnetic flux field generated by the alignment of the magnetic domains of the metal as they are further aligned in comparison to FIG. 27, consistent with embodiments of the present disclosure.

FIG. 29 is a diagram illustrating a cross-sectional end view of the stator/rotor laminates with a depiction of the evolving magnetic flux field generated by the alignment of the magnetic domains of the metal as they are further aligned in comparison to FIG. 28, consistent with embodiments of the present disclosure.

FIG. 30 is a diagram illustrating a superior end view wound and installed of the inner rotor laminates, stator laminates and outer rotor laminates, consistent with the embodiment of the present disclosure.

FIG. 31 is a diagram illustrating a superior oblique projection of the wound and installed rotor/stator/rotor, consistent with the embodiment of the present disclosure.

FIG. 32 is a diagram illustrating the base winding pattern of the stator units, consistent with embodiments of the present disclosure.

FIG. 33 is a diagram illustrating a line drawing of an end view rendering of all the rotor laminates assembled and the rotor with windings, consistent with embodiments of the present disclosure.

FIG. 34 is a diagram illustrating a cross-sectional end view of rotor/stator laminates in member combinations, consistent with embodiments of the present disclosure.

FIG. 34A is a diagram illustrating a cross-sectional end view of rotor/stator laminates in member combinations and including typical dimensions of the same, consistent with embodiments of the present disclosure.

FIG. 35 is a diagram illustrating a cross-sectional end view of an inner stator laminate member, consistent with embodiments of the present disclosure.

FIG. 36 is a diagram illustrating a cross-sectional end view of a double rotor laminate member, consistent with embodiments of the present disclosure.

FIG. 37 is a diagram illustrating a cross-sectional end view of a double stator laminate member, consistent with embodiments of the present disclosure.

FIG. 38 is a diagram illustrating a cross-sectional end view of an outer rotor laminate member, consistent with embodiments of the present disclosure.

FIG. 39 is a diagram illustrating a hook-up pattern of the 3-phase coils in a “high-wye” 4-wire hookup, consistent with embodiments of the present disclosure.

FIG. 40 is a diagram illustrating an oscilloscope tracing of a 3-phase power generated by a generator, consistent with embodiments of the present disclosure.

FIG. 41 is an elevated view of the cowling which covers the rotor/stator, according to an embodiment of the present disclosure.

FIG. 42 is an elevated view of the partially separated cowling which covers the rotor/stator according to an embodiment of the present disclosure.

FIG. 43 is an elevated view of the partially separated cowling (further separated when compared to FIG. 42) which covers the rotor/stator of one of the embodiments of the present disclosure.

FIG. 44 is a diagram illustrating an end view projection of an oscillating modulator laminate with three of the phase windings in place, according to an embodiment of the present disclosure.

FIG. 45 is a diagram illustrating a base winding pattern of an oscillating modulator, consistent with embodiments of the present disclosure.

FIG. 46 is a diagram illustrating a stator of an oscillating modulator fully wound and prepared for assembly with the rotor, consistent with embodiments of the present disclosure.

FIG. 47 is a diagram illustrating a rotor laminate of an oscillating modulator pressed and prepared to be wound, consistent with embodiments of the present disclosure.

FIG. 48 is a diagram illustrating a rotor laminate of an oscillating modulator fully wound and prepared to be placed into the stator, consistent with embodiments of the present disclosure.

FIG. 49 is a diagram illustrating a stator and rotor hookup of an oscillating modulator, consistent with embodiments of the present disclosure.

FIG. 50 is a diagram illustrating a block diagram of a self-powering generator, consistent with embodiments of the present disclosure.

FIG. 50A is a graphical plot of the variation of the strength of magnetic flux generated in units of Gauss vs. the magnitude of the current provided to the coils, for both electrical steel and Plexiglas.

FIG. 51 is a diagram illustrating a typical pole circuit of a generator according to an embodiment of the present disclosure.

FIG. 52 is a diagram illustrating an end view of a generator main control panel of the system, consistent with embodiments of the present disclosure.

FIG. 53 is a diagram illustrating a view of one of a generator pole modules of the system, consistent with embodiments of the present disclosure.

FIG. 54 is a diagram illustrating a view of one of a generator pole module diode/terminal junctions, consistent with embodiments of the present disclosure.

FIG. 55 is a diagram illustrating one of the capacitor bank isolation pole discharge units, consistent with embodiments of the present disclosure.

FIG. 56 is a diagram illustrating a signal time sequence program of the computer controller, consistent with embodiments of the present disclosure.

FIG. 57 is a diagram illustrating isolated capacitor charging system, consistent with embodiments of the present disclosure.

FIG. 58 is a diagram illustrating the relay timer control circuit of the isolation battery charger, consistent with embodiments of the present disclosure.

FIG. 59 is a diagram illustrating the generator self-charging system battery and capacitor layout, consistent with embodiments of the present disclosure.

FIG. 60 is a diagram illustrating a 36 volt capacitor/battery bank, consistent with embodiments of the present disclosure.

FIG. 61 is a diagram from a plot of the variation of voltage with respect to time for a 36 volt battery capacitor/battery bank over a 24-hour self-charging, self-sustaining run with no external power supply, consistent with embodiments of the present disclosure.

FIG. 62 is a block diagram of measurement points with volt meters and Data Loggers for a self-charging, self-sustaining run, consistent with embodiments of the present disclosure.

FIG. 63 is a block diagram of measurement points with volt meters and Data Loggers for the power magnification experiment, consistent with embodiments of the present disclosure.

FIG. 64 is a graph of data taken from measurement data points with volt meters and Data Loggers to demonstrate the power magnification experiment, consistent with embodiments of the present disclosure.

FIG. 65 is a diagram from a 48 volt battery bank with voltage drop under load plotted against watts of remaining usable energy, consistent with embodiments of the present disclosure.

FIG. 66 is a plot of the variation of voltage with respect to time for a 36 volt battery/capacitor bank for a 24-hour period, consistent with embodiments of the present disclosure.

FIG. 67 is a plot of the variation of voltage with respect to time for a 36 volt battery bank over a 12-hour self-sustaining run with no outside power source, consistent with embodiments of the present disclosure.

FIG. 68 is a plot of the variation of voltage with respect to time for a 36 volt battery bank over a 2-hour period looking at data from a self-sustaining vs. a non self-sustaining run, consistent with embodiments of the present disclosure.

FIG. 69 is a plot of the variation of voltage with respect to time for a 36 volt battery bank over a 103-minute run with no outside power source, consistent with embodiments of the present disclosure.

FIG. 70 is a plot of the variation of voltage with respect to time for a 36 volt battery bank over 24 hours in a self-charging, self-sustaining mode with no external power source, consistent with embodiments of the present disclosure.

FIG. 71 is a diagram of a Plexiglas test assembly used for evaluation of the role played by the magnetic domains of electrical steel in power generation, consistent with embodiments of the present disclosure.

FIG. 72 is a diagram of an electrical steel test assembly used for evaluation of the role played by the magnetic domains of electrical steel in power generation, consistent with embodiments of the present disclosure.

FIG. 73 is a diagram of a Plexiglas test assembly used for evaluation of the role played by magnetic domains of electrical steel in power generation with test data displayed, consistent with embodiments of the present disclosure.

FIG. 74 is a diagram of an electrical steel test assembly used for evaluation of the role played by magnetic domains of electrical steel in power generation with additional test data, consistent with embodiments of the present disclosure.

FIG. 75 is a diagram of an electrical steel test assembly used for evaluation of the role played by magnetic domains of electrical steel in power generation with additional test data, consistent with embodiments of the present disclosure.

FIG. 76 is a diagram of an electrical steel test assembly used for evaluation of the role played by magnetic domains of electrical steel in power generation with additional test data, consistent with embodiments of the present disclosure.

FIG. 77 is an illustration of an assembly which is bolted to the bottom of each rotor structure to maximise power output with respect to the stator during an operating cycle, according to an embodiment of the present disclosure.

FIG. 78 is an illustration of a ceramic bearing surface and an attachment surface of the previous Figure, according to an embodiment of the present disclosure.

FIG. 79 is an illustration of a cross-sectional view of the attachment surface, according to an embodiment of the present disclosure.

FIG. 80 is a process diagram illustrating a scan cycle of a computer/controller operating cycle, consistent with embodiments of the present disclosure.

FIG. 81 is an illustration of a logic ladder sequence priority, according to an embodiment of the present disclosure.

FIG. 82 is an illustration of a relay control system which may balance the capacitance across the legs of a 3-phase generator, consistent with embodiments of the present disclosure.

FIG. 83 is a diagram illustrating an excitation power supply control circuit, according to an embodiment of the present disclosure.

FIG. 84 is a diagram illustrating a rotor impedance modulator control circuit, according to an embodiment of the present disclosure.

The accompanying drawings, which are incorporated in and constitute part of this specification, and together with the description, illustrate and serve to explain the principles of various exemplary embodiments.

### DETAILED DESCRIPTION OF THE DRAWINGS

Embodiments herein include systems and methods. At least some disclosed methods may be revealed and executed by several embodiments of the present disclosure. Several systems consistent with the present disclosure may include at least one rotor and one stator or the system may include multiple rotors and multiple stators. Embodiments of the present disclosure may alone or in the cumulative accomplish the purpose of the unique method of harnessing an abundance of usable electric energy from the magnetic domains of ferromagnetic and paramagnetic materials such as electrical steel but not limited to electrical steel. For example, various exemplary embodiments are discussed and described herein involving an aspect of an electric machine, such as a generator which utilizes relatively weak magnetic fields to align the magnetic domains of ferromagnetic and paramagnetic material used to construct rotor poles and stator irons. In the present disclosure, the electromagnetic fields of the rotor align in direction and evolve in strength as the magnetic domains of the ferromagnetic and paramagnetic materials are aligned by the relatively weak fields of the magnetic coils. As the domains are aligned the power of the moving magnetic fields evolve primarily from the aligned domains which derive their energy from the electron spin of the metals of the ferromagnetic and paramagnetic materials. Magnetic domain is a region within a magnetic material in which the magnetization is in a uniform direction. This means that the individual magnetic moments of the atom are aligned with one another. The regions separating the domains are called domain walls, wherein induced magnetization fields such as produced by the polar coils of the present disclosure rotates coherently from the direction in one domain to that in the next domain such that the domains may align in their exposed to the fields of the relatively weak magnetic coils. In the case of the electrical steel of the present disclosure, the ratio of magnetic permeability μ (H/M) of air is 1.2567×10⁻⁶H/M and the magnetic permeability of electrical steel is 5.0×10⁻³ H/M. Therefore the relative permeability of electrical steel compared to air is 4,000 max. μ/μ₀. Therefore the present disclosure in part or in whole allows the ability to harvest energy from ferromagnetic and/or paramagnetic materials with relatively small amounts of energy input. The ferromagnetic and paramagnetic materials provide an energy source much like photons from the sun.

Embodiments herein include systems and methods. At least some disclosed methods may be executed for example by at least one processor that receives instructions from a non transitory computer-readable storage medium. Similarly, systems consistent with the present disclosure may include one processor and memory, and the memory may be a non-transitory computer-readable storage medium. As used herein, a non-transitory computer readable storage medium refers to any type of physical memory on which information or data readable by at least one processor may be stored. Examples include Random Access Memory (RAM), Read-Only Memory (ROM), Volatile Memory, Non-Volatile Memory, hard drive, CD-Roms, DVD's, flash-drives, discs and any other known physical storage medium. Singular terms such as “memory” and “computer readable storage medium” may additionally refer to multiple structures such as a plurality of memories, and/or computer-readable storage mediums, as referred to herein a “memory” may comprise any type of computer-readable storage medium unless otherwise specified. A computer-readable storage medium may store instructions for evaluation by at least one processor including instructions for causing the processor to perform steps or stages consistent with an embodiment herein. Additionally one or more computer-readable storage medium may be utilized in implementing a computer-implemented method. The term “computer-readable storage medium” should be understood to include tangible items and exclude carrier waves and transient signals.

Embodiments of the present disclosure provide numerous advantages over prior systems and methods for example; various exemplary embodiments are discussed and described herein involving aspects of an electrical machine such as a generator that produces power with high efficiency and no reverse torque or electromagnetic drag. The relevance of elimination of the drag to its uses and applications along with the use of super conductor coils is presented and discussed. For example, embodiments of the present disclosure provide systems and methods for a generator design virtually free of reverse torque due to five design changes when compared to a conventional rotary generator.

These changes are explained next. The solid-state static rotor disclosed herein allows the generator rotors to be operated in any embodiment or design of generator stator. It allows the magnetic poles of the rotor to be rotated at any speed without back EMF or reverse torque because the rotor does not spin, only the magnetic poles spin.

In accordance with embodiments of the present disclosure, a method is disclosed for removing reverse torque from a rotary electric generator that includes replacement of the conventional dipole or spinning multipole with a unipole, dipole or multipole solid-state rotor or a series of rotors structured with layers of stator structures which creates rotating magnetic poles and generates electric power. Since the rotor is stationary there is no energy consuming interaction between the induced magnetic poles formed in a stator piece when the generator is connected to an electric load, nor does the generator require energy to spin a rotor at a proper frequency.

In accordance with an embodiment of one of the present disclosures, concentric circular rotors and double rotors are alternated with circular stators and double stators. This arrangement provides more power generating potential as the rotor/stator progresses outward.

Removal of the reverse torque allows an AC or DC generator to operate with 400%-500% increased efficiency by this design change alone. The removal of reverse torque may be due to geometric isolation or solid-state technology. The solid-state machine of the current disclosure removes reverse torque by developing a solid-state computer controlled electric power generator made of materials with maximum magnetic permeability. The majority of the input energy which produces output power is contributed by the peculiar electron spin pattern of the electrical steel or other ferromagnetic or paramagnetic materials of the generator. The material with high magnetic permeability has a large number of magnetic domains as compared to materials of low magnetic permeability.

It will be understood that a variety of materials are envisaged as being feasible alternatives to those expressed in the exemplary embodiments. For example, the windings wrapped around the salient poles may be copper but may alternatively be another sufficiently conducting material such as but not limited to graphene. What is more, various dimensions of said materials are envisaged as being feasible. For example, the windings may be #18 American Wire Gauge copper magnet wire, but may alternatively possess other dimensions and/or may be made of a different material. Indeed, the dimensions and compositions of materials discussed in the present disclosure are by way of example only, and should not be construed as being limiting.

Reference will now be made in detail to the exemplary embodiments implemented according to the disclosure, the examples of which are illustrated in the accompanying drawing.

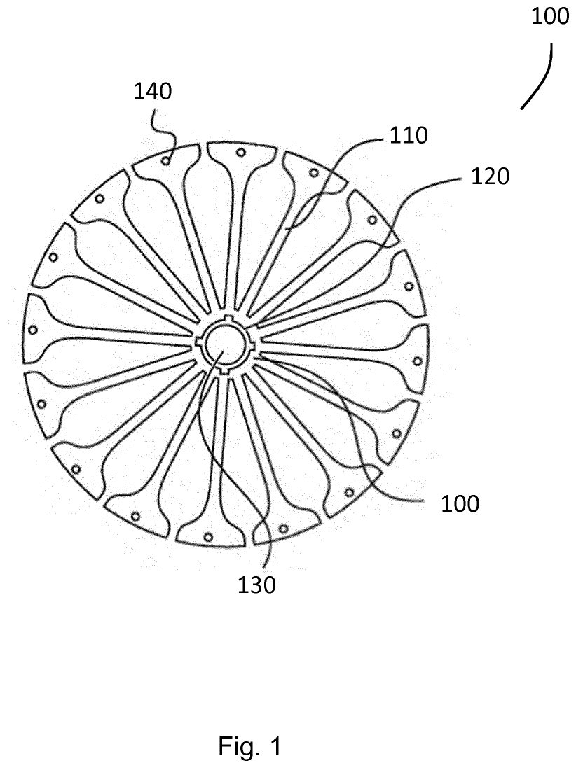

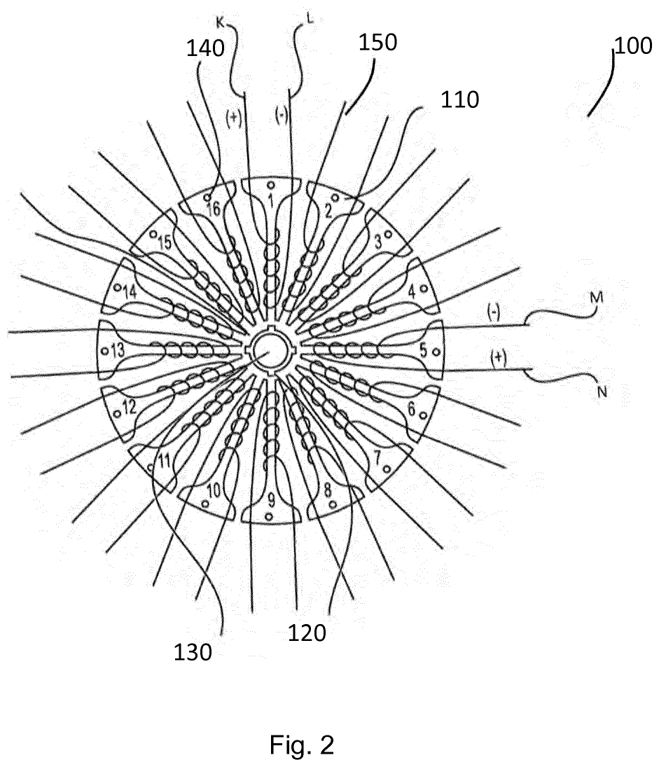

FIG. 1 is a diagram illustrating a cross-sectional end view of an exemplary rotor laminate 100 revealing salient pole pieces 110 and flux sleeve 120, consistent with embodiments of the present disclosure. In the exemplary embodiment, the flux sleeve 120 is a mu metal flux sleeve 120; other suitable materials matching the design requirements of permeability, strength and durability are envisaged as being feasible alternatives or for use in combination, for example permalloy. The body of the rotor may be laser cut from a disc (not presented) of, by way of example only, 0.34 mm annealed electrical steel which may be stacked on a jig in such a fashion that salient poles 110 are formed. The rotor laminate 100 may be manufactured to include a shaft 130 such that the rotor laminate 100 may be mounted on a jig. The jig may be selected such that it may be received by the shaft 130 or the shaft 130 may be dimensioned to fit a particular jig, for mounting. The shaft 130 may be slip fit with the mu metal sleeve 120. The body of the rotor laminate 100 and the salient poles 110 may be pressed and retained through fastening members (not pictured) in holes 140. In various embodiments, the fastening members may include one or more of bolts, pins, rivets and the like. The insulated salient pole windings (best presented in FIGS. 2-21) may then be wound around pole pieces 110.

FIG. 2 is a diagram illustrating a cross-sectional end view of an exemplary rotor laminate 100 made of laser cut disc (not presented) revealing salient poles 110, flux sleeve 120, and pole piece windings 150 consistent with embodiments of the present disclosure. Each salient pole 110 may have two leads which, for example, pole 1 may be excited north pole with leads K and L, and pole 5 may be excited south pole with leads M and N. Retention holes 140 containing retention bolts are shown along with support shaft 130 and mu metal sleeve 120. In alternative embodiments, each salient pole 110 may have more than two leads. A variety of materials are envisaged as being feasible for the material of the windings; the material may be selected based on a number of desired relevant parameters such as inductance, Q factor, tensile strength and the like.

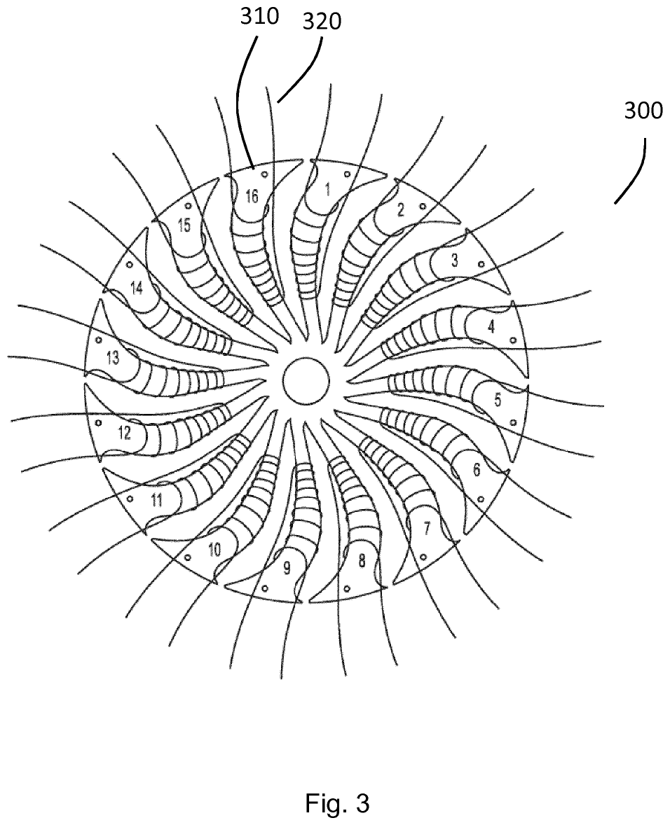

FIG. 3 is a diagram illustrating a cross-sectional end view of an exemplary rotor laminate 300 revealing salient pole pieces 310 with angulation in a clockwise fashion and pole piece windings 320 consistent with embodiments of the present disclosure. This angle may allow the evolving magnetic field from each pole to emanate at a 45° angle in a clockwise direction and as the field is repelled by the existing like-adjoining pole, the flux may rotate parallel to the surface of the rotor in a clockwise direction.

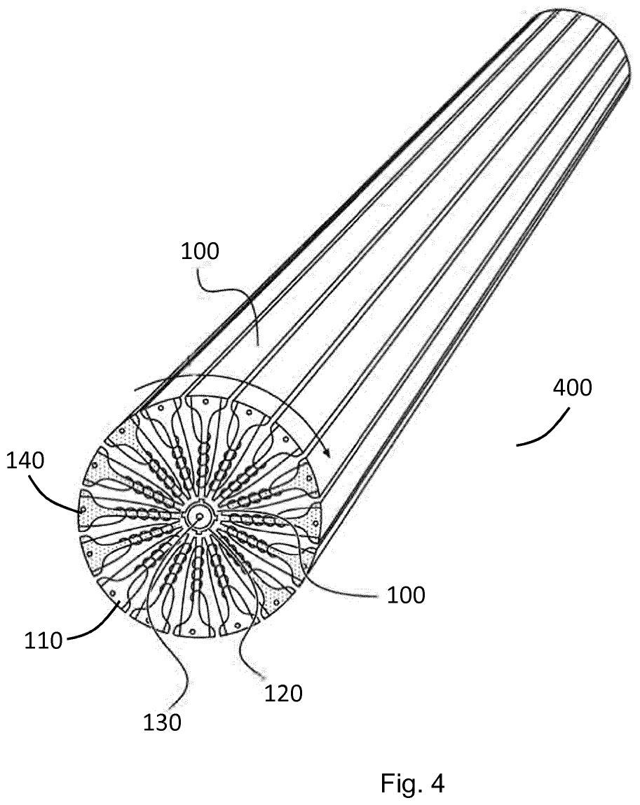

FIG. 4 is a diagram illustrating a view of an exemplary solid state rotor body 400 revealing 16 wound salient poles 110 as well as a flux sleeve 120, consistent with embodiments of the present disclosure. A rotor 400 is illustrated comprising stacked and pressed rotor laminates 100, including salient poles 110, and mu metal sleeve 120, along with support shaft 130.

In accordance with embodiments of the present disclosure, a method is disclosed for removing reverse torque from a rotary electric generator that includes replacement of the conventional dipole or spinning rotor with a uni-pole, dipole, or multi-pole static solid state rotor 400 which creates rotating magnetic poles and generates electric power. Since the rotor 400 is stationary, there is no energy consuming interaction between the magnetic poles formed in a stator pole piece 110 when the generator is connected to an electric load, nor does the generator require energy to spin a rotor at a proper frequency.

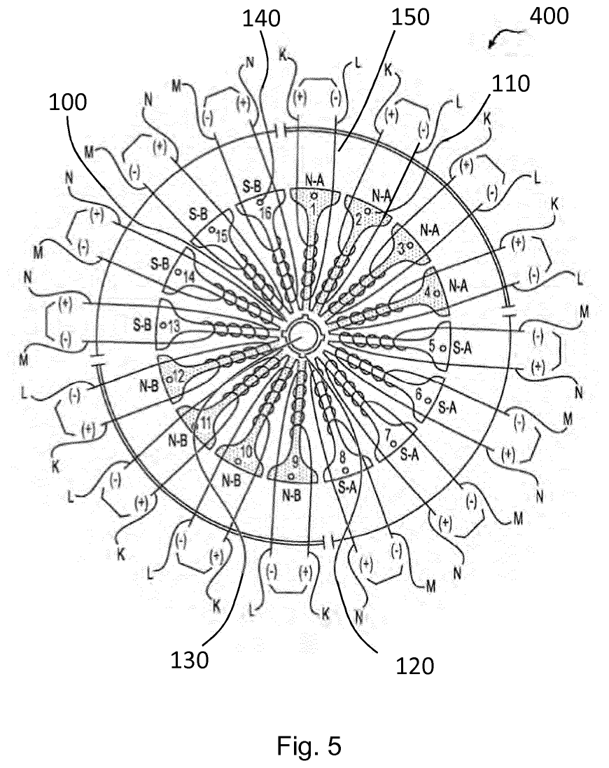

In the exemplary embodiment, this redesign of the rotor is accomplished by cutting laminates 100 from electrical steel to a desired diameter. In some embodiments, the diameter may be 6 inches. In alternative embodiments, the diameter is greater than 6 inches. In further alternative embodiments the diameter is less than 6 inches. In the exemplary embodiment the laminate 100 may be cut such that the rotor comprises 16 salient pole pieces. Other numbers of the salient poles pieces 110 may be selected dependent on, for example, a desired power input/output. The salient pole pieces 110 may be of different dimensions or the same dimensions, and may be distributed uniformly with respect to the center of the laminate 100 or according to another distribution which is not uniform and is according to a predefined pattern or random. FIGS. 5-21 described later illustrate various alternative configurations according to different embodiments. The pole pieces 110 may be wound with a desired and appropriate electrical magnet wire 150. The magnet wire windings 150 may be terminated in two leads which may be connected to a computer controlled gating system (not presented) using, for example, a programmable logic center (PLC), allowing switching in an alternate fashion from a first polarity to a second polarity and from the second polarity to the first polarity by use of, for example, a MOSFET gating system in an excitation circuit (not presented). In a case of a four-pole rotor for example, the salient poles are wired into four groups of four poles per group, or two groups of eight poles per group, but not limited to two or four groups.

In an exemplary embodiment involving a 60 Hz power input and a four-pole rotor, the polarity may alternate from group to group. That is, pole 1 of group #1 is a first polarity and pole 1 of group #2 is a second polarity; pole 1 of group #3 is a first polarity and pole 1 of group #4 is a second polarity, and so on. Pole 1 from each group may be excited by a solid state exciter circuit. Pole 2 from each group may be excited by a solid state exciter circuit. Pole 3 from each group may be excited by a solid state exciter circuit. Pole 4 from each group may be excited by a solid state exciter circuit. Various embodiments of the excitation sequence are envisaged, which may include different excitation time delays. In one embodiment, pole 1 of each group may be excited and, for example, 2.084 milliseconds later, pole 2 may be excited; then again, for example, 2.084 milliseconds later, pole 3 may be excited; then again, for example, 2.084 milliseconds later, pole 4 may be excited; and, for example, 2.084 milliseconds later pole 1 may be excited again, and the cycle repeats. In alternative embodiments, the time delay between (for example) the excitation of the n^{th} and the n^{th}+1 poles compared with the n^{th}+1 and n^{th}+2 poles may be different.

Pole circuits may be excited with a first polarity DC power current in a first cycle and a second polarity DC power current in a second cycle. The first and second cycles make up one AC cycle every 16.667 milliseconds in the case of a 60 Hz current. Appropriate adjustments may be made for other frequencies, such as 50 Hz. Each pole may be excited for, for example, a 4.167 milliseconds but not confined to 4.167 milliseconds with, for example, a 4.167 millisecond collapse time but not confined to 4.167 collapse time for each magnetic salient pole 110. The excitation wave progresses clockwise which distorts each pole as it is forming, which pushes the magnetic flux in a progressive clockwise fashion by the repelling flux of the preceding poles. This in effect constantly pushes discrete separated magnetic poles in a clockwise circular fashion at a desired frequency and the poles are separated, alternating first polarity and second polarity. Accordingly, every complete 16.667 millisecond cycle, the excitation switches from first polarity to second polarity such that the four distinct magnetic poles continue to rotate without physical rotation of the rotor member itself.

In a case of a two-pole magnetic rotor, salient poles 110 may be wired into two groups of eight pole pieces 110 per group. Pole pieces 110 in each group may be connected to a circuit (not presented) from the exciter system. For example, pole 1 of group #1 is a first polarity, pole 1 of group #2 is a second polarity. Pole 1 for each group may be excited by a solid state exciter channel. Pole 2 for each group may be excited by a solid state exciter board channel (not presented). Pole 3 for each group may be excited by a solid state exciter channel. Each and any of poles 4-8 for each group may be excited by a solid state exciter board channel.

By way of example only, pole 1 of each group may be excited and, for example, 1.042 milliseconds later, pole 2 of each group may be excited. Pole 2 of each group may be excited and, for example, 1.042 milliseconds later, pole 3 of each group may be excited. Pole 3 of each group may be excited and, for example, 1.042 milliseconds later, pole 4 of each group may be excited. Pole 4 of reach group may be excited and, for example, 1.042 milliseconds later, pole 5 may be excited. Pole 5 of each group may be excited and, for example, 1.042 milliseconds later, pole 6 may be excited. Pole 6 of each group may be excited and, for example, 1.042 milliseconds later, pole 7 may be excited. Pole 7 of each group may be excited and, for example, 1.042 milliseconds later, pole 8 may be excited. Pole 8 of each group may be excited and, for example, 1.042 milliseconds later pole 1 of each group may be excited, and the cycle repeats.

The excitation polarity changes with each cycle. Therefore, in the case of the four-pole unit, the polarity switches two times per each 16.667 milliseconds cycle and with the two pole unit, the polarity of the excitation switches two times per 16.667 milliseconds cycle for a 60 Hz current.

For example, in a case of a uni-pole magnetic rotor, 16 salient poles 110 are wired into four groups of four pole pieces 110 per group. All 16 pole pieces 110 may be excited north pole, for example, for 8.3335 milliseconds but not limited to 8.3335 milliseconds; and then all 16 pole pieces 110 may be excited south pole, for example, for another 8.3335 milliseconds, but not limited to 8.3335 milliseconds, such that each complete cycle is of 16.667 milliseconds. Pole pieces 110 in each group may be connected to a circuit from a PLC driven exciter system. Accordingly, in embodiments pole piece #1 of group #1 may be a first polarity; pole pieces #1 of group 2, 3, and 4 may be a first polarity for one cycle; and then all switch to a second polarity for pole piece #1, 2, 3 and 4. That is, the entire rotor may alternate between first polarity for 360° and second polarity for 360°. Alternating polarity may be controlled by, for example, a MOSFET gating system. The speed of the rotating field is not relevant to the generated current frequency. The frequency may be controlled by a computer controlled gating system, for example, for a 50 Hz, a 60 Hz, or any other desired frequency. The speed of rotation of the magnetic field may be controlled by a rate of progression of excitation.

For example, to obtain a rotation rate of the magnetic field at, for example 7,500 rpm, the following sequence may apply. Pole piece #1 of each group may be excited and, for example, 0.5 milliseconds later, pole piece #2 may be excited; and, for example, 0.5 milliseconds later, pole piece #3 may be excited; and, for example, 0.5 milliseconds still later, pole piece #4 may be excited and, for example, 0.5 milliseconds later, pole piece #1 may be again excited, and the cycle is repeated until an excitation polarity is switched. Each pole piece 110 may be excited, for example, 0.1 milliseconds. The pole circuits may be excited with a first polarity DC current in the first cycle and a second polarity DC current in the second cycle. As discussed above, the combination of first and second cycles makes a complete AC cycle.

The design of the solid state static rotor of the present disclosure allows the generator rotors to be operated in any embodiment or design of a generator stator. The design allows the rotor magnetic poles to be rotated at any speed without consideration of power output frequency. The frequency can be controlled by an excitation circuit rather than by the speed of the rotors.

As noted earlier, the redesign of the rotor is accomplished by, for example, cutting laminates 100 from a desired material to a desired diameter. In the exemplary embodiment, the laminates 100 are cut from electrical steel. FIGS. 5-21 described next illustrate this redesign, where the pole pieces 110 may be wound with a desired and appropriate electrical magnet wire 150.

FIG. 5 is a diagram illustrating an end view of an exemplary solid state rotor 400 with pole windings 150 and excitation polarity sequencing circuits demonstrated for all 16 salient poles 110 through a four-pole, 60 Hz cycle-pulse #1, which generates the rotating magnetic poles, consistent with embodiments of the present disclosure. Solid state rotor 400 reveals an end laminate 100 and retention bolt holes 140. FIG. 5 is a depiction of a static state rotor 400 with 4 magnetic poles and the excitation scheme of the salient poles 110 associated with each magnetic pole. Salient poles 110 are numbered 1-16. The 4 rotor magnetic poles include north pole #1 (labeled N-A), south pole #1 (labeled S-A), north pole #2 (labeled N-B) and south pole #2 (labeled S-B). Each magnetic rotor pole comprises 4 electrically excited wound salient pole pieces 110. North pole excitation leads K and L, and south pole excitation leads M and N are sequentially excited in the following manner.

In pulse #1 as shown in FIG. 5, the first magnetic pole group (salient poles 1-4) is excited in a first polarity and the second magnetic pole group (salient poles 5-8) is excited in a second polarity. The third group (salient poles 9-12) is excited in a first polarity and the fourth magnetic pole group (salient poles 13-16) is excited in a second polarity. Salient poles 1, 5, 9, and 13 may be excited by a solid state exciter board channel #1 (CH1) and channel #2 (CH2). Salient poles 2, 6, 10, and 14 may be excited by a solid state exciter board channel #3 (CH3) and channel #4 (CH4). Salient poles 3, 7, 11, and 15 may be excited by a solid state exciter board channel #5 (CH5) and #6 (CH6). Salient poles 4, 8, 12, and 16 may be excited by a solid state exciter board channel #7 (CH7) and channel #8 (CH8). In the exemplary embodiment, within each group the salient pole pieces 110 are not excited simultaneously, but sequentially. For example, in the first group (poles 1-4), salient pole 1 is excited in a first polarity and, for example 2.084 milliseconds later, salient pole 2 is excited in a first polarity; for example, 2.084 milliseconds later, salient pole 3 is excited in a first polarity; and, for example, 2.084 milliseconds later, salient pole 4 is excited in a first polarity. After all the poles have been excited in one polarity sequentially, the polarity is switched. For example, after pole 4 is excited in the first polarity for 2.084 milliseconds, salient pole 1 is excited again, this time in a second polarity, and the cycle repeats. In other words, the poles are excited by a first polarity DC in a first half cycle and a second polarity DC in a second half cycle. The first and second half cycles make up one AC cycle every 16.667 milliseconds, in the case of a 60 Hz alternating current. Appropriate adjustments may be made for frequencies other than 60 Hz.

In the case of 60 Hz current, each pole is excited, for example, 4.167 milliseconds but not limited to 4.67 milliseconds, with, for example, a 4.167 millisecond relaxation time but not limited to 4.167 millisecond relaxation time, for each salient pole. The excitation wave progresses clockwise, which distorts each magnetic pole as it is forming with the result being a pushing of the flux in a progressive clockwise fashion parallel to a surface of the rotor 400 as a result of the repelling of the flux from the preceding pole. The effect in the case of FIG. 5 is that four discreet alternating magnetic poles circulate in a clockwise circular fashion at a desired frequency. The poles are separated by an alternating first polarity and second polarity. Every 16.667 millisecond complete cycle involves the first and second polarities in 180° of rotation in each half cycle. The four distinct magnetic poles continue to rotate without physical rotation of the rotor member.

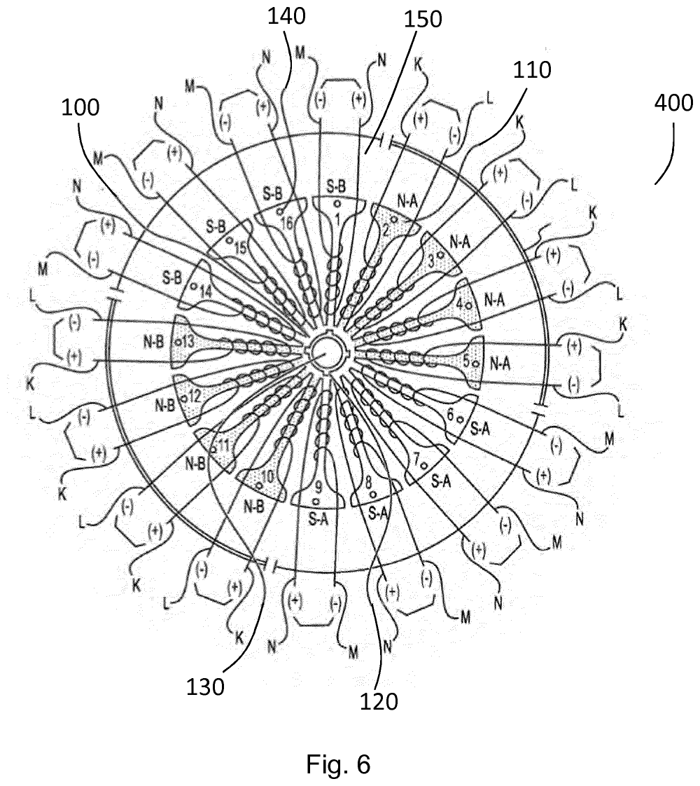

FIG. 6 is a diagram illustrating an end view of an exemplary solid state rotor 400 with pole windings 150 and excitation polarity sequencing circuits demonstrated for all 16 salient poles 110 through a four-pole, 60 Hz cycle-pulse #2, consistent with embodiments of the present disclosure. Rotor 400 reveals an end laminate 100 and retention bolt holes 140. FIG. 6 is a depiction of a four-pole rotor in a static state view of an excitation cycle of the salient poles 110 which generates the rotating poles. Salient poles 110 are numbered 1-16. In this view of pulse #2 of a 16 step rotation of the discreet magnetic poles, mu metal sleeve 120 and shaft 130 are also revealed. The 4 magnetic poles are labeled: north pole #1 is labeled N-A (salient poles 2-5), south pole #1 is labeled S-A (salient poles 6-9), north pole #2 is labeled N-B (salient poles 10-13), and south pole #2 is labeled S-B (salient poles 14-16 and 1). Like FIG. 5, each magnetic rotor pole in FIG. 6 also consists of four electrically excited salient pole pieces 110 wound with pole windings 150 formed from a suitable conductor, such as magnet wire. However, in the illustration of FIG. 6 the pole groups have rotated clockwise by one pole, compared to their positions in FIG. 5. For example, the first magnetic pole group now includes rotor poles 2-5, the second magnetic pole group now includes rotor poles 6-9, the third magnetic pole group now includes rotor poles 10-13, and the fourth magnetic pole group now includes rotor poles 14-16 and 1. Among these groups, rotor poles with N-A and N-B polarities (i.e., rotor poles 2-5 and 10-13) are excited through the north pole wound magnet wire leads K-L, and rotor poles with S-A and S-B polarities (rotor groups 6-9 and 14-16 and 1) are excited through the south pole wound magnet wire leads M-N, where, K (+), L (−), M (−) and N (+). These excitation leads are sequentially excited similarly as described in connection with FIG. 5, except the polarity groups have shifted by one rotor pole.

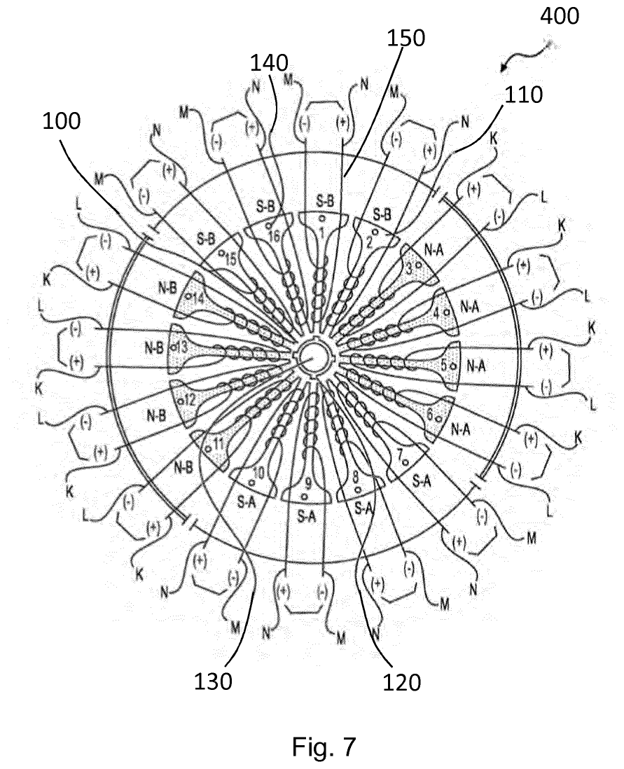

FIG. 7 is a diagram illustrating an end view of an exemplary solid state rotor 400 with pole windings 150 and excitation polarity sequencing circuits demonstrated for all 16 salient poles 110 through a four-pole, 60 Hz cycle—pulse #3, consistent with embodiments of the present disclosure. Rotor 400 reveals an end laminate 100 and retention bolt holes 140. FIG. 7 is a depiction of a four-pole rotor in a static state view of an excitation cycle of the salient poles which generates the rotating poles. The salient poles 110 are numbered 1-16. This is pulse #3 of a 16 step rotation of the four discrete magnetic poles. The mu metal sleeve 120 and shaft 130 are also revealed. The magnetic poles are labeled: North #1 is labeled N-A (salient poles 3-6), south pole #1 is labeled S-A (salient poles 7-10), north pole #2 is labeled N-B (salient poles 11-14), and south pole #2 is labeled S-B (salient poles 15-16 and 1-2). Each magnetic rotor pole group consists of four electrically excited salient pole pieces wound with magnet wire. The north pole wound magnetic wire leads are expressed as K-L, and south pole wound magnetic wire leads are expressed as M-N, with K (+) and L (−) M (−) and N (+). The excitation leads are sequentially excited as in FIG. 5, except the polarity groups have shifted by two rotor poles.

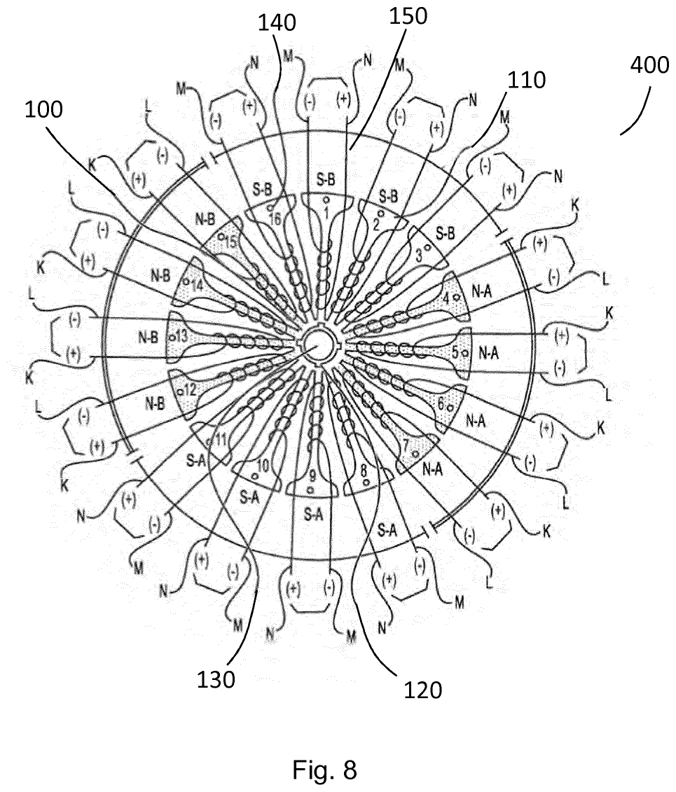

FIG. 8 is a diagram illustrating an end view of an exemplary solid state rotor 400 with pole windings and excitation polarity sequencing circuits demonstrated for all 16 salient poles through a four-pole, 60 Hz cycle—pulse #4, consistent with embodiments of the present disclosure. Rotor 400 reveals an end laminate 100 and retention bolt holes 140. FIG. 8 is a depiction of a four-pole rotor in a static state view of an excitation cycle of the salient poles which generates the rotating poles. The salient poles 110 are numbered 1-16. This depicts pulse #4 of a 16 step rotation of the four discrete magnetic poles involving 360° of rotation. The mu metal sleeve 120 and shaft 130 are also revealed. The four magnetic poles are labeled: North pole #1 is labeled N-A (salient poles 4-7), south pole #1 is labeled S-A (salient poles 8-11), north pole #2 is labeled N-B (salient poles 12-15), and south pole #2 is labeled S-B (salient poles 16 and 1-3). Each magnetic rotor pole consists of four electrically excited salient pole pieces wound with magnet wire. The north pole wound magnet wire leads are expressed as K-L, and south pole wound magnet wire leads are expressed as M-N, with K (+), L (−), M (−) and N (+). These excitation leads are sequentially excited similarly as in FIG. 5, except the polarity groups have shifted by three rotor poles.

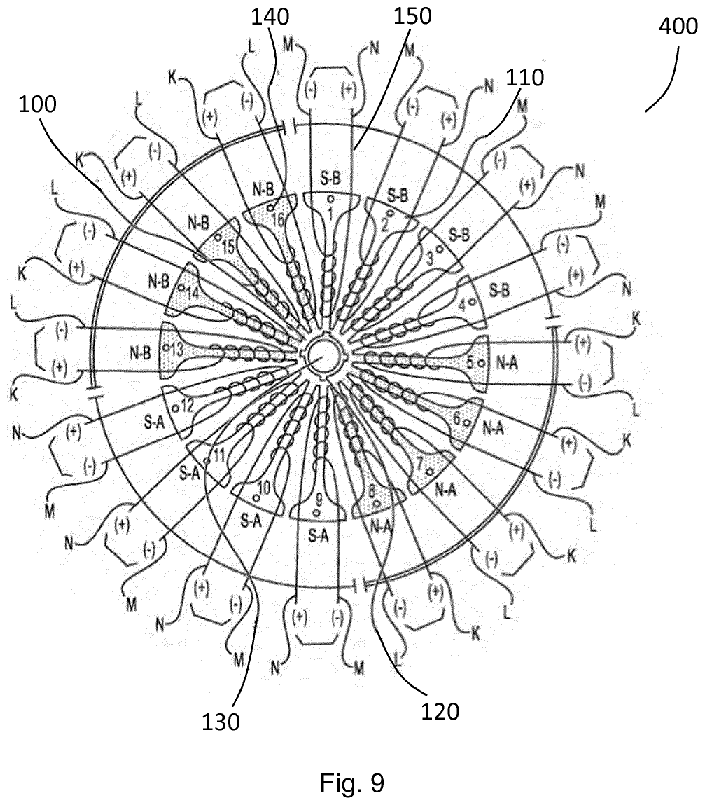

FIG. 9 is a diagram illustrating an end view of an exemplary solid state rotor 400 with pole windings and excitation polarity sequencing circuits demonstrated for all 16 salient poles through a four-pole, 60 Hz cycle—pulse #5, consistent with embodiments of the present disclosure. Rotor 400 reveals an end laminate 100 and retention bolt holes 140. FIG. 9 is a depiction of a four-pole rotor in a static state view of an excitation cycle of the salient poles which generates the rotating poles. The salient poles 110 are numbered 1-16. This depicts pulse #5 of a 16 step rotation of the discrete magnetic pole involving 360° of rotation. The mu metal sleeve 120 and shaft 130 are also revealed. The 4 magnetic poles are labeled: north pole #1 is labeled N-A (salient poles 5-8), south pole #1 is labeled S-A (salient poles 9-12), north pole #2 is labeled N-B (salient poles 13-16), and south pole #2 is labeled S-B (salient poles 1-4). Each magnetic rotor pole consists of four electrically excited salient pole pieces wound with magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by four rotor poles.

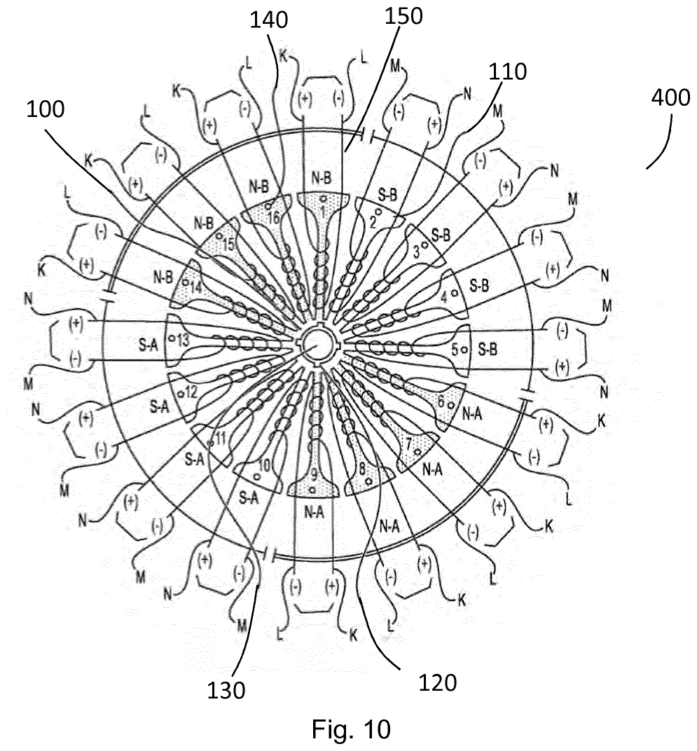

FIG. 10 is a diagram illustrating an end view of an exemplary solid state rotor 400 with pole windings 150 and excitation polarity sequencing circuits demonstrated for all 16 salient poles 110 through a four-pole, 60 Hz cycle—pulse #6, consistent with embodiments of the present disclosure. Rotor 400 reveals an end laminate 100 and retention bolt holes 140. FIG. 10 is a depiction of a four-pole rotor in a static view of an excitation cycle of the salient pole which generates the rotating poles. The salient poles 110 are numbered 1-16. This depicts pulse #6 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 6-9), south pole #1 is labeled S-A (salient poles 10-13), north pole #2 is labeled N-B (salient poles 14-16 and 1), and south pole #2 is labeled S-B (salient poles 2-5). Each magnetic rotor pole consists of four electrically excited salient pole pieces wound with magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by five rotor poles.

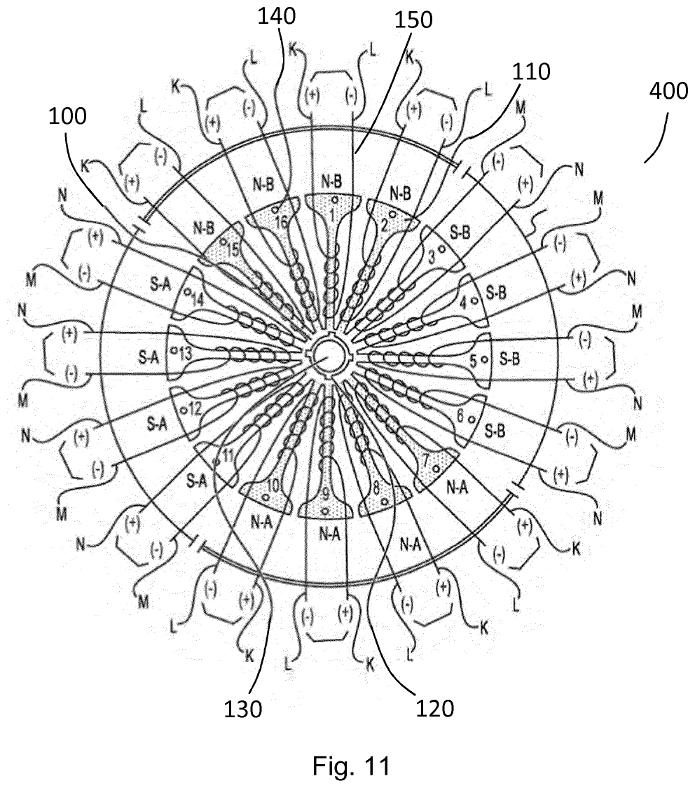

FIG. 11 is a diagram illustrating an end view of an exemplary solid state rotor 400 with pole windings 150 and excitation polarity sequencing circuits demonstrated for all 16 salient poles 110 through a four-pole, 60 Hz cycle—pulse #7, consistent with embodiments of the present disclosure. Rotor 400 of the invention reveals an end laminate 100 and retention bolt holes 140. FIG. 11 is a depiction of a four-pole rotor in a static state view of a sequential excitation cycle of the salient poles which generates the rotating magnetic poles. The salient poles 110 are numbered 1-16. FIG. 11 illustrates pulse #7 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 7-10), south pole #1 is labeled S-A (salient poles 11-14), north pole #2 is labeled N-B (salient poles 15-16 and 1-2), and south pole #2 is labeled S-B (salient poles 3-6). Each magnetic rotor pole consists of four electrically excited salient pole pieces wound with magnet wire. The north pole wound magnet wire leads are expressed as K-L and south pole wound magnet wire leads are expressed as M-N, with K (+), L (−), M (−) and N (+). These excitation leads are sequentially excited as in FIG. 5, except the polarity groups have shifted by six rotor poles.

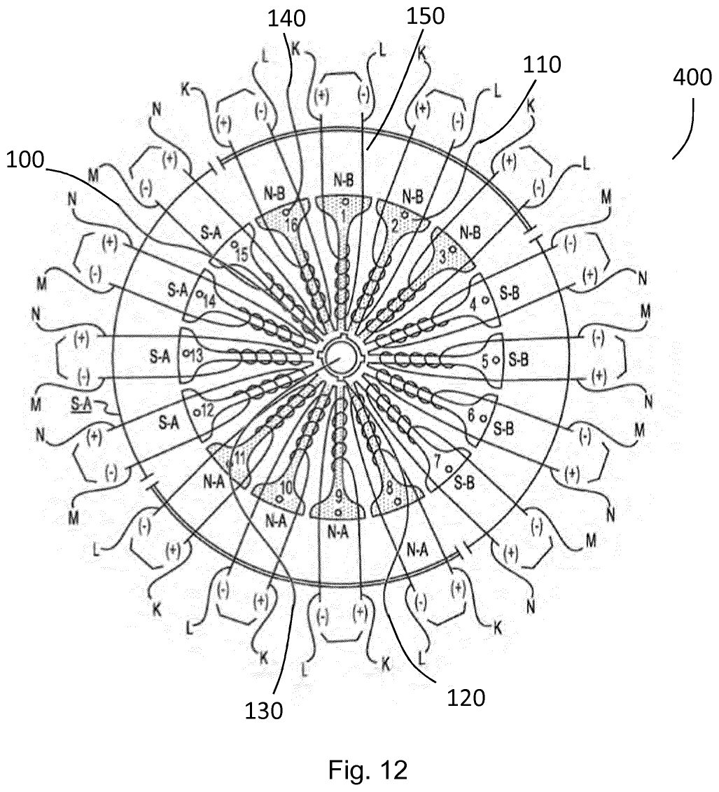

FIG. 12 is a diagram illustrating an end view of an exemplary solid state rotor 400 with pole windings 150 and excitation polarity sequencing circuits demonstrated for all 16 salient poles 110 through a four-pole, 60 Hz cycle—pulse #8, consistent with embodiments of the present disclosure. Rotor 400 of the invention reveals an end laminate 100 and retention bolt holes 140. FIG. 12 is a depiction of a four-pole rotor 400 in a static state view of a sequential excitation cycle of the salient poles 110 which generates the rotating magnetic poles. The salient poles 110 are numbered 1-16. FIG. 12 illustrates pulse #8 of a 16 step generation and rotation of the four discrete magnetic poles involving 360° of rotation and two cycles of 60 Hz alternating current. The mu metal sleeve 120 and shaft 130 are revealed. The 4 magnetic poles are labeled: North pole #1 is labeled N-A (salient poles 8-11), south pole #1 is labeled S-A (salient poles 12-15), north pole #2 is labeled N-B (salient poles 16 and 1-3), and south pole #2 is labeled S-B (salient poles 4-7). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K(+), L (−), M (−) and N (+). These excitation leads are sequentially excited as in FIG. 8, except the polarity groups have shifted by seven rotor poles 110.

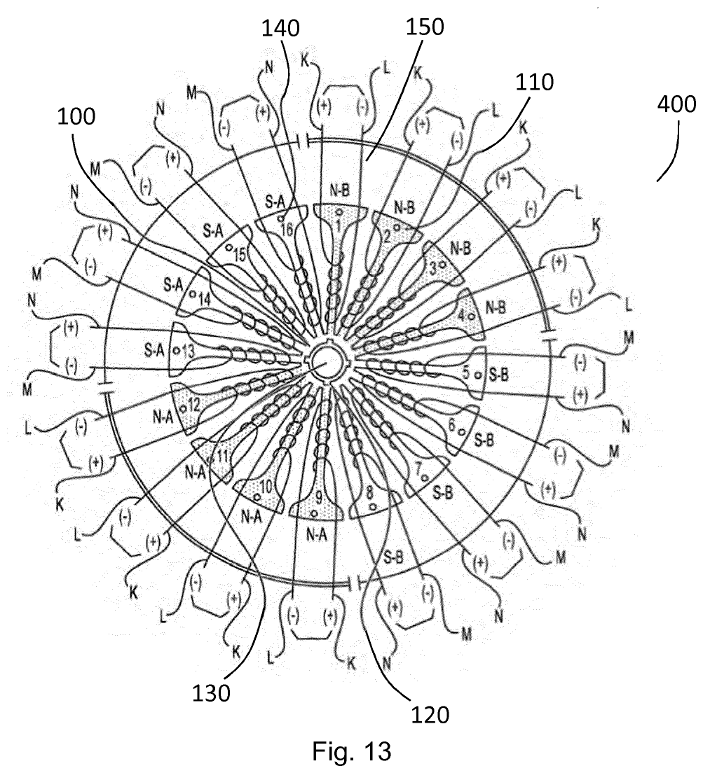

FIG. 13 is a diagram illustrating an end view of an exemplary solid state rotor 400 with pole windings 150 and excitation polarity sequencing circuits demonstrated for all 16 salient poles 110 through a four-pole, 60 Hz cycle-pulse #9, consistent with embodiments of the present disclosure. Rotor 400 reveals an end laminate 100 and retention bolt holes 140. FIG. 13 is a depiction of a four-pole rotor in a static state view of a sequential excitation cycle of the salient poles 110 which generates rotating magnetic poles. The salient poles 110 are numbered 1-16. FIG. 13 illustrates pulse #9 of a 16 step generation and rotation of the four discrete magnetic poles involving 360° of rotation and two cycles of 60 Hz current. The mu metal sleeve 120 and shaft 130 are also revealed. The 4 magnetic poles are labeled: north pole #1 is labeled N-A (salient poles 9-12), south pole #1 is labeled S-A (salient poles 13-16), north pole #2 is labeled N-B (salient poles 1-4), and south pole #2 is labeled S-B (salient poles 5-8). Each magnetic rotor pole consists of four electrically excited salient pole pieces wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by eight rotor poles.

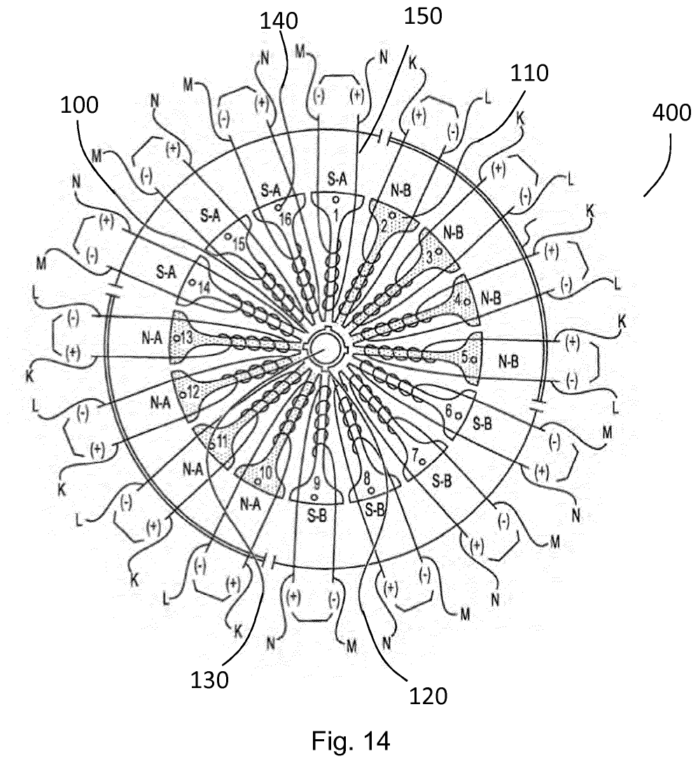

FIG. 14 is a diagram illustrating an end view of an exemplary solid state rotor 400 with pole windings 150 and excitation polarity sequencing circuits demonstrated for all 16 salient poles 110 through a four-pole, 60 Hz cycle—pulse #10, consistent with embodiments of the present disclosure. Rotor 400 reveals an end laminate 100 and retention bolt holes 140. FIG. 14 is a depiction of a four-pole rotor in a static state view of a sequential excitation cycle of the salient poles 110 which generates the rotating magnetic poles. The salient poles 110 are numbered 1-16. FIG. 14 illustrates pulse #10 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 10-13), south pole #1 is labeled S-A (salient poles 14-16 and 1), north pole #2 is labeled N-B (salient poles 2-5), and south pole #2 is labeled S-B (salient poles 6-9). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by nine rotor poles.

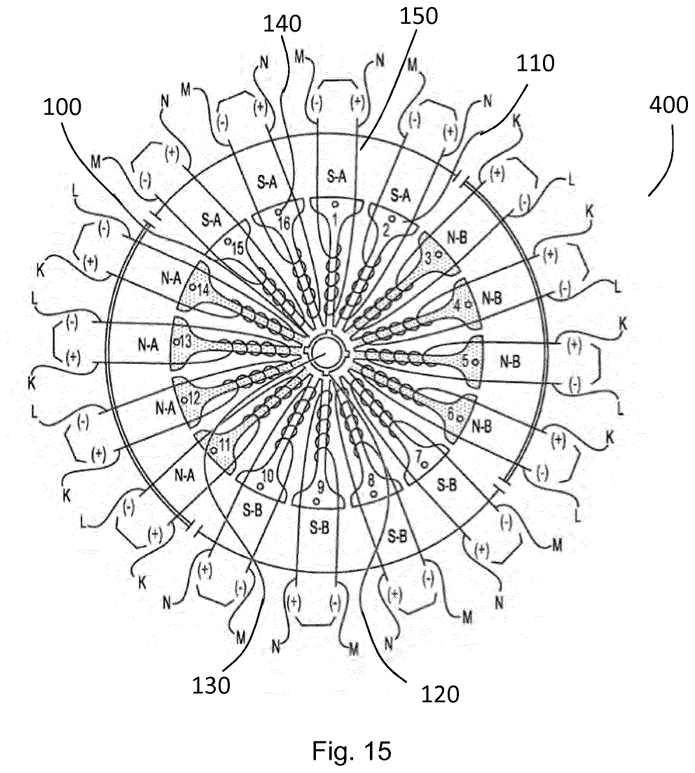

FIG. 15 is a diagram illustrating an end view of an exemplary solid state rotor 400 with pole windings 150 and excitation polarity sequencing circuits demonstrated for all 16 salient poles 110 through a four-pole, 60 Hz cycle—pulse #11, consistent with embodiments of the present disclosure. Rotor 400 reveals an end laminate 100 and retention bolt holes 140. FIG. 15 is a depiction of a four-pole rotor in a static state view of a sequential excitation cycle of the salient poles 110 which generates the rotating magnetic poles. The salient poles 110 are numbered 1-16. FIG. 15 illustrates pulse #11 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 11-14), south pole #1 is labeled S-A (salient poles 15-16 and 1-2), north pole #2 is labeled N-B (salient poles 3-6), and south pole #2 is labeled S-B (salient poles 7-10). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by ten rotor poles.

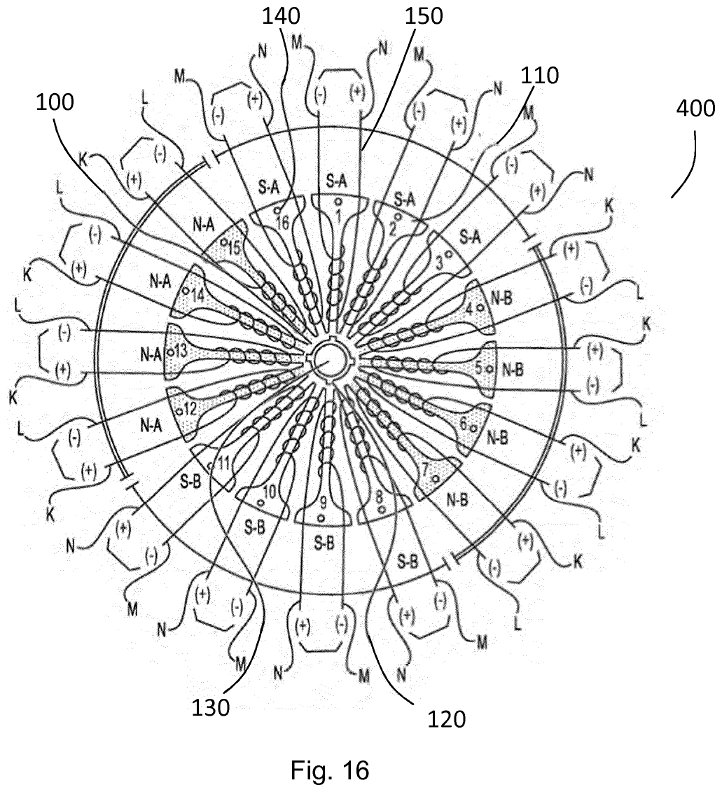

FIG. 16 is a diagram illustrating an end view of an exemplary solid state rotor 400 with pole windings 150 and excitation polarity sequencing circuits demonstrated for all 16 salient poles 110 through a four-pole, 60 Hz cycle—pulse #12, consistent with embodiments of the present disclosure. Rotor 400 reveals an end laminate 100 and retention bolt holes 140. FIG. 16 is a depiction of a four-pole rotor in a static state view of a sequential excitation cycle of the salient poles 110 which generates the rotating magnetic poles. The salient poles 110 are numbered 1-16. FIG. 16 illustrates pulse #12 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 12-15), south pole #1 is labeled S-A (salient poles 16 and 1-3), north pole #2 is labeled N-B (salient poles 4-7), and south pole #2 is labeled S-B (salient poles 8-11). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by eleven rotor poles.

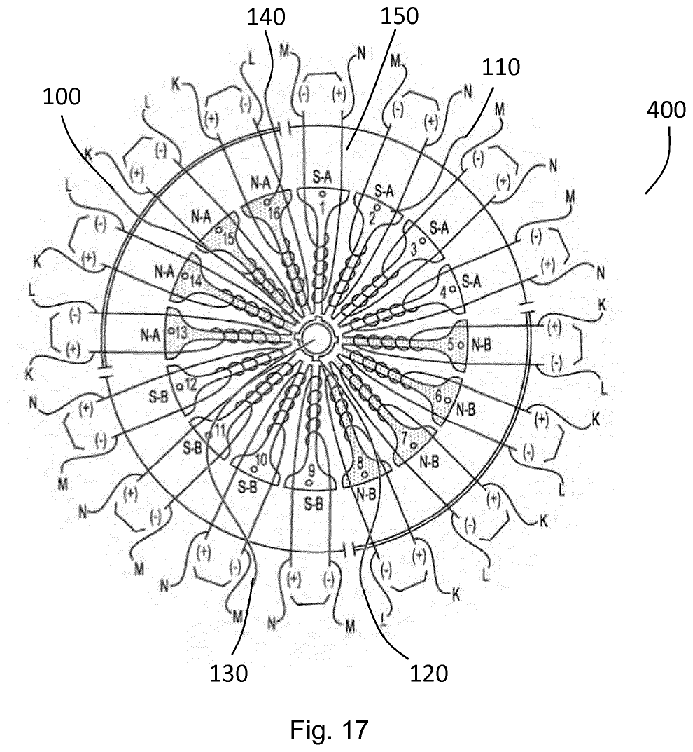

FIG. 17 is a diagram illustrating an end view of an exemplary solid state rotor 400 with pole windings and excitation polarity sequencing circuits demonstrated for all 16 salient poles through a four-pole, 60 Hz cycle—pulse #13, consistent with embodiments of the present disclosure. Rotor 400 reveals an end laminate 100 and retention bolt holes 140. FIG. 17 is a depiction of a four-pole rotor in a static state view of a sequential excitation cycle of the salient poles which generates the rotating magnetic poles. The salient poles 110 are numbered 1-16. FIG. 17 illustrates pulse #13 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 13-16), south pole #1 is labeled S-A (salient poles 1-4), north pole #2 is labeled N-B (salient poles 5-8), and south pole #2 is labeled S-B (salient poles 9-12). Each magnetic rotor pole consists of four electrically excited salient pole pieces wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by twelve rotor poles.

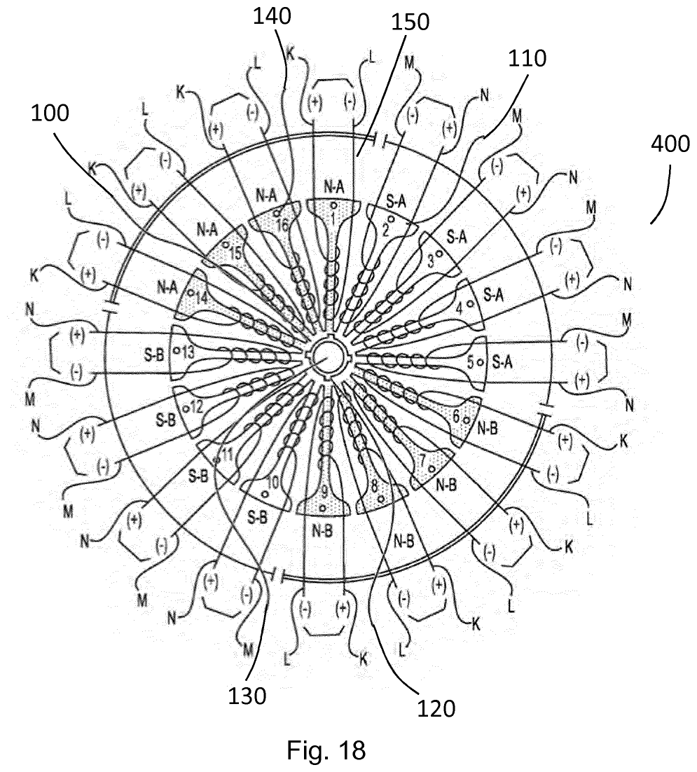

FIG. 18 is a diagram illustrating an end view of an exemplary solid state rotor 400 with pole windings and excitation polarity sequencing circuits demonstrated for all 16 salient poles through a four-pole, 60 Hz cycle—pulse #14, consistent with embodiments of the present disclosure. Rotor 400 reveals an end laminate 100 and retention bolt holes 140. FIG. 18 is a depiction of a four-pole rotor in a static state view of a sequential excitation cycle of the salient poles 110 which generates the rotating magnetic poles. The salient poles 110 are numbered 1-16. FIG. 18 illustrates pulse #14 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 14-16 and 1), south pole #1 is labeled S-A (salient poles 2-5), north pole #2 is labeled N-B (salient poles 6-9), and south pole #2 is labeled S-B (salient poles 10-13). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K (+), L(−), M (−) and N (+). These excitation leads are sequentially excited as in FIG. 5, except the polarity groups have shifted by thirteen rotor poles.

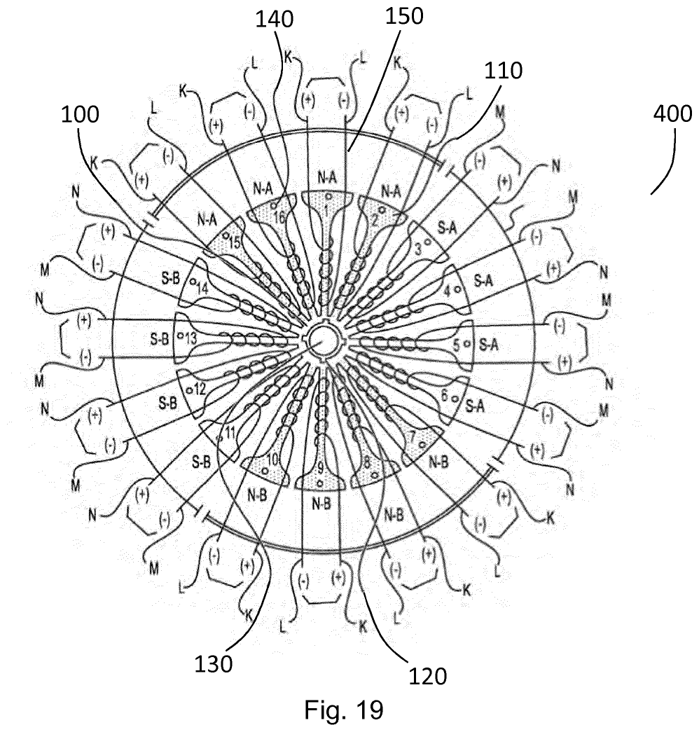

FIG. 19 is a diagram illustrating an end view of an exemplary solid state rotor 400 with pole windings 150 and excitation polarity sequencing circuits demonstrated for all 16 salient poles 110 through a four-pole, 60 Hz cycle—pulse #15, consistent with embodiments of the present disclosure. Rotor 400 reveals an end laminate 100 and retention bolt holes 140. FIG. 19 is a depiction of a four-pole rotor in a static state view of a sequential excitation cycle of the salient poles 110 which generates the rotating magnetic poles. The salient poles 110 are numbered 1-16. FIG. 19 illustrates pulse #15 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 15-16 and 1-2), south pole #1 is labeled S-A (salient poles 3-6), north pole #2 is labeled N-B (salient poles 7-10), and south pole #2 is labeled S-B (salient poles 11-14). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by fourteen rotor poles.

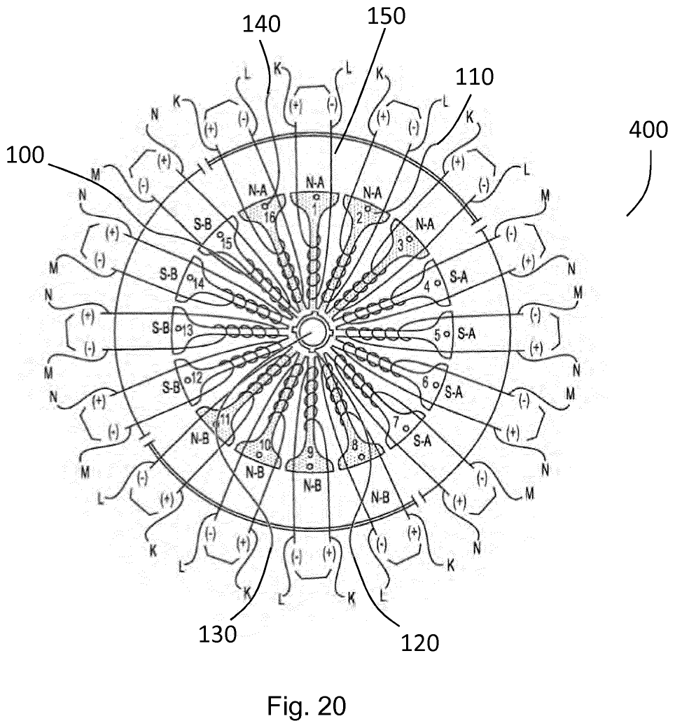

FIG. 20 is a diagram illustrating an end view of an exemplary solid state rotor 400 with pole windings 150 and excitation polarity sequencing circuits demonstrated for all 16 salient poles 110 through a four-pole, 60 Hz cycle—pulse #16, consistent with embodiments of the present disclosure. Rotor 400 reveals an end laminate 100 and retention bolts 140. FIG. 20 is a depiction of a four-pole rotor in a static state view of a sequential excitation cycle of the salient poles 110 which generates the rotating magnetic poles. The salient poles 110 are numbered 1-16. FIG. 20 illustrates pulse #16 of a 16 step generation and rotation of the four discrete magnetic poles involving 360° of rotation and two cycles of 60 Hz current. The mu metal sleeve 120 and shaft 130 are also revealed. The 4 magnetic poles are labeled: North pole #1 is labeled N-A (salient poles 16 and 1-3), south pole #1 is labeled S-A (salient poles 4-7), north pole #2 is labeled N-B (salient poles (8-11), and south pole #2 is labeled S-B (salient poles 12-15). Each magnetic rotor pole consists of four electrically excited salient pole pieces 110 wound with pole windings 150 which in the exemplary embodiment may be formed of magnet wire. The north pole wound magnet wire leads are expressed as K-L, and south pole wound magnet wire leads are expressed as M-N, with K (+), L (−), M (−) and N (+). These excitation leads are sequentially excited as in FIG. 5, except the polarity groups have shifted by fifteen rotor poles.

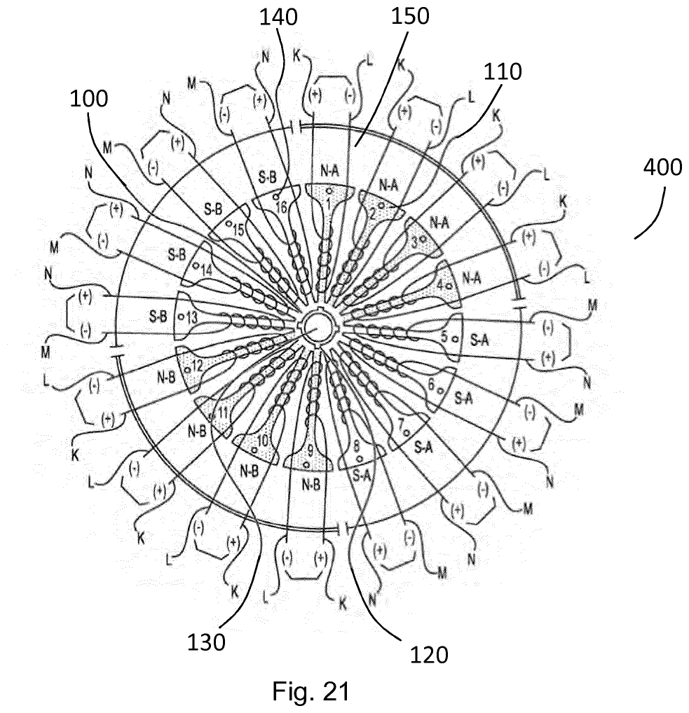

FIG. 21 is a diagram illustrating an end view of an exemplary solid state rotor 400 with pole windings 150 and excitation polarity sequencing circuits demonstrated for all 16 salient poles 110 through a four-pole, 60 Hz cycle-pulse #1, consistent with embodiments of the present disclosure and described in FIG. 5.

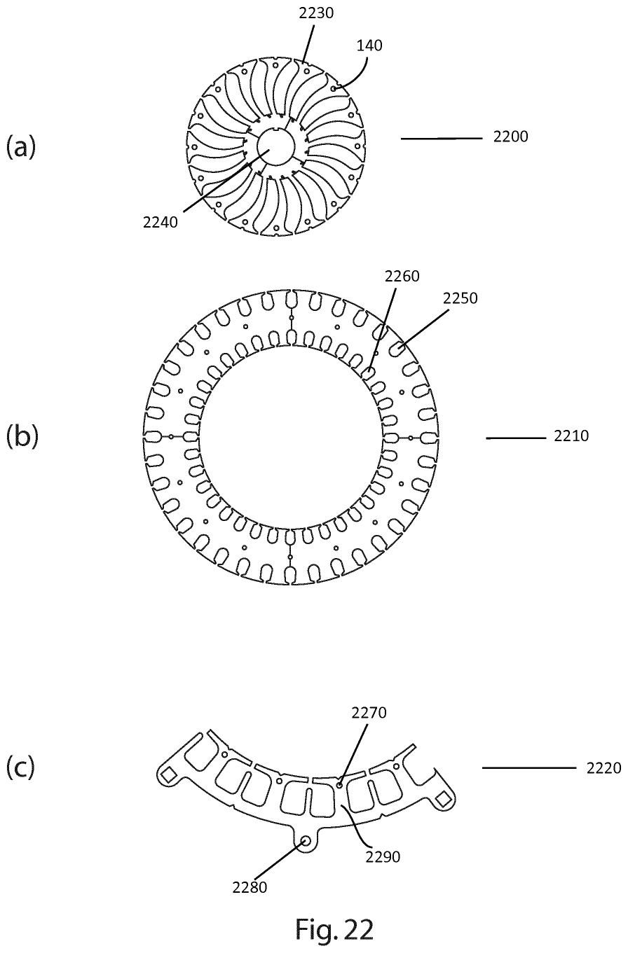

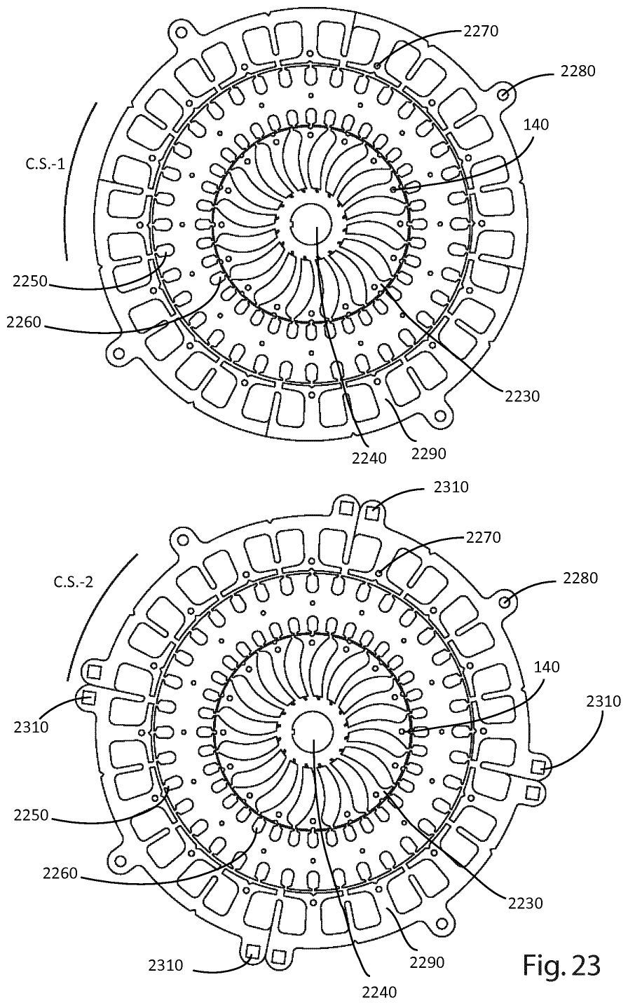

FIG. 22 is a diagram illustrating a cross-sectional view of separated exemplary components of the system of the present disclosure—namely, an inner rotor laminate 2200, a stator laminate 2210 and an outer rotor laminate 2220 according to embodiments of the present disclosure. Inner rotor 2200 in FIG. 22a reveals 16 salient pole pieces 2230 similar to those illustrated in the embodiment of FIG. 4. It is envisaged that the embodiment of FIG. 22 may alternatively comprise the salient pole pieces 110 illustrated in FIGS. 1-2 and 4-21. After these laminates 2200; 2210; 2220 are stacked, pressed and insulated, the salient poles 2230 may be wound with copper wire or other suitable conduction material such as graphene. After the inner rotor 2200 is wound and the proper leads installed, the inner rotor 2200 may be dipped in insulation varnish. It may then be baked at the proper temperature for the proper time. It is then mounted on a jig (not presented) through a shaft 2240. The stator laminates 2210 in FIG. 22b may be stacked and pressed at an appropriate pressure. In the exemplary embodiment, the stator laminates 2210 may be stacked and pressed under 50 tons of pressure. While under pressure, fastening members (not presented) may be installed through retention holes 140. The stator 2210 may then be insulated and wound. In the exemplary embodiment, winding is carried out with #18 American Wire Gauge insulated copper magnet wire. However, the choice of winding material is not contemplated as being limited to #18 American Wire Gauge copper magnet wire. In the exemplary embodiment, the winding formula constitutes 12 groups of three coils per group and 4 magnetic poles. The coils may be wound with 4 #18 American Wire Gauge wires in hand and 9 turns. The span may be 1-7 and the hookup may be “high wye”, “low wye” or “delta” but not limited to the above winding formulas or hookups. The stator 2210 is wound in outer slots 2250 and inner slots 2260.
The outer rotor laminate 2220 in FIG. 22c may be stacked to a desired thickness and pressed under the appropriate pressure. In some embodiments, the outer rotor laminate 2220 may be pressed under 50 tons of pressure. While under pressure, fastening members may be installed through retention holes 2270 and 2280. The outer rotor laminates 2220 are then insulated and wound. In the exemplary embodiment, the salient poles 2290 of the outer rotor laminate 2220 may be wound with #AWG copper magnet wire, 9 in hand, and 48 turns. As discussed above, the winding formula is not limited to #18 AWG copper magnet wire 9 in hand and 48 turns. After winding, the outer rotor 2220 may be dipped in insulation varnish and baked at the proper temperature for the proper time to cure the varnish. The inner rotor laminate 2200, the jig, the stator laminate 2210 and the outer rotor laminate 2220 may then be assembled into one piece (best presented in FIG. 23. The rotor leads are then hooked up in the proper fashion.

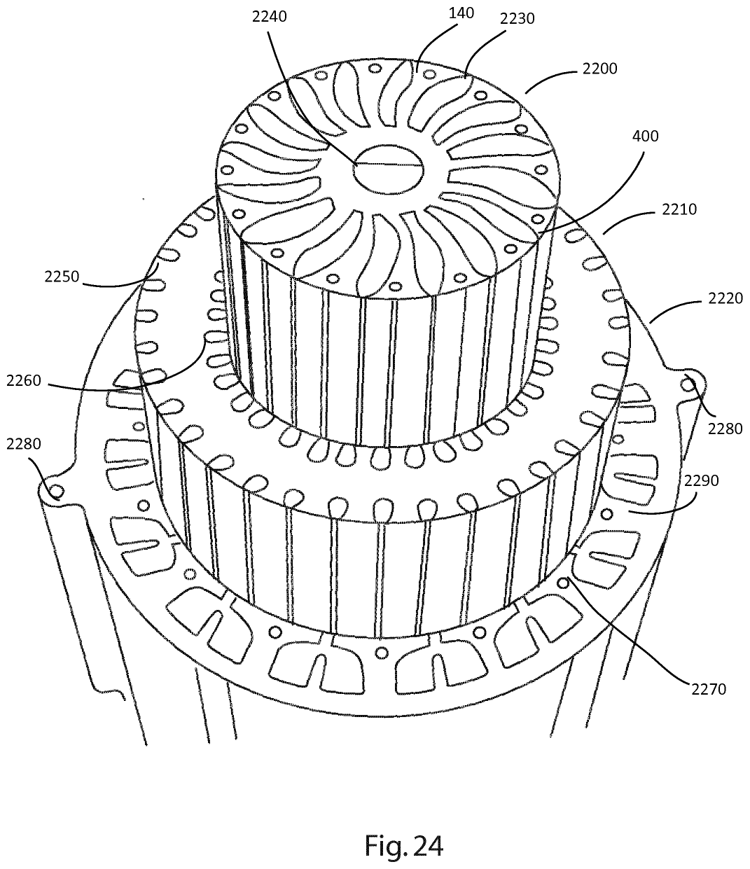

FIG. 23 is a diagram illustrating 2 cross-sectional end views C.S.-1 and C.S.-2 of the assembly of the exemplary inner rotor laminate 2200, stator laminate 2210, and outer rotor laminate 2220 consistent with embodiments of the present disclosure. The laminates in C.S.-2 contain assembly tabs 2310 which when stacked in the appropriate thickness are utilized in connecting and securing the four sections of the outer rotor assembly. However, the laminates viewed in C.S.-1 do not include the assembly tabs 2310. The laminates viewed in C.S.-1 are stacked and alternated with stacks of C.S.-2. Advantageously, the alternation of the C.S.-1 and C.S.-2 stacks makes assembly possible utilizing short fastening members such as short retention bolts in the assembly tabs 2310 rather than the more difficult task of fastening members going through the entire length of the outer rotor stator unit during assembly. The FIG. 24 reveals the position of inner rotor 2200 to inner stator laminate 2210 to outer rotor laminate 2220 as viewed in cross-sectional view C.S.-1 of FIG. 23. After these components are wound and connected they must be rotated one to the other while operating in order to tune them to maximum stable output.

FIG. 24 is a diagram illustrating a cross-sectional end oblique elevation of the assembly of the inner rotor laminate 2200, the stator laminate 2210 and the outer rotor laminate 2220, ready to insulate and wind, consistent with embodiments of the present disclosure. After the inner rotor laminate 2200, the stator laminate 2210 and the outer rotor laminate 2220 are wound and properly connected, they may be pressed together and tuned by an automatic tuning mechanism which rotates the components and is controlled by a voltage balancing feedback loop from voltage sensors placed on each of the three 3-phase legs output from the stator 2210. This will be explained in detail in a further ahead. In the exemplary embodiment, the ends of all three of the inner rotor laminate 2200, the stator laminate 2210 and the outer rotor laminate 2220 may be flush and locked in place when assembly and tuning is complete. Advantageously, the tuning mechanism is active and dynamic during operation.

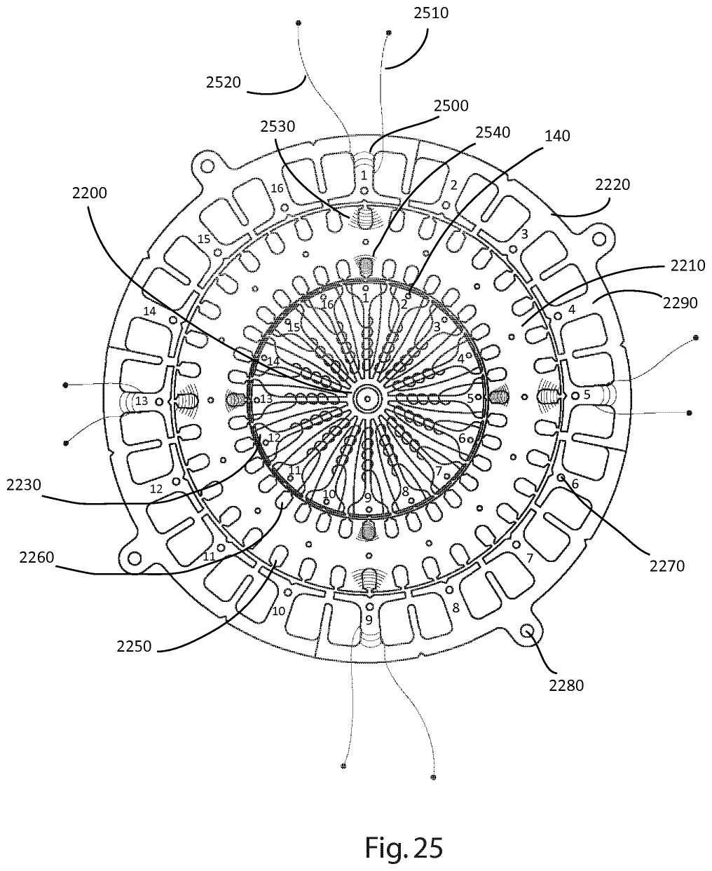

FIG. 25 through FIG. 29 reveal the interaction and function of the inner rotor laminate 2200 and the outer rotor laminate 2220 (as viewed in C.S.-1) in generating 3-phase electric power in the stator 2210 (inner stator and outer stator). The pole pieces 2230 of the inner rotor laminate 2200 and the pole pieces 2290 of the outer rotor laminate 2220 may be wound with the desired and appropriate electrical magnet wire. The pole pieces 2230 of FIGS. 25-29 are substantially similar to the pole pieces 110 illustrated in FIGS. 1-2 and 4-21, however other pole piece geometries such as the pole pieces 310 illustrated in FIG. 4. Generally, the pole pieces may define a variety of geometries, either one type of geometry in a single embodiment or multiple geometries in a single embodiment. Each of pole pieces may define, by way of example only, one or more of substantially elliptical, rectangular, or ovular geometries. The magnet wire coils 2500 may be terminated in two leads 2510; 2520 and the two leads 2510; 2520 from each pole may be connected in series or in parallel to a computer controlled gating system using, for example, a programmable logic center (PLC), allowing switching in an alternate fashion from a first polarity to a second polarity and from the second polarity to the first polarity by use of, for example, a MOSFET gating system in an excitation circuit. In the case of a four pole inner rotor 2200 and outer rotor 2220 wired in parallel or in series, when flux 2530 in FIG. 25 is north pole, flux 2540 is south pole, the salient poles 2230; 2290 may be wired into four groups of four poles per group or two groups of eight poles per group but not limited to two or four groups. In alternative embodiments, the groupings may be defined differently.

In a case of a 60 Hz power and four pole rotor as illustrated in FIG. 25, pole 1 of group 1 is a first polarity in the inner pole rotor 1 and a second polarity in the outer rotor pole 1 and pole #1 or group #2 in the inner pole 5 is a second polarity and the first polarity in the outer rotor 5. Pole 1 of group 3 is a first polarity in the inner rotor salient pole 9 and pole 1 of group 3 is a second polarity in the outer rotor salient pole 9. Pole #1 of group 4 salient pole 13 is a second polarity inner rotor and pole #1 group 4 salient pole #13 is a first polarity in outer salient pole #13.

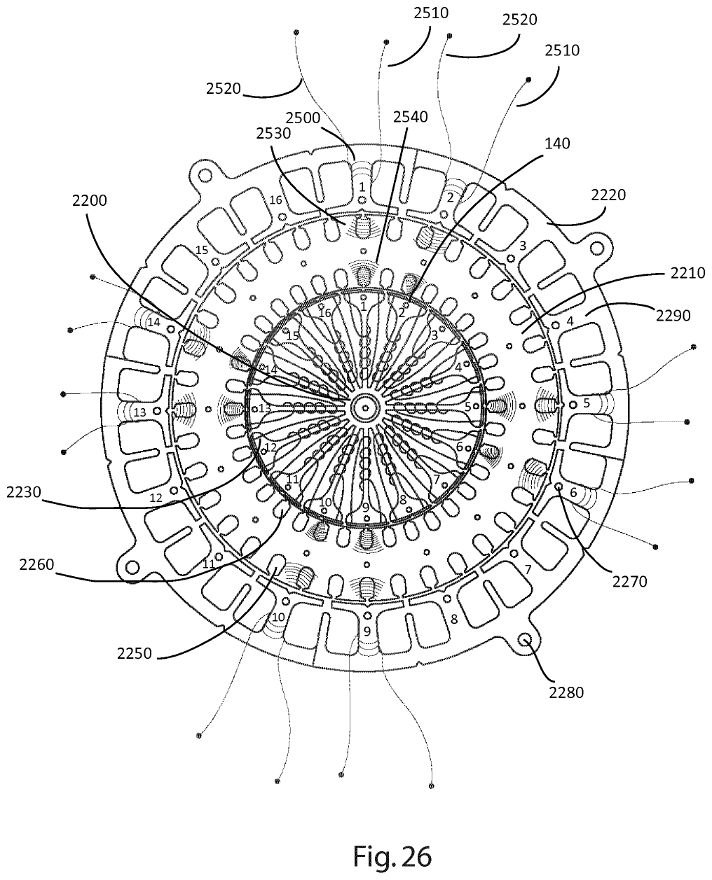

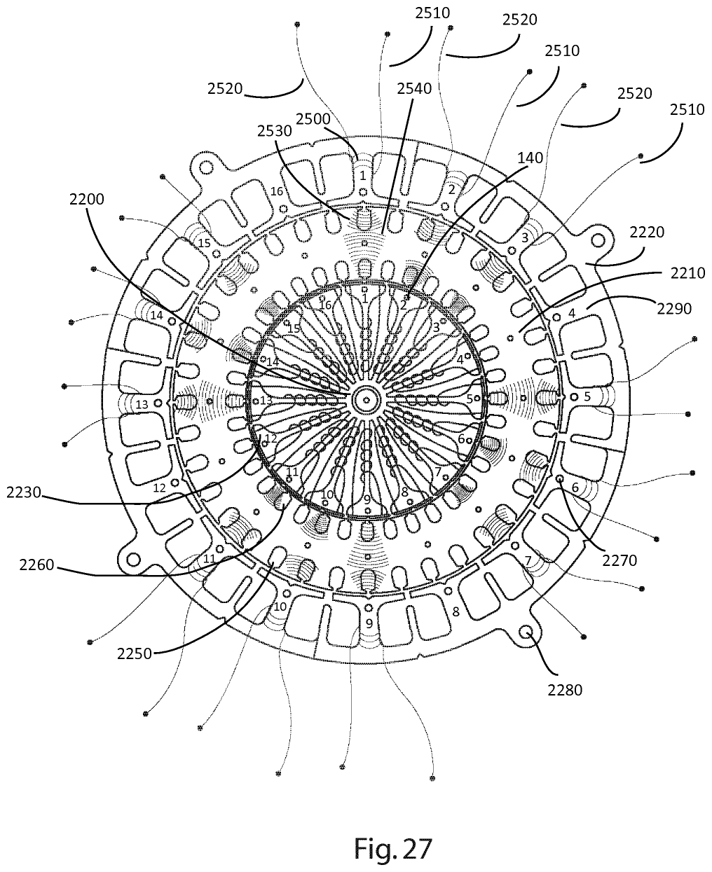

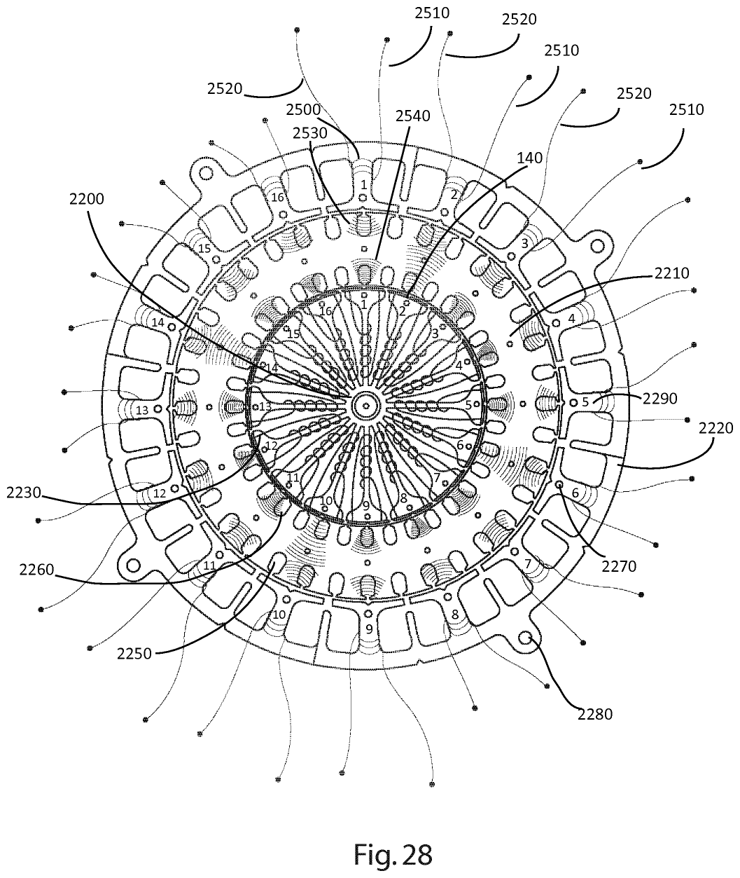

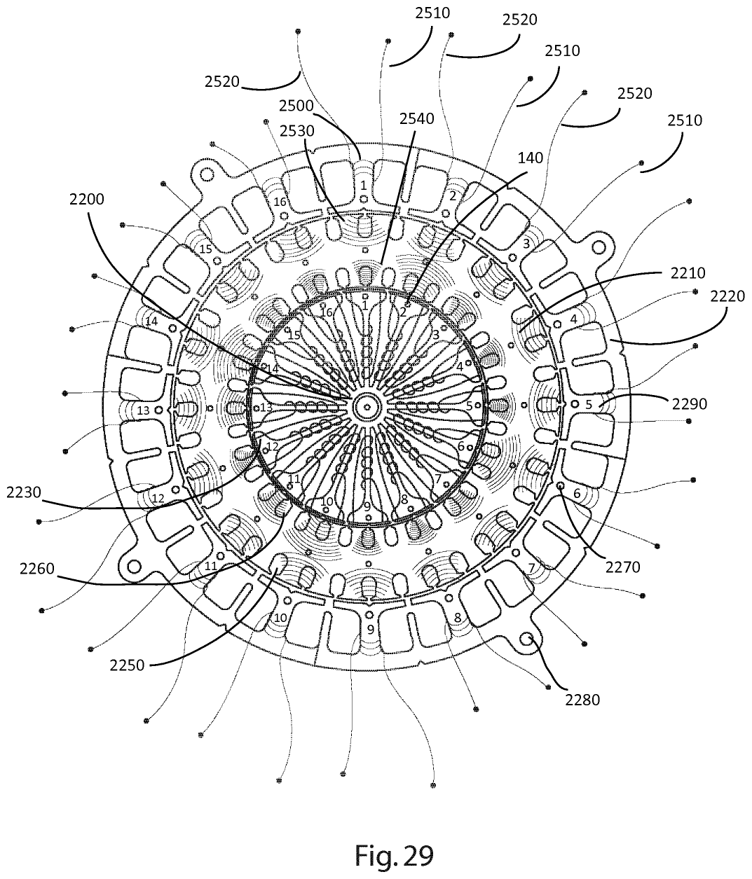

Pole #1 from each group may be excited by a solid-state exciter circuit (not presented). Pole #2 from each group may be excited by a solid-state exciter circuit. Pole #3 from each group may be excited by a solid-state exciter circuit. Pole #4 from each group may be excited by a solid-state exciter circuit. An exemplary excitation sequence is progressively illustrated in FIGS. 25-29: FIG. 25 pole #1 for each group may be excited and for example, 2.084 milliseconds later, FIG. 26 pole #2 may be excited; then again for example, 2.084 milliseconds later pole #3 FIG. 27 may be excited; then again, for example, 2.084 milliseconds later, pole #4 FIG. 28 may be excited; and for example, 2.084 milliseconds later, pole #1 FIG. 29 may be excited again and the cycle repeats.

Pole circuits may be excited with a first polarity DC power current in a first cycle and a second polarity DC power current in a second cycle. The first and second cycle make up one AC cycle every 16.667 milliseconds in the case of 60 hz power. Appropriate adjustments may be made for other frequencies such as 50 Hz. Each pole may be excited, for example, 4.167 milliseconds but not confined to 4.167 milliseconds with, for example, a 4.167 millisecond collapse time, but not limited to 4.167 millisecond collapse time, for each of the magnetic salient poles. The magnetic coupling between the salient poles 2230 of the inner rotor laminate 2200 and the salient poles 2290 of the outer rotor laminate 2220 increases the strength of the flux in the stator 2210 thereby improving power output. The excitation wave progresses clockwise which distorts each pole as it is forming, which pushes the magnetic flux in a progressive clockwise fashion by the repelling flux of the preceding pole. This, in effect, constantly pushes discrete separated magnetic poles in a clockwise circular fashion at a desired frequency and the poles are separated, alternate first polarity and second polarity. Accordingly every complete 16.667 millisecond cycle, the excitation switches from first polarity to second polarity such that the four distinct magnetic poles continue to rotate without physical rotation of the rotor 400 itself.

Adjustments may be made for other polar arrangements/groupings.

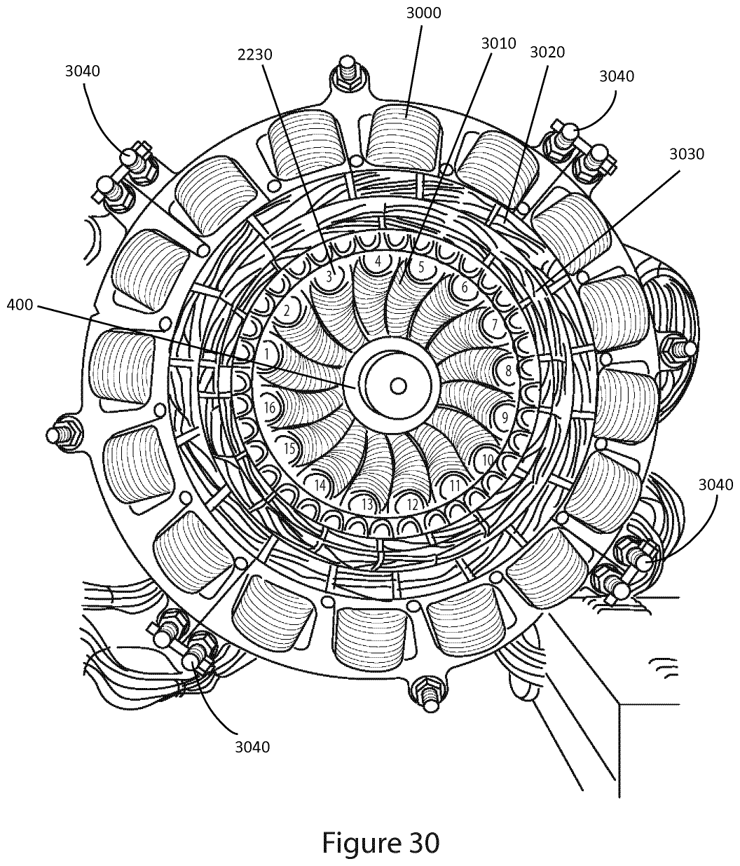

FIG. 30 is a diagram illustrating a superior end view of one of the embodiments of the present disclosure revealing the outer rotor windings 3000, the inner rotor windings 3010 along with outer stator windings 3020 and inner stator windings 3030. Also visible are fastening members 3040 inserted into the assembly tabs 2310 of the outer rotor laminate 2220 to secure the laminate stacks to build the rotor 400. Salient poles 2230 are labelled 1-16.

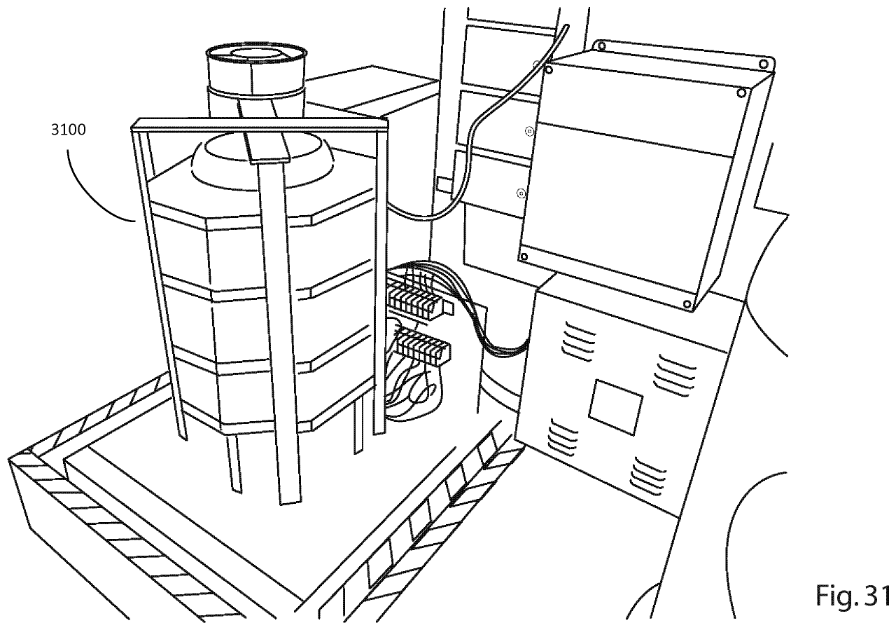

FIG. 31 is a diagram illustrating a superior oblique projection of a generator 3100 assembly including the wound and installed apparatus (outer rotor laminate, stator laminate and inner rotor laminate stack) according to the embodiments of any of the previous Figures.

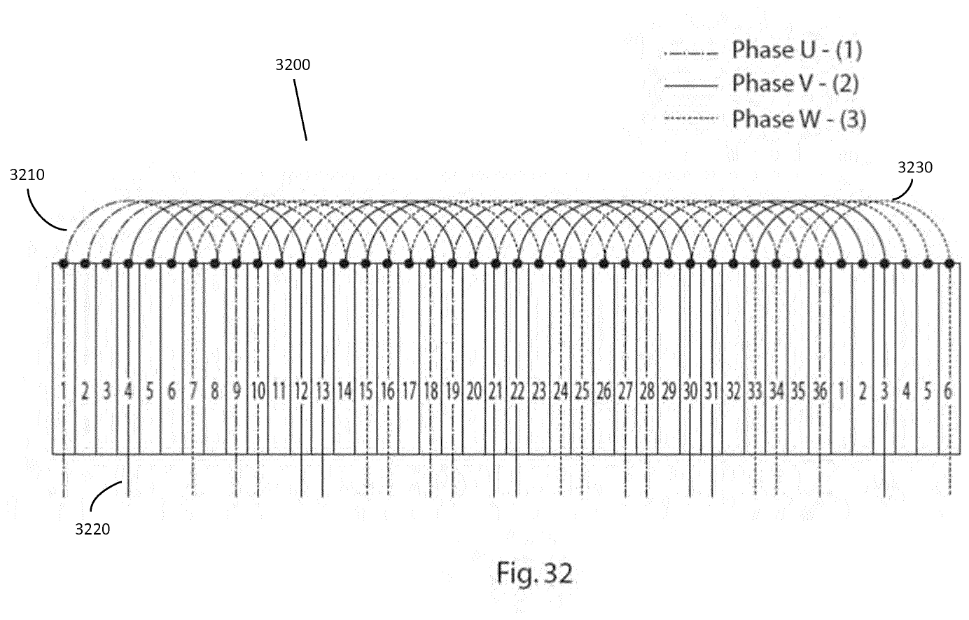

FIG. 32 is a diagram illustrating the base winding pattern 3200 of the stator 2210 consistent with embodiments of the present disclosure. The exemplary formula of FIG. 32 reveals four coil groups with three coils per group 3210; 3220; 3230. The coil span is 1-7 and the winding is a lap winding in 36 slots. The leads may be labeled in customary fashion to be connected in a “high wye” “low wye” or “delta” connection but not limited to these connections. The phase coils are herein coded by different line-types: dot-dashed=phase (1) or U, solid=phase (2) or V, dashed=phase (3) or W. Other coil groupings and spans are anticipated as being feasible.

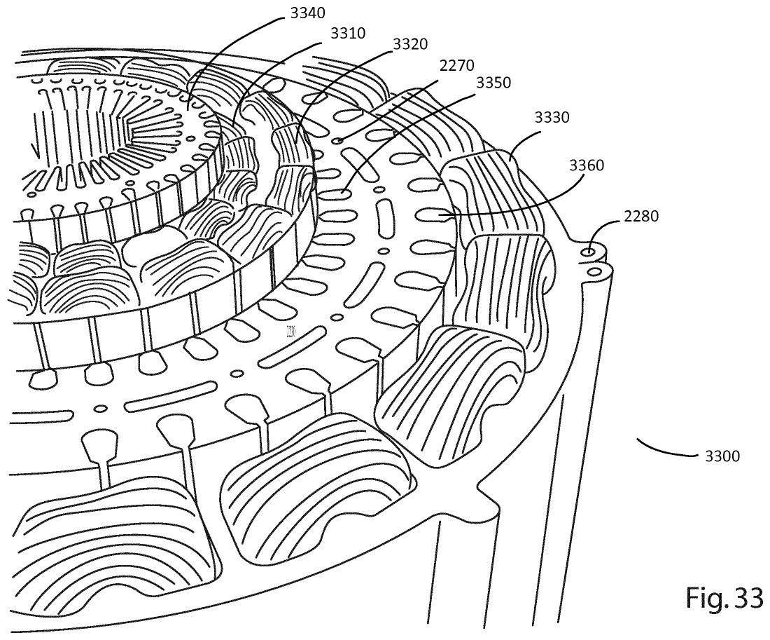

FIG. 33 is an illustration of an end view of an exemplary rotor 3300, including a plurality of the inner rotor laminate 2200, stator laminate 2210 and outer rotor laminate 2220 assembly, consistent with embodiments of the present disclosure. The design of the present disclosure allows unlimited numbers of rotors and stators to be expanded outward in a radial fashion to increase the output capacity in an exponential fashion. The numbering for this multi-layer rotor/stator unit is unique to this unit and in this respect differs from the single-stator, double-rotor unit depicted in FIGS. 22 and 23. The unit in FIGS. 22 and 23 may have a power output potential of 25 kW with 5 kW required to power the rotor coils 3000; 3010 which align the magnetic domains in the paramagnetic or ferromagnetic material which forms the rotor salient poles 2230; 2290. As the magnetic domains are aligned, the evolving magnetic flux excites the stator coils 3020; 3030 and produces electric power. The input power to the rotors 2200; 2220 is produced by the generator stator 2210 and is fed back through a battery capacitor interface through the solid-state relays which sends current to the rotors 2200; 2220. The winding for the unit in FIGS. 22 and 23 is as follows:

Outer Rotor Laminate 2220:

#18 AWG, 9 in hand, 48 turns

Outer Stator Laminate 2210:

#18 AWG, 4 in hand, 9 turns

12 coil groups

3 coils per group

The winding for the assembly in FIGS. 32 and 33 is as follows:

Rotor 3310:

#18 AWG, 9 in hand, 48 turns.

Rotor 3320:

#18 AWG, 11 in hand, 58 turns.

Rotor 3330:

#18 AWG, 18 in hand, 192 turns.

Stator 3340:

#18 AWG, 4 in hand, 9 turns;

Span 1-7; 12 coil groups, 3 coils per group.

Stator Windings in Slots 3350:

#18 AWG, 5 in hand, 9 turns;

Span 1-7; 12 coil groups, 3 coils per group, 5 coil groups in parallel.

Stator Windings in Slots 3360:

#18 AWG, 5 in hand, 9 turns, 12 coil groups;

Span 1-7; 3 coils per group, 7 coils in parallel.

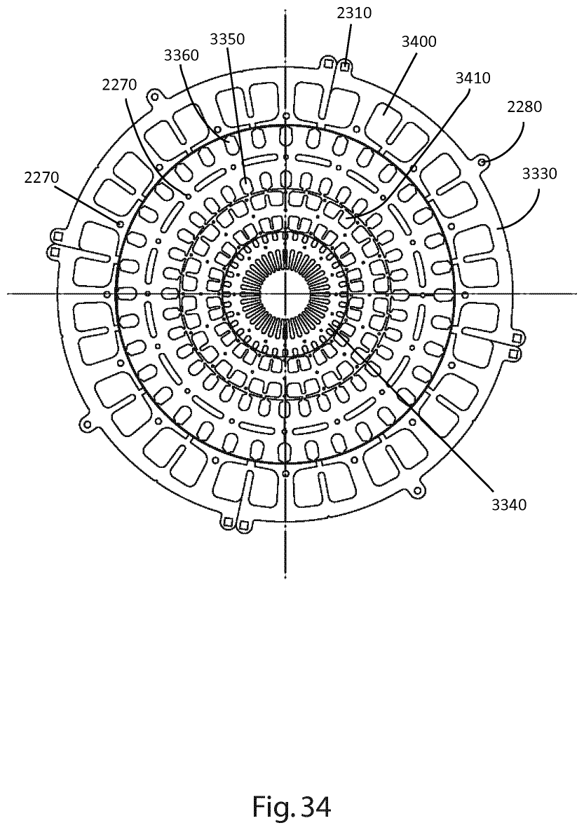

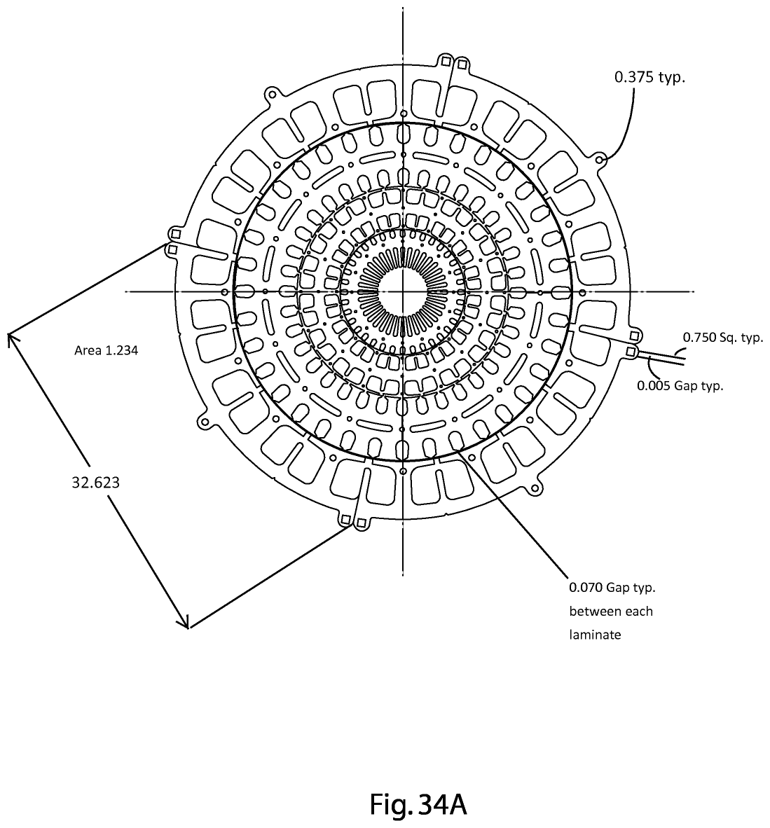

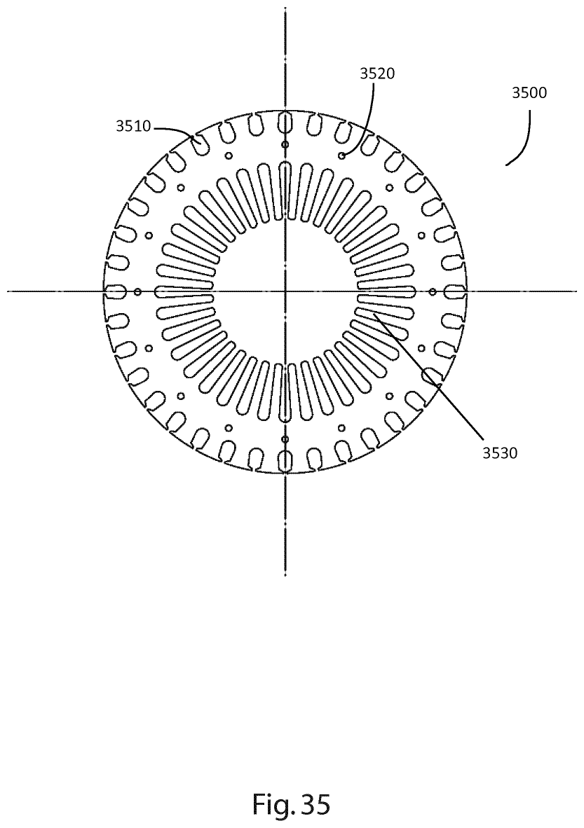

FIG. 34 is a diagram illustrating a cross-sectional view of the laminates of rotors and stators assembled as in FIG. 33. The various laminates are best presented in isolation in FIGS. 35-38.

When the slot area is examined for the rotors and stator slots, it is discovered that the stator slot capacity 3350 and 3360 is 12 times greater than the slot capacity of slots 2250; 2260 in FIGS. 22 and 23. The rotor slot capacity in 3400 and 3410 is 8.5 times greater than the equivalent slot illustrated in FIGS. 22c and 23. The increased power output is estimated below. The efficiency is equal to the sum of these differences—that is, a 20.5 times increase in power output or conservatively 12.5×20.5 is equal to 256.25 kW if one assumes that the output of a generator including the assembly of FIGS. 22 and 23 is 12.5 kW output. However the output capacity of the assembly of FIGS. 22 and 23 may be as high as 50 kW output. If that output can be extrapolated in this case the output capacity may be 1025 kW. FIG. 34A is illustrative of an embodiment of various measurements of the assembly of the laminates.

FIG. 35 is a diagram illustrating the inner stator laminate 3500, the same as that viewed in the embodiment of FIGS. 33 and 34. It reveals winding slots 3510, retention holes 3520, and heat sink members 3530. This laminate 3500 may be stacked in the desired fashion to the desired height and then pressed at the appropriate pressure for the appropriate time. While under pressure, fastening members such as torque bolts are installed in retention holes 3520. The stator laminate 3500 is then insulated and wound with the appropriate magnet wire. It is then hooked in a “wye” or “delta” connection but not limited to “wye” or “delta”. The stator laminate 3500 may then be dipped in insulation varnish and baked at the appropriate temperature for the appropriate time to cure the varnish.

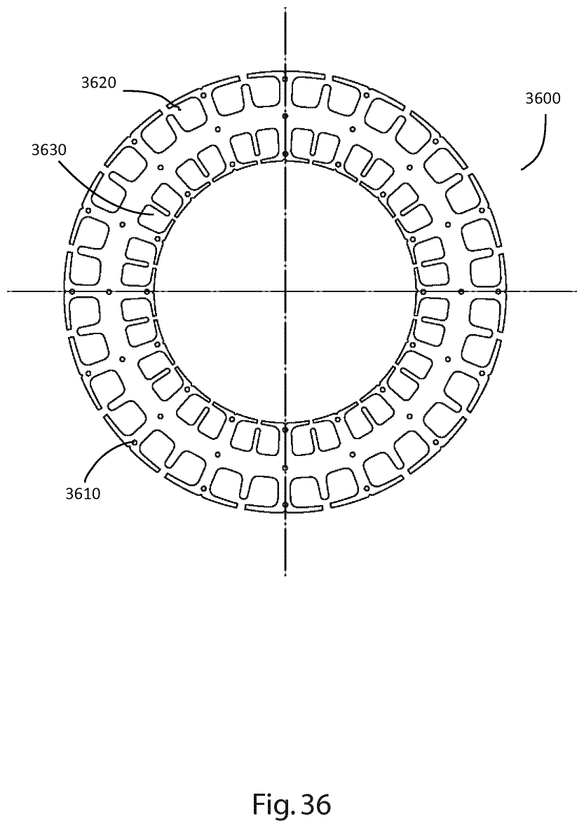

FIG. 36 is a diagram illustrating a drawing of an inner rotor laminate 3600, the same as that viewed in the embodiment of FIG. 34. The laminates 3600 may be stacked to the desired height and pressed under appropriate pressure for the appropriate period of time. Fastening members such as torque bolts may be installed in retention holes 3610. The laminates may then be insulated and wound with wire in slots 3620 and 3630. In the exemplary embodiment, the wire may be copper wire, although other embodiments with alternative wire materials in isolation or in combination are feasible. The coils may be tied down and lead wires such as the lead wires of FIGS. 25-29 attached. The laminates may then be dipped in insulation varnish and then baked at the appropriate temperature for the appropriate amount of time.

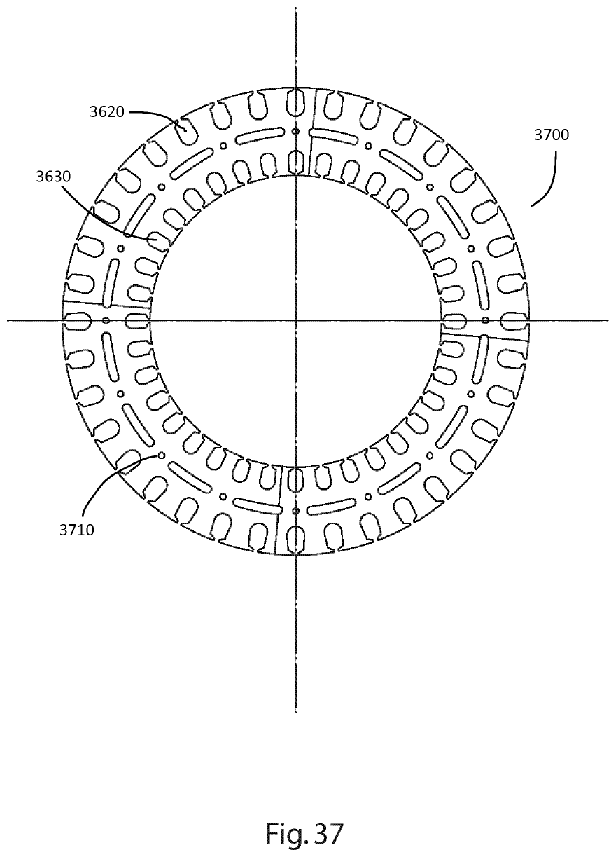

FIG. 37 is a diagram illustrating a drawing of the middle double stator 3700, the same as that viewed in the embodiment of FIG. 34. These laminates 3700 may be stacked to the desired height and then pressed at the appropriate pressure. While under pressure fastening members may be installed in retention holes 3710. The laminates may then be insulated and wound with the appropriate conductor material, in slots 3720; 3730. The coils are hooked up in a “wye” or “delta” connection but not limited to a “wye” or “delta” connection. The laminates may then be dipped in insulation varnish and baked for the appropriate time and at the appropriate temperature in order to cure the varnish.

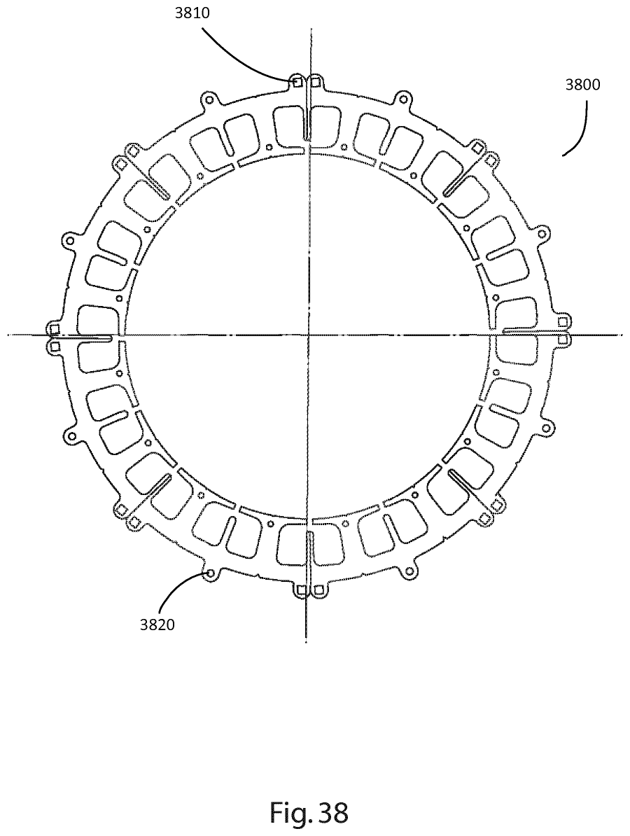

FIG. 38 is a diagram illustrating the drawing of an outer rotor laminate 3800, the same as that viewed in the embodiment of FIG. 34. The laminates 3800 may be cut into eight sections and stacked. Once they are stacked, they may be pressed and torqued together with fastening members, insulated and then wound. The leads may then be applied and tied down. The laminates may then be dipped and baked in an insulation varnish for the appropriate period of time at the appropriate temperature. The stacks are then assembled by the use of assembly tabs 3810 as well as retention holes 3820.

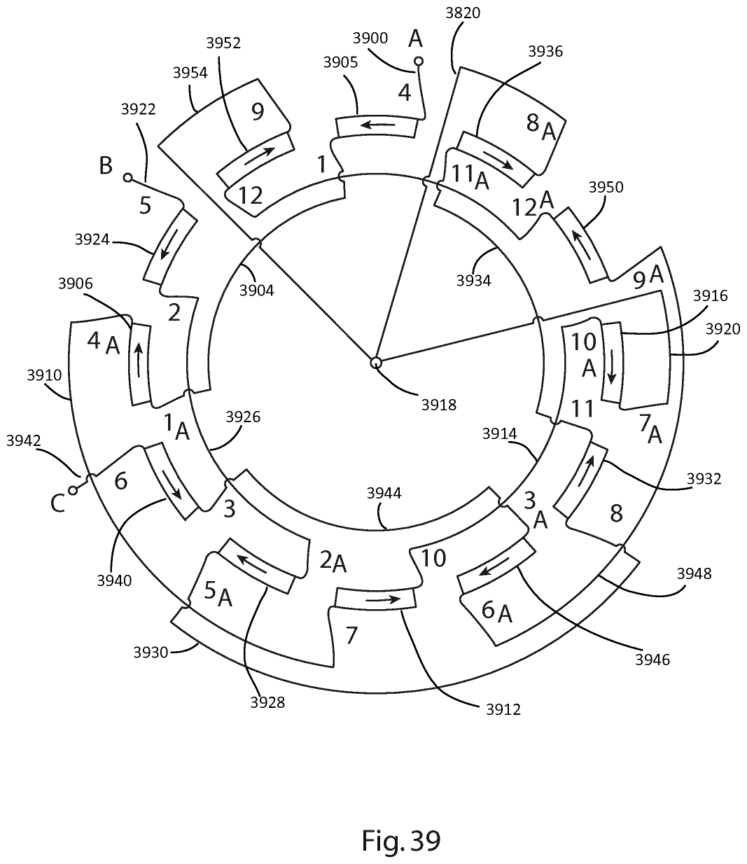

FIG. 39 is a diagram illustrating a drawing of the hookup of the stator of one of the embodiments of the present disclosure. Phase (1 or A or U) lead (4) 3900 is input to coil 3905, the output (1) is connected to (1)A through jumper 3904 (1)A feeds coil 3908. The output lead from 3906 (4)A is connected to lead (7) through jumper 3910. Lead (7) feeds coil 3912. Output lead (10) connects (10)A through jumper 3914. Lead (10)A feeds coil 3916. Lead (7)A out of 3916 is connected to neutral 3918 through jumper 3920.

Phase (2 or B or W) lead (5) 3922 is input to coil 3924. Lead (2) connects to (2)A through jumper 3926. Lead (2)A feeds coil 3928 and coil output lead (5)A is connected to lead (8) through jumper 3930. Lead (8) feeds coil 3932 and coil 3932 output lead (11) connects to (11)A through jumper 3934. Lead (11)A feeds coil 3936 in lead (8)A feeds neutral 3918 through jumper 3820.

Phase (3 or C or V) connects to coil 3940 through jumper 3942. Lead (3) connects to (3)A through jumper 3944. Lead (3)A connects to coil 3946 and output lead (6)A connects to (9)A through jumper 3948. Lead (9)A feeds coil 3950 and output lead (12)A connects to (12) which feeds coil 3952 and output lead (9) connects to neutral 3918 through jumper 3954.

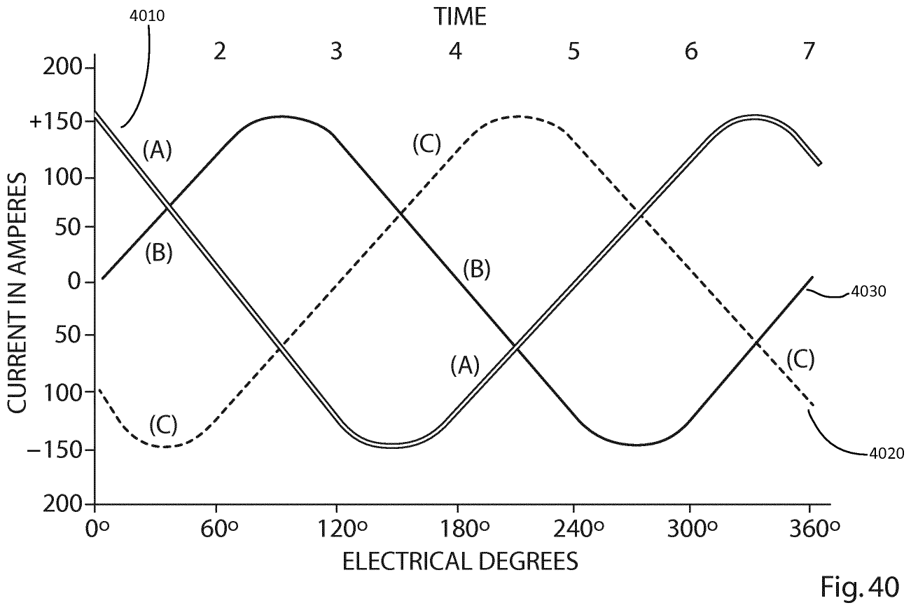

FIG. 40 is a diagram illustrating an oscilloscope tracing of the 3-phase power generated by stator laminates according to embodiments of the present disclosure. The three phase legs feed into each other. The leads which have a negative voltage receive electron flow from the more positive leads. As depicted at zero degrees, phase A 4010 feeds electrons into phase B 4020 and phase C 4030. At 90 degrees phase B 4020 is feeding electrons into phase A 4010 and phase C 4030. At 200 degrees phase C 4030 is feeding into phase B 4020 and phase A 4010. One complete cycle is 360 degrees.

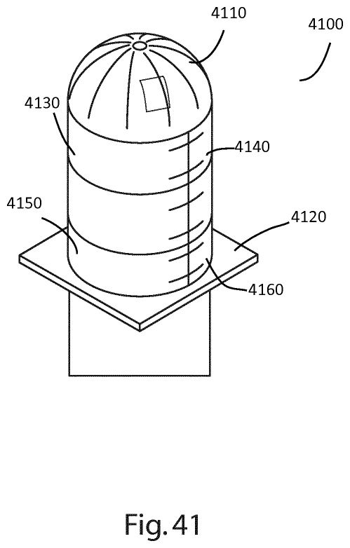

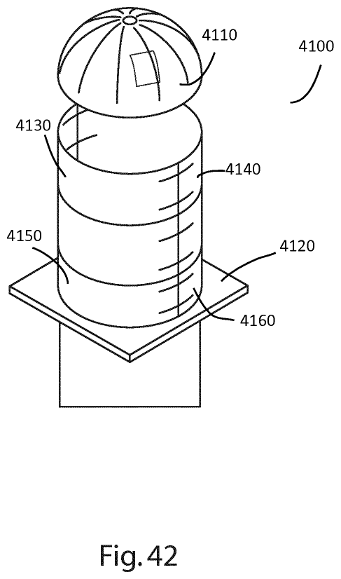

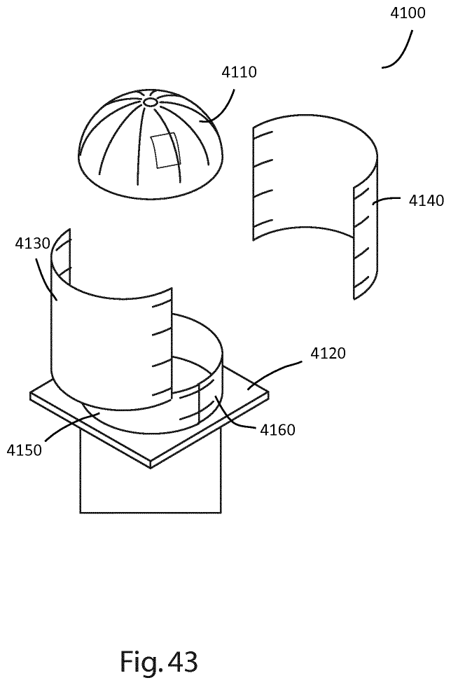

FIGS. 41-43 illustrate an elevated view of the cowling 4100 which covers the assembly of rotors and stators of embodiments of the present disclosure. The components may be manufactured according to a variety of appropriate methods, which may include but are not limited to: 3D printing, injection moulding, blow moulding, thermoforming and the like. The components may be manufactured in separable sections. Advantageously, when the generator is formed of separable sections an operator of the assembly may remove a section which is experiencing technical problems, without having to decommission the entire generator. The top bonnet 4110 can be lifted off as in FIG. 42. The base 4120 is made of metal and contains the rotating mechanism needed to rotate and tune the rotors during the tuning process. After tuning is complete the system is locked into place. In FIG. 42 and FIG. 43 it will be noted that the cowling components 4110; 4120; 4130, 4140; 4150; 4160 all may be separated from each other for easy assembly and disassembly.

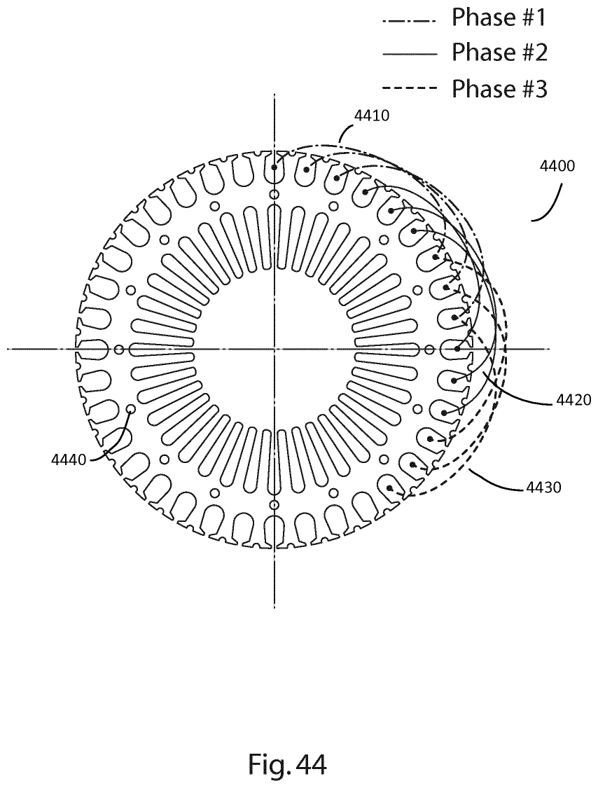

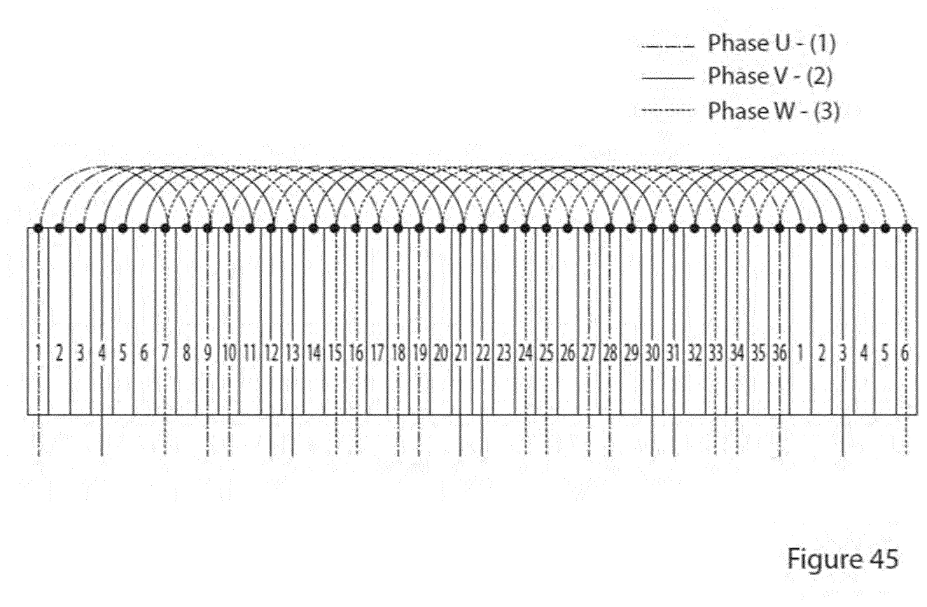

FIG. 44 is a diagram illustrating an end view projection of an oscillating modulator laminate 4400 with three of the phase winding coils 4410; 4420; 4430 in place consistent with embodiments of the present disclosure. In the case of a rotary generator in common use today at operating speed the rotor exerts a flywheel effect to stabilize the voltage and enhance the power output. In the case of the present disclosure the modulator 4400 serves the function of the rotor/flywheel effect. The modulator coil is constructed by pressing laminates of the present Figure which may be made up of 0.34 mm (but not limited to 0.34 mm) of electrical steel under the appropriate pressure. While under the appropriate pressure, fastening members such as torque bolts may be applied through retention holes 4440. After insulating the modulator laminate 4400, the slot coils 4410; 4420; 4430 are laid in place. The slot coils 4410; 4420; 4430 may be made of #18 AWG insulated copper magnet wire, but not limited to #18 AWG insulated copper magnet wire. In the exemplary embodiment there are 12 coil groups which are wound 5 in hand and 9 turns with a span of 1-7 in 36 slots, but not limited to 12 groups of coils, 5 in hand, 9 turns and a span of 1-7 in 36 slots. The hookup is in a 4-pole “high wye” stator hookup. Variable capacitor loads are connected across L1-L2, L2-L3, and L1-L3. Capacitors of variable loads are also across L1—Neutral, L2—Neutral and L3—Neutral. The coil winding and labeled leads are illustrated in FIG. 45. Specifically, a span of 1-7 is illustrated as the exemplary embodiment. The “high wye” hookup is displayed in FIG. 39.

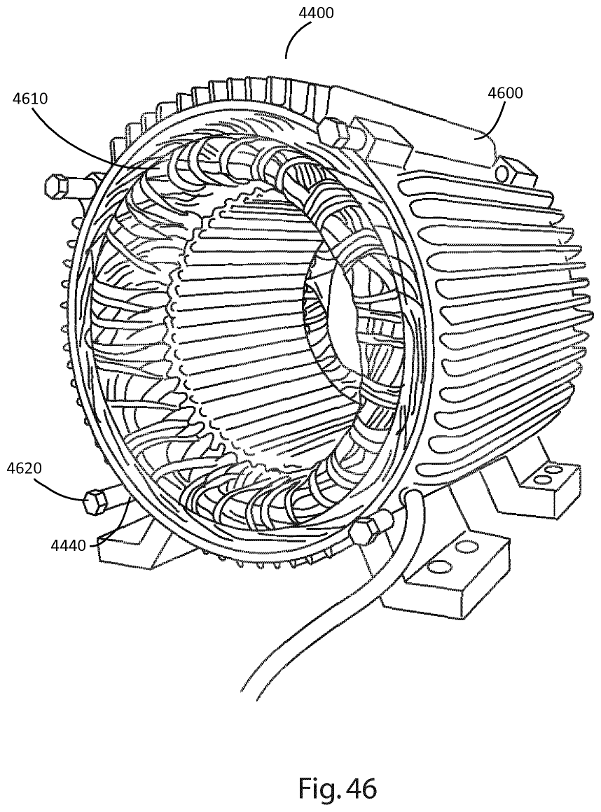

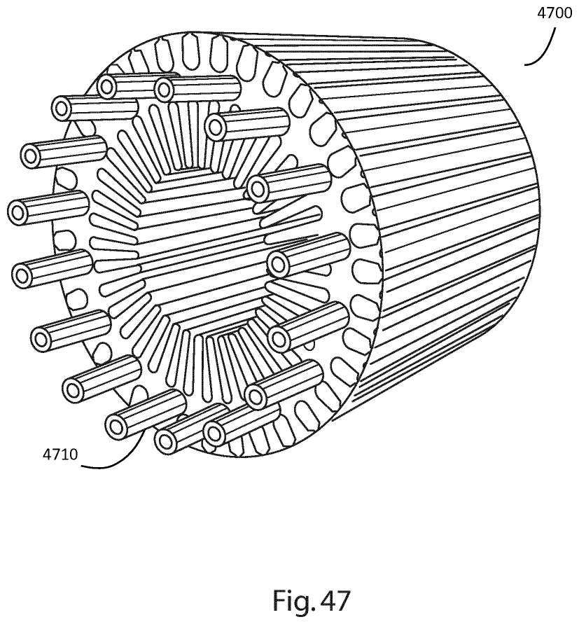

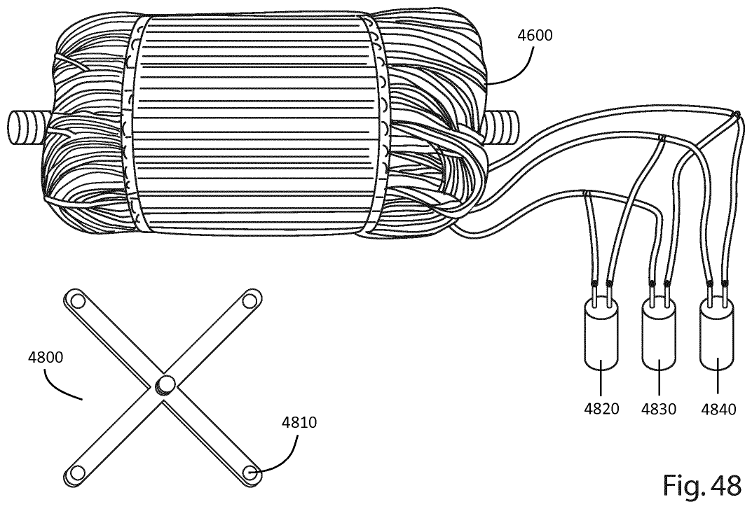

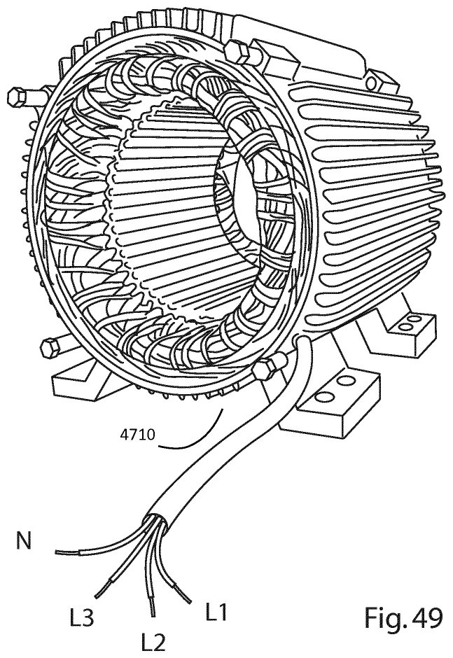

FIGS. 46-49 provide illustrations of an assembly of the oscillator modulator 4400. In particular, FIG. 46 is an illustration of the stator 4600 of the oscillating modulator 4400, fully wound with coils 4610 and hooked up as a 4-pole 1800 rpm 3-phase 60 Hz electric motor. FIG. 47 is an illustration of a modulator rotor 4700, which slides in to a stator 4600. The modulator rotor 4700 is fastened in place on both ends by retaining bar 4800 illustrated in FIG. 48, which also provides a side view of the stator 4600. The retention holes 4810 in FIG. 48 are configured to receive fastening members 4620 illustrated in FIG. 46. In the exemplary embodiment, capacitors 4820, 4830 and 4840 illustrated in FIGS. 48 and 49 are attached across L1-L2, L2-L3 and L1-L3 as well as L1—Neutral, L2—Neutral and L3—Neutral. The modulator 4400 operates by connecting leads from L1, L2 and L3 in FIG. 49 to the output leads of the stator system of FIG. 30 and FIG. 31. As the 3-phase power flows through the coils of the modulator stator 4600, four alternating poles are generated which rotate at 1800 rpm and generate a high voltage 3-phase power in the modulator rotor 4700 core. The capacitors 4820; 4830; 4840 are repeatedly charged and discharged into the winding of the modulator rotor 4700 coils. The oscillating flux influences the generator winding which influences the rotor impedance of the generator. Advantageously, the proper constant automating tuning of the capacitance across the leads of the modulator 4400 output will reduce the impedance of the generator rotor coils by greater than 50%, therefore the generator power output may be increased by greater than 50% of stable 3-phase power.

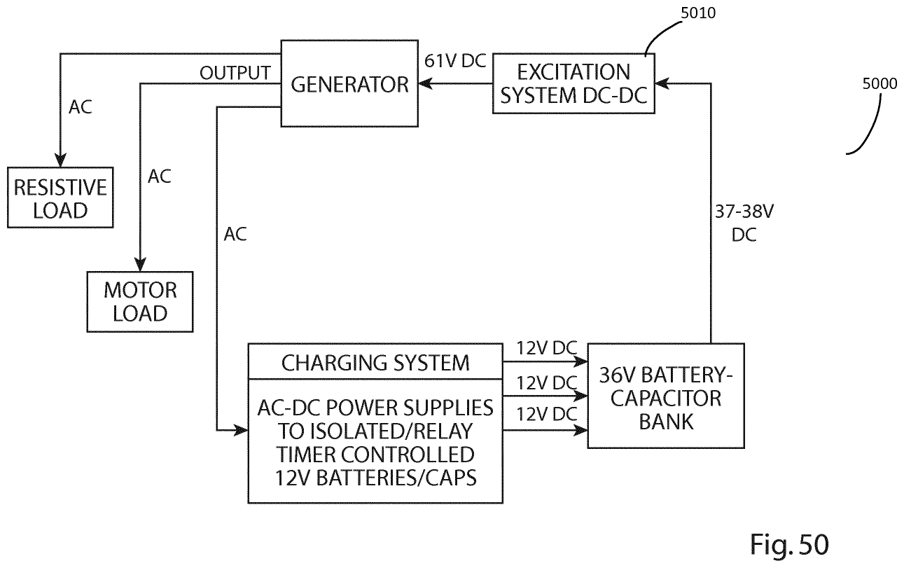

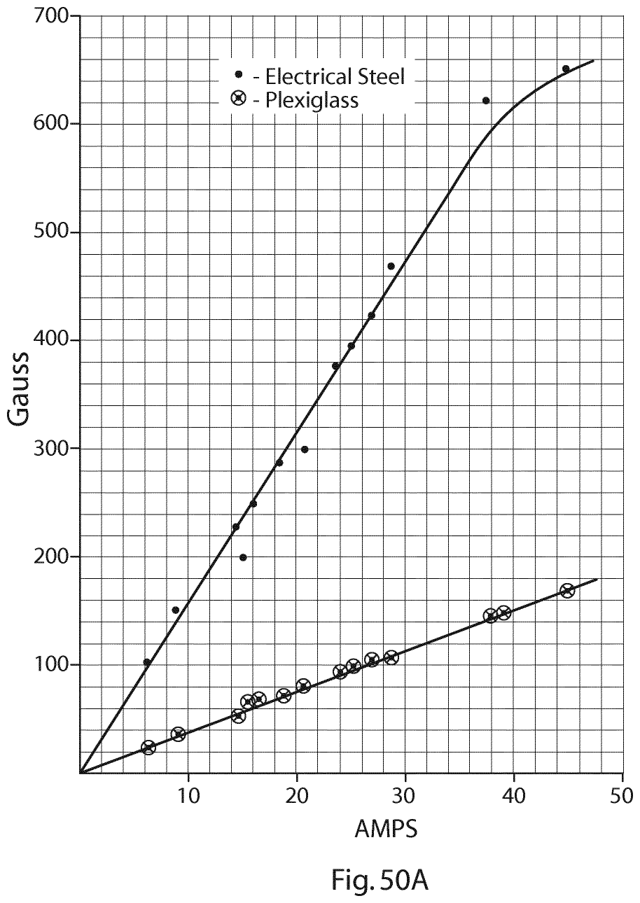

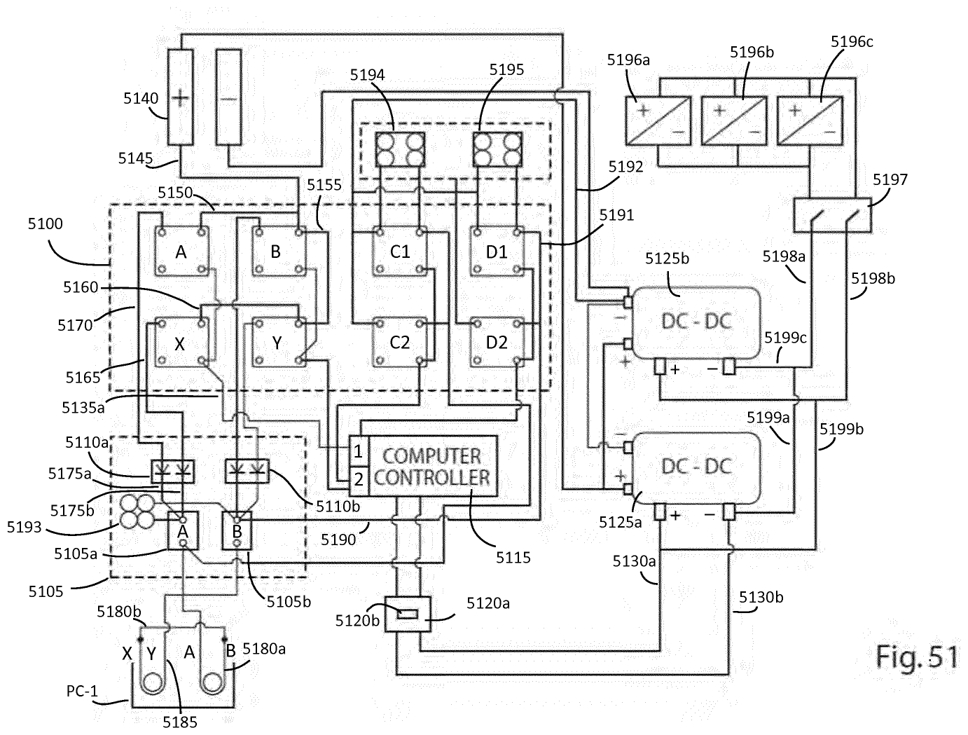

FIG. 50 is a block diagram illustrating processes relating to a self-sustaining generator 5000 consistent with embodiments of the present disclosure. The block diagram of FIG. 50 is an outline of the functioning self-sustaining operation of the generator of the present disclosure. The system is powered up by activating the computer system sequencing which is explained in the FIGs and descriptions of FIG. 1 through FIG. 21. The program brings about sequencing and excitation of the relays 5010. The relays 5010 open and close by the computerized sequencing program and send a voltage and current as a DC power to a MOSFET gating system in the solid-state relay bank. The proper relay opens and allows the current to flow through the proper rotor coils in generator 5000. The current flows through the coils and returns to the neutral of the power supplies which power the excitation system 5010. The power output from the generator 5000 is generated by the relatively weak magnetic fields formed by the rotor coils which align the magnetic domains of the electrical steel FIG. 50a. As the domains align the magnetic flux off the rotor increases exponentially until all the domains are aligned. When all magnetic domains are aligned, the electrical steel poles are said to be saturated. When all domains are aligned, additional current through the poles will only yield one unit of output power from the generator for each unit of input power. In routine operation, the generator 5000 may take one unit of power off of the stator and pass it through a capacitor interface and a DC-DC power supply, then run the one unit back through the rotor coils and aligns the magnetic domains such that each pole may produce at least 4.3 units of power for each unit of input to the rotors from the stator of the generator 5000. Importantly, this allows the generator 5000 to be self-sustaining but not a perpetual motion machine. The power is harvested from the process of aligning the magnetic domains with a proportionally weak magnetic field by the rotor coils. The magnetic domains are formed by the unpaired electron spin of the metal. This is no more perpetual motion than a solar panel. Solar powered photovoltaic (PV) panels convert the sun rays into electricity by the photons colliding with electrons in the silica (PV) cells. The electrons take the energy from the photons and the electrons fly out. The higher the oscillating frequency of the photons, the greater electron energy produced. The present disclosure uses the natural magnetic domains created by the unpaired electrons of the metal which are swung into alignment under the influence of the weak electromagnetic fields produced by the generator rotors. The summation of the aligned magnetic domains produces very powerful and moving magnetic fields. These moving magnetic fields push electrons through the stator windings to produce electricity. Solar cells harvest the power of the sun and the present disclosure harvests the power of the unpaired electron spin of the metal. FIG. 50A provides a hysteresis curve. Specifically, FIG. 50A illustrates a graphical plot of the variation of the strength of magnetic flux generated in units of Gauss vs. the magnitude of the current provided to the coils, for both electrical steel and Plexiglas. The strength of the magnetic flux generated at (say) 30A in the case of electrical steel is noticeably greater than in the case of Plexiglas, owing to the alignment of magnetic domains in the electrical steel according to embodiments of the present disclosure. FIG. 50A will be placed in context according to FIG. 51.

FIG. 51 is a diagram illustrating a view of a generator pole module 5100, as well as terminal blocks 5105a; 5105b and diode blocks 5110a; 5110b, consistent with embodiments of the present disclosure. The cycle begins with AC power turned on to the computer controller 5115. The power comes from DC/AC power supplies 5120a. In the exemplary embodiment, the power supply 5120a may be a DC-DC power supply. In the exemplary embodiment the power supply 5120a may take power from power supply 5125a through conduits 5130a and 5130b. In order to power the computer controller 5115, switch 5120b may be turned on. The computer controller 5115 sends a DC signal voltage through conduit 5135a to solid-state relays (SSR's) labelled A and X, the pulse opens MOSFET gates and A and X to allow the current from (+) power bar 5140 to flow through conductor 5145 on through conductor 5150 to SSR A and through 5155 and 5160 to SSR X. Pole SSR A and X sends current to diode block 5110a through conductors 5165 and 5170. Conductors 5175a and 5175b carry the current to terminal block A 5105a. From terminal block A 5105a current flows into the A side of the rotor pole coil PC-1. The current goes in a counterclockwise direction (North pole). The current flows into leads B 5180, the current flows in a counterclockwise direction and forms a weak electromagnetic north pole which aligns the magnetic domain of the electrical steel into a strong North pole orientation. The current flows from the B 5180a lead through X lead 5180b in a counterclockwise direction which forms an additive effect and results in an even stronger electromagnetic field which aligns more magnetic domains. The current flow is “titrated” to just below the saturation of the electrical steel of the rotor pole. This saturation is predetermined for each pole by performing a hysteresis curve such as that in FIG. 50A. The current then flows out through Y 5185 to terminal block B 5105b. Current then flows through conductor 5190 to SSR D2. Then through conductor 5191 to SSR D₁. The signal sent through conduit 5135a which opens the MOSFET of A and X simultaneously opens D1 and D2 which allows the current to return to the neutral of the power supply 5125b through conductor 5192. Capacitor bank 5193 is placed across terminal blocks A 5105a and B 5105b and the capacitor absorbs significant flyback as the current in the rotor coil is discontinued and the magnetic domains become once again randomly oriented. As this magnetic collapse occurs the current continues in the same direction but the voltage reverses polarity with a high magnitude spike which can damage the circuit. Therefore, capacitor banks 5193; 5194 are placed across the in and out terminals of C1 and C2, and capacitor bank 5195 is placed across the in and out terminals of D1 and D2.

The DC-DC power supplies 5125a; 5125b receive power from capacitor/battery banks 5196a; 5196b; 5196c through an on and off switch 5197 and then through conductors 5198a; 5198b. In parallel, DC-DC power supply 5125a receives power by jumpers 5199a; 5199b from conductors 5198b; 5199c. This FIG. 51 represents a pole module in embodiments of the present disclosure in which the rotor may comprise sixteen pole modules. As previously discussed, other numbers and/or groupings of poles and the necessary technical adjustments are anticipated as being feasible. The circuit which keeps the capacitor/battery banks topped off with power will be discussed further ahead.

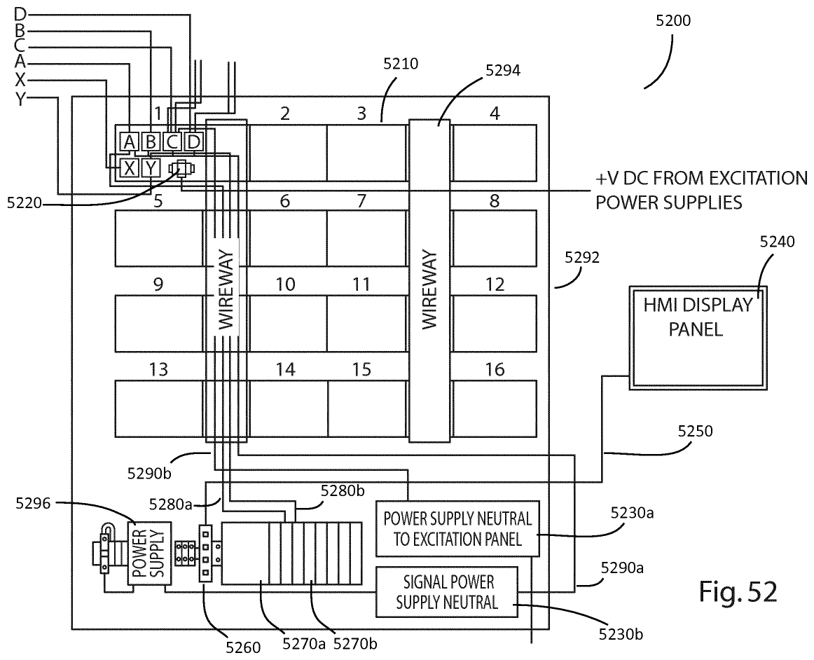

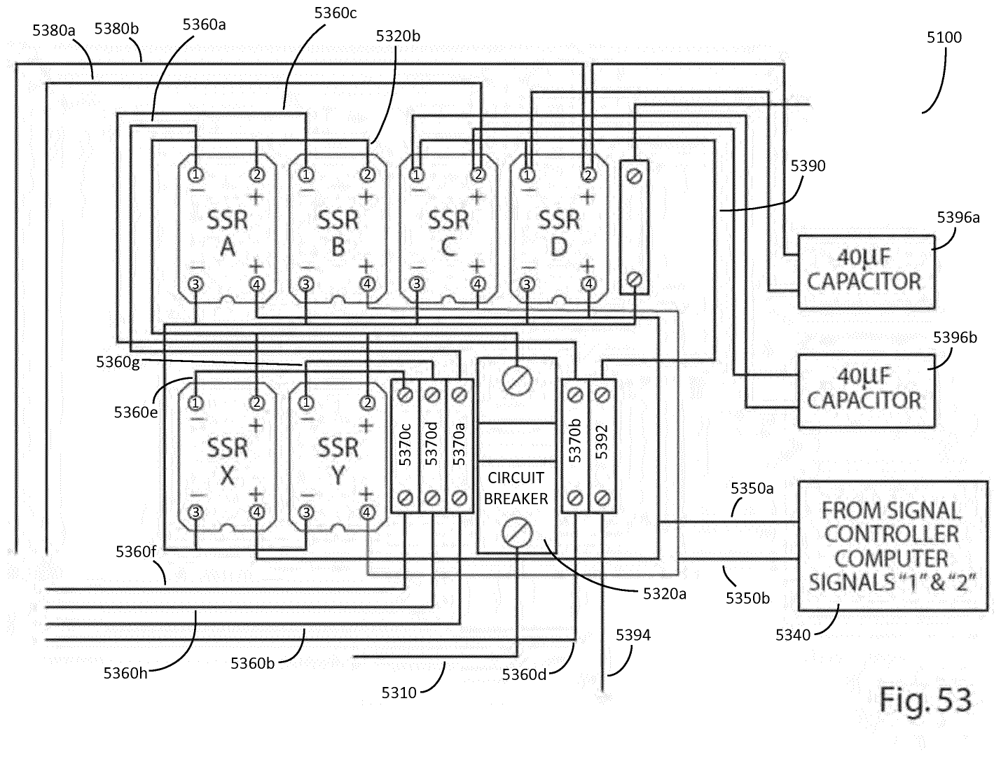

FIG. 52 is a diagram illustrating a view of the generator main control panel 5200 of the system, consistent with embodiments of the present disclosure. In the exemplary embodiment, the main control panel 5200 contains 16 pole modules 5210. Each pole module 5210 will be described in detail in FIG. 53. The pole modules 5210 herein represented contain six solid-state relays A, B, X, Y, C and D such as those illustrated in FIG. 51 and described above. They also contain one circuit breaker 5220 and four terminal blocks subsisting in power supply neutral 5230a and signal power supply neutral 5230b. This FIG. 52 reveals the Human Machine Interface (HMI) display panel 5240 which sends a signal through ethernet cable 5250 through a router switch 5260 to microprocessor controllers 5270a; 5270b. The signal to the relays is sent from the processor card through shielded conductors 5280a and 5280b with neutrals 5290a and 5290b. Cabinet 5292 houses all of the main controls. The wires are routed through wire trough 5294. The microprocessor 5270a; 5270b containing the central processing unit (CPU) and the IO cards receives its operating power from a 24 volt power supply 5296.

FIG. 53 is a diagram illustrating a view of one of the generator pole modules 5100 in some detail, consistent with embodiments of the present disclosure. In particular, this FIG. is a detailed description of the input and output of power to the relays as described in FIG. 51. The power to the rotor coils which is routed by the SSR's enters the pole module 5100 through conductor 5310 from the DC-DC power supplies. The current goes through circuit breaker 5320a and through conductor 5320b to the input side (2) of SSR's A, B, X and Y. The relay's MOSFET gates are opened and closed between (1) and (2) by a signal from “1” and “2” from signal controller computer 5340 at a timing sequence which is programmed to give a desired sequence among the generator pole modules 5100. The control signal “1” and “2” flows through 5350a and 5350b to open the MOSFETS A, B, C, D, X and Y as described in FIG. 51. The current then flows from (2) through the MOSFET to terminal (1). In the case of SSR A the current flows through conductor 5360a to terminal block A 5370a and through conductor 5360b out to the diode block into the rotor coil A lead. SSR B current flows through conductor 5360c to terminal block B 5370b and out through conductor 5360d to the diode block and the rotor coil B lead. In the case of SSR X current flows through conductor 5360e into terminal block X 5370c and through conductor 5360f to the diode block and the rotor coil X lead. In the case of SSR Y current flows through conductor 5360g to the terminal block Y 5370d and out through conductor 5360h to the diode block and rotor coil Y lead.

The current returns from the rotor coils through conductors 5380a and 5380b to SSR's C and D and as the signal controller opens the MOSFET between (1) and (2) current flows through conductor 5390 to power supply neutral terminal block 5392 and through conductor 5394 back to the neutral of the power supply. Capacitors 5396a and 5396b are located across the power terminals (1) and (2) of SSR's C and D to absorb the fly-back voltage when the magnetized rotor collapses during each cycle. In the exemplary embodiment, the capacitors each have a capacitance of 40×10⁻⁶ s⁴A²m⁻²kg⁻¹ (40 μF). Alternative values of capacitance are anticipated as being feasible, based on various other circuit parameters for different scales of the generator in various embodiments.

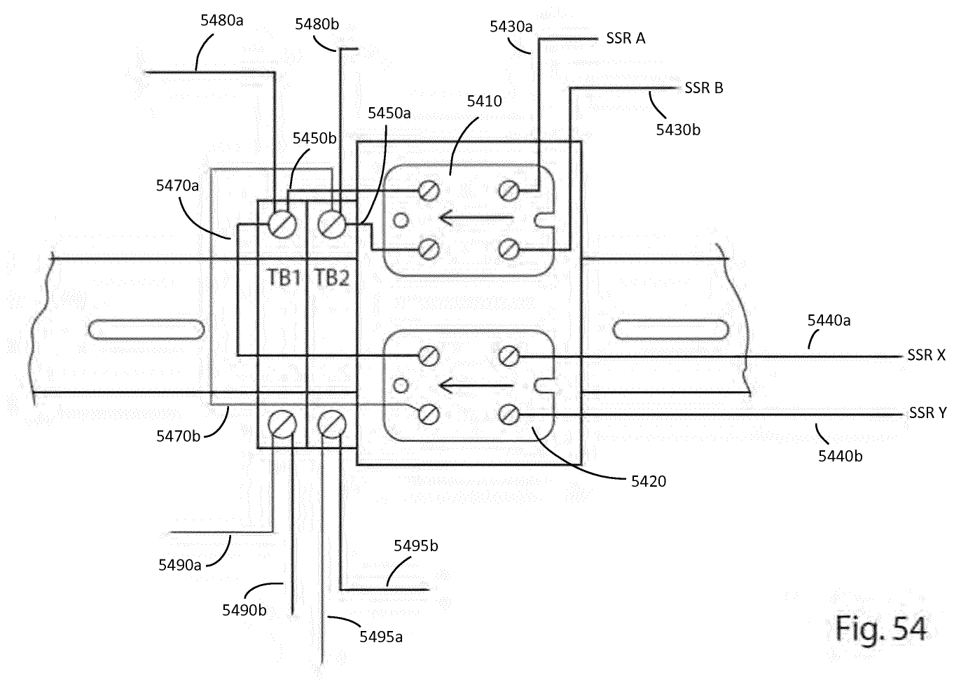

FIG. 54 is a diagram illustrating a view of one of the generator pole module diode block/terminal junctions consistent with embodiments of the present disclosure. The function of the diodes 5410; 5420 is to allow current to flow in only one direction and thus avoid fly-back into the SSR control system from the collapsing coils. Diode 5410 takes current from SSR A along conductor 5430a and from SSR B through conductor 5430b. Diode 5420 receives current through conductor 5440a from SSR X and through conductor 5440b from SSR Y. The output from diode 5410 is through conductor 5450a to TB (terminal block) 2 and through conductor 5450b to TB 1. The output from diode 5420 goes through conductor 5470a to TB 1 and through conductor 5470b to TB 2. The current from TB 1 goes through conductor 5480a to SSR D and from TB 2 through 5480b to SSR C. The output from TB 1 through conductor 5490a to rotor “X” coil and through conductor 5490b to rotor coil “A”. The output from TB 2 through conductor 5495a to rotor coil “B” and through conductor 5495b to rotor coil “Y”.

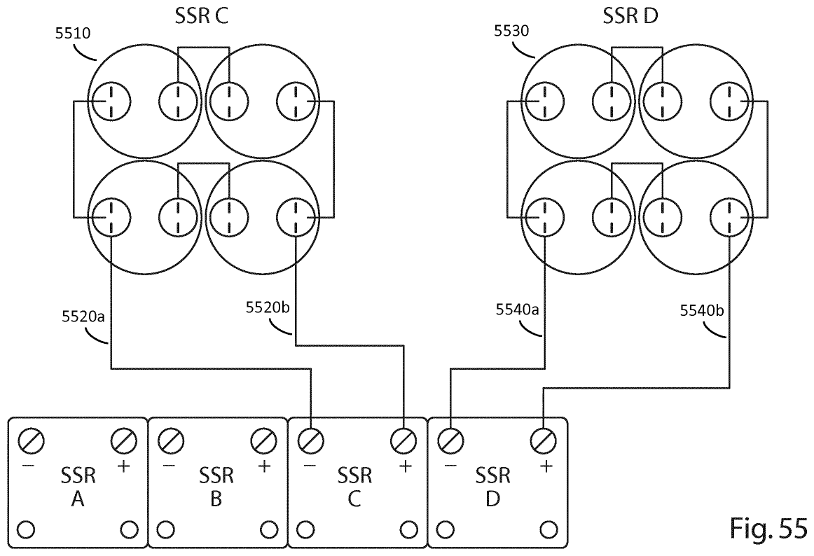

FIG. 55 is a diagram illustrating one of the capacitor bank isolation pole discharge units, consistent with embodiments of the present disclosure. This system may be utilized for fly-back mitigation. The bank of four capacitors are connected in series and parallel. In the exemplary embodiment, the four capacitors each have a capacitance of 20×10⁻⁶ s⁴A²m⁻²kg⁻¹ (20 μF). Capacitor bank 5510 is across the poles of SSR C through conductors 5520a and 5520b. Capacitor bank 5530 is connected across the power poles of SSR D through conductors 5540a and 5540b.

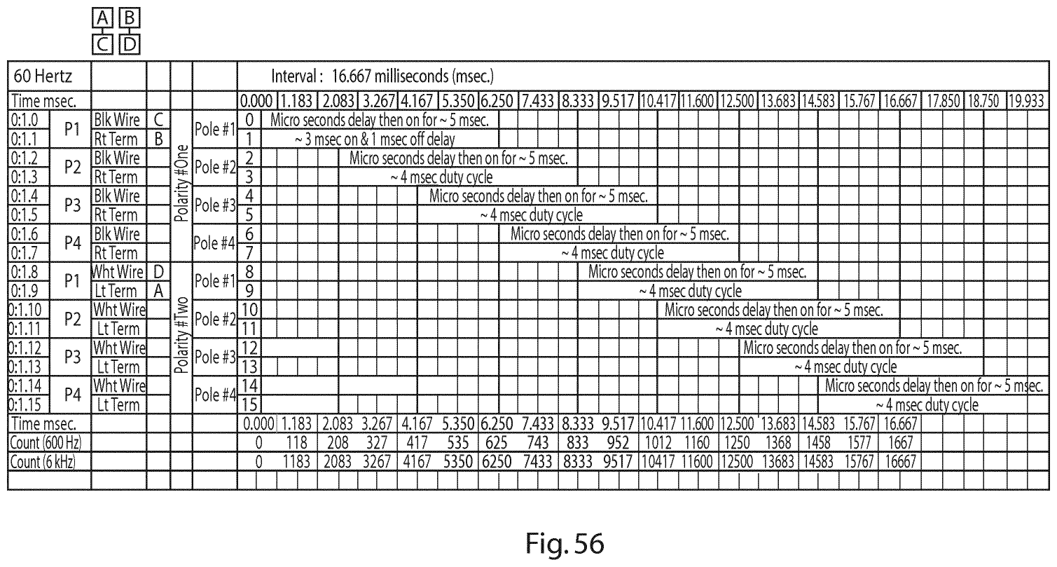

FIG. 56 is a diagram illustrating the signal time sequence program of the computer controller 5115 consistent with embodiments of the present disclosure. This is a one-time cycle which in some embodiments may last 16.667 milliseconds.

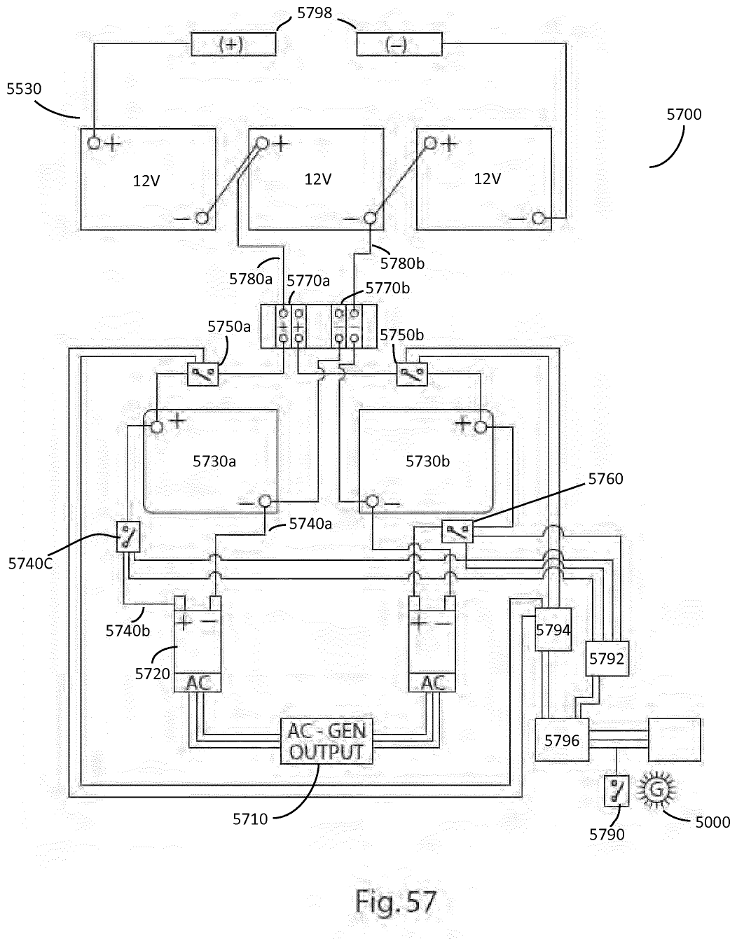

FIG. 57 is a diagram illustrating an isolated capacitor charging system 5700 consistent with embodiments of the present disclosure. In order to provide a stable input to the DC-DC power supplies which supplies the rotor relays, the battery/capacitor charging system 5700 may be isolated. In the exemplary embodiment, this is accomplished by charging one side of a dual battery charging system 5700, while the other side is isolated and discharging into the capacitor battery bank 5510 of FIG. 55. AC power is taken off the stator of the generator 5000 onto power bar 5710. In the exemplary embodiment, the power supply 5720 is AC powered from the generator output and charges capacitor 5730a through neutral conductor 5740a and positive 5740b and open relay 5740c to positive terminal of the capacitor 5730a. Relay 5750a is closed and relay 5750b of capacitor B 5730b is open but relay 5760 is closed. Capacitor 5730b may be open to capacitor battery bank 5530 of FIG. 55 through open relay 5750b. In the present embodiment the capacitor battery bank 5530 may comprise a potential difference of 36 Volts comprising three 12V capacitors/batteries connected in series, however other total values and/or groupings and configurations of capacitors/batteries are anticipated as being feasible to accommodate varying needs of users or and scales of the generator 5000 of the present disclosure. The positive pole conductor connects to terminal block 5770a and the negative conductor connects to terminal block 5770b. Conductor 5780a connects to the positive pole of the 36 volt battery bank 5530, conductor 5780b connects to the negative pole of the battery bank 5530. The next cycle 12 Volt capacitor 5730b is in charge cycle and capacitor 5730a is in discharge to the 36 Volt capacitor/battery bank 5530. This isolated battery charging system 5700 is the interface between the stator output of the generator 5000 and the rotor input back into the generator 5000.

Also presented in FIG. 57 are on/off switch indicator module 5790, relay timer control circuits 5792; 5794, power supply 5796 and excitation bus 5798.

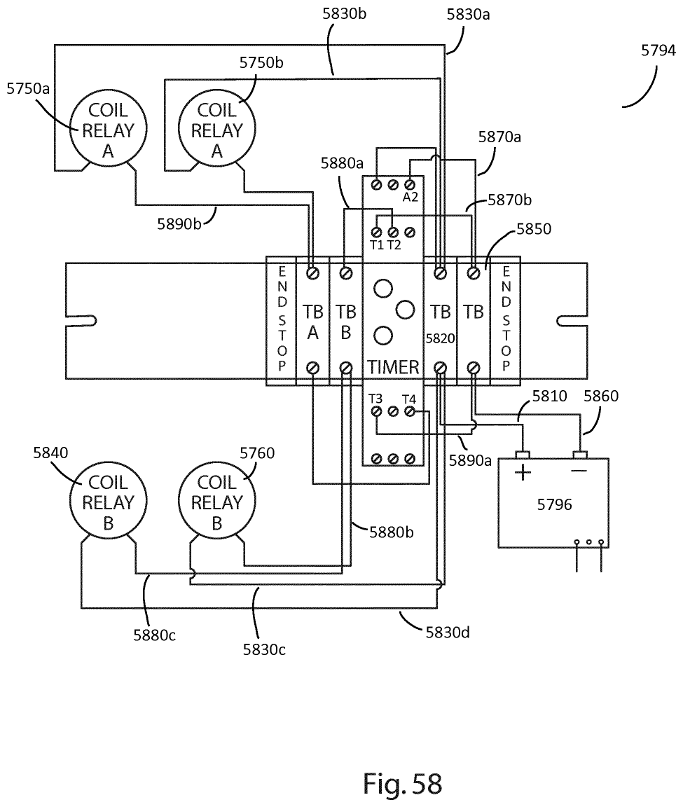

FIG. 58 is a diagram illustrating the relay timer control circuit 5794 of the isolation battery charger 5700 consistent with embodiments of the present disclosure. In the exemplary embodiment, the relay timer control 5794 is powered by a 24 Volt DC power supply 5796. The power supply 5796 may be powered with off-the-generator stator. In some embodiments, the off-the-generator stator is a 120 volt AC off-the-generator stator. The timer 5794 may cut through the neutral side of the circuit. Positive conductor 5810 connects with TB 5820. Conduit 5830a carries current to coil relay A 5750a. Conduit 5830b carries current to coil relay A 5750b. Conduit 5830c carries current to coil relay B 5760. Conduit 5830d carries current to coil relay B 5840. The power supply neutral is connected to TB 5850 through conductor 5860. Conductor 5870a connects TB 5850 neutral to timer A₂ and 5870b connects TB 5850 to terminal block T1. The timer breaks the neutral circuit and connects the neutral circuit to TB-B, through conductor 5880a, to terminal block T2 which provides the neutral to coil relay B through conductor 5880b and to coil relay B through conductor 5880c. Conductor 5890a connects neutral TB 5850 to timer terminal T3. The timer breaks and makes up the neutral to terminal T4 which is connected to TB A. TB A connects neutral to coil relay A 5750b through conductor 5890b. Conductor 5890b connects TB A to coil relay A 5750a.

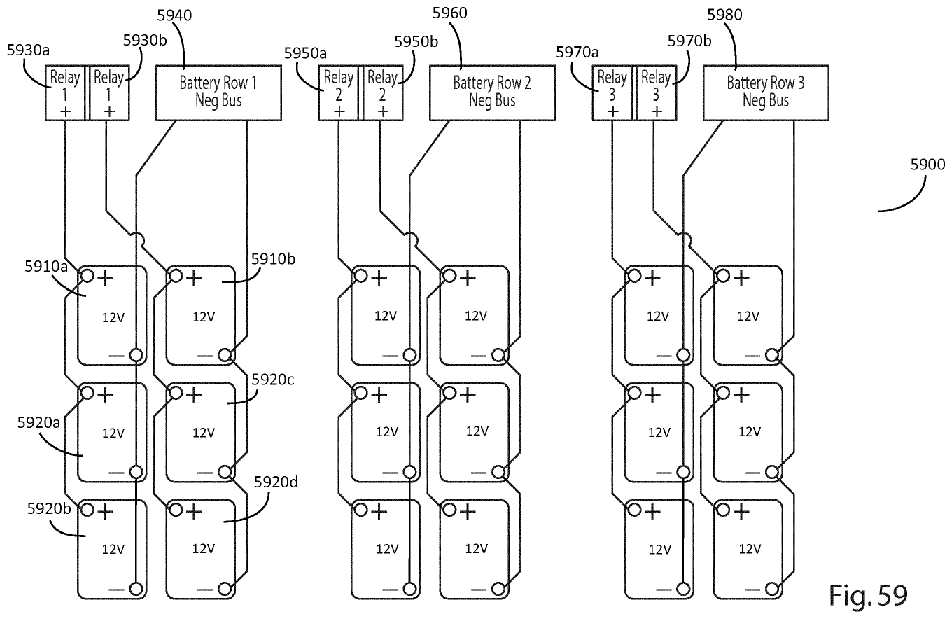

FIG. 59 is a diagram illustrating an exemplary generator self-charging system battery and capacitor layout 5900 consistent with embodiments of the present disclosure. In the exemplary embodiment each battery/capacitor unit comprises a potential difference of 12 Volts. The 12V system feeds a 36V battery bank not presently illustrated. This FIG. 59 comprises three banks of capacitor/batteries, each with a potential difference of 12V, which are connected in parallel. Capacitor 5910a, battery 5920a and battery 5920b are connected in parallel with capacitor 5910b; 5920c; 5920d. The two remaining battery sets (connected to relays 2 and 3 respectively) are, in the embodiment of FIG. 59, also 12V each and connected in parallel. Relay 5930a and 5930b connect to positive battery row 1 of the 36V volt battery bank. Neutral 5940 connects to neutral of battery row 1. Relays 5950a; 5950b connect to the positive of battery row 2. Neutral 5960 connects the negative bus of row 2 in the 36V battery bank. Relays 5970a; 5970b connects to battery row 3 of the 36V battery bank. Neutral 5980 connects to battery row 3 bus bar.

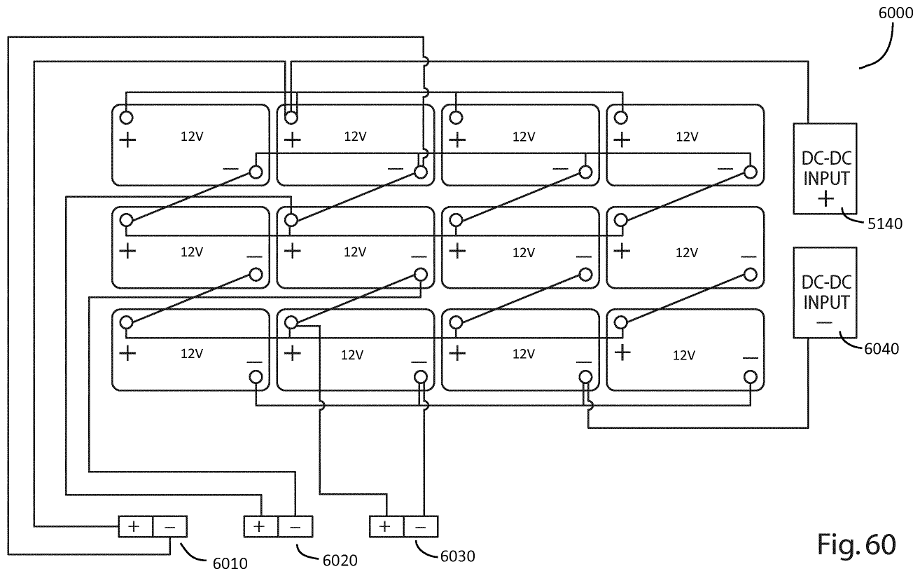

FIG. 60 is a diagram illustrating an exemplary 36V capacitor/battery bank 6000 consistent with embodiments of the present disclosure. Terminal blocks 6010; 6020; 6030 are connected to the self-charging input in FIGS. 57, 58 and 59. The series connections are 5140 and 6040. In the exemplary embodiment the series connections 5140; 6040 are DC-DC inputs. The parallel voltage may be 12V DC and the series voltage may be 36V DC. The series voltage connection to 5140 and 6040 may feed the DC-DC power supplies of the system FIG. 51 (5125a; 5125b).

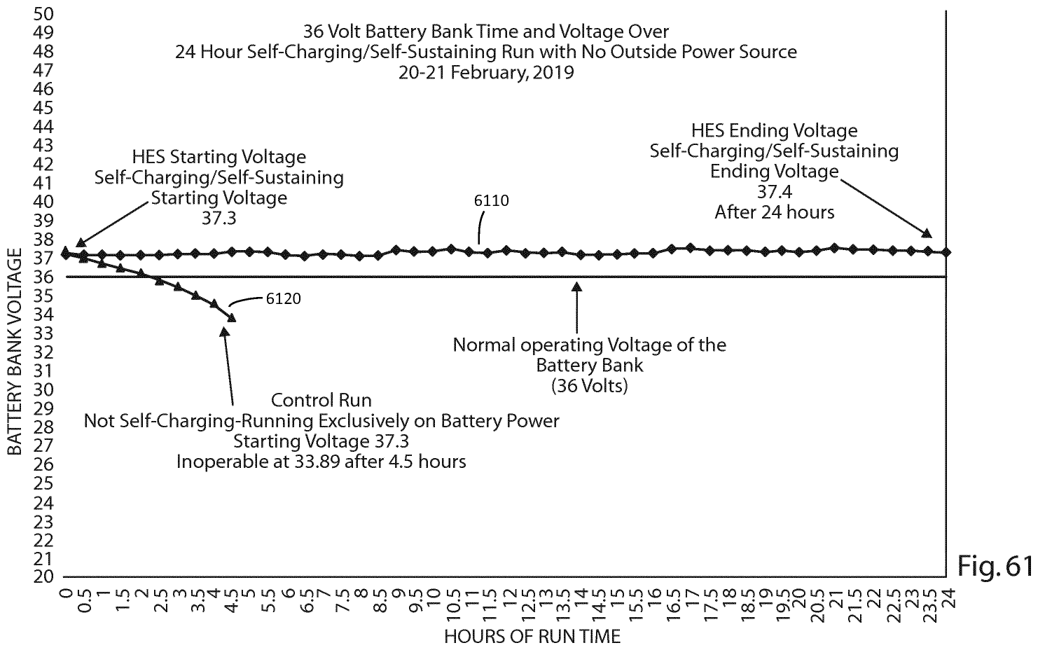

FIG. 61 is a diagram of data from 36V battery/capacitor bank 6000. The data presented is time plotted against voltage over a 24-hour self-charging/self-sustaining run of the generator 5000 with no outside power source, consistent with embodiments of the present disclosure. This data suggests that the battery/capacitor bank 6000 maintains a charge of 37.3 to 37.4 as noted in curve 6110 for 24 hours when the self-charging mode was operating. However when the self-charging loop was turned off, the voltage of the capacitor/battery bank 6000 dropped to 33.89 volts after 4.5 hours; curve 6120 illustrates operating under the same load on the generator 5000 and the entire system failed and shut down.

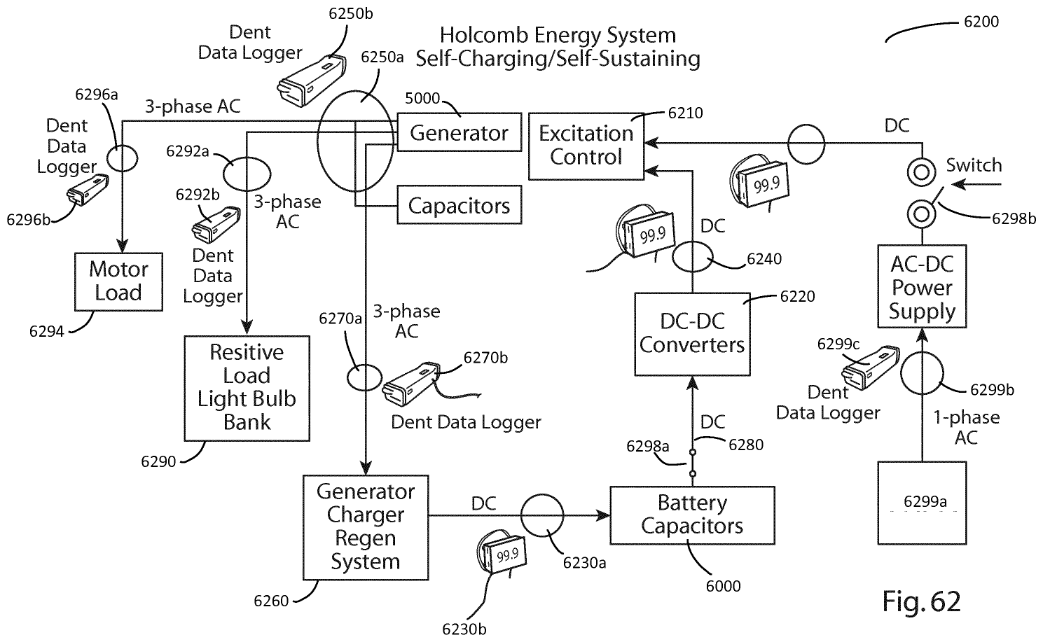

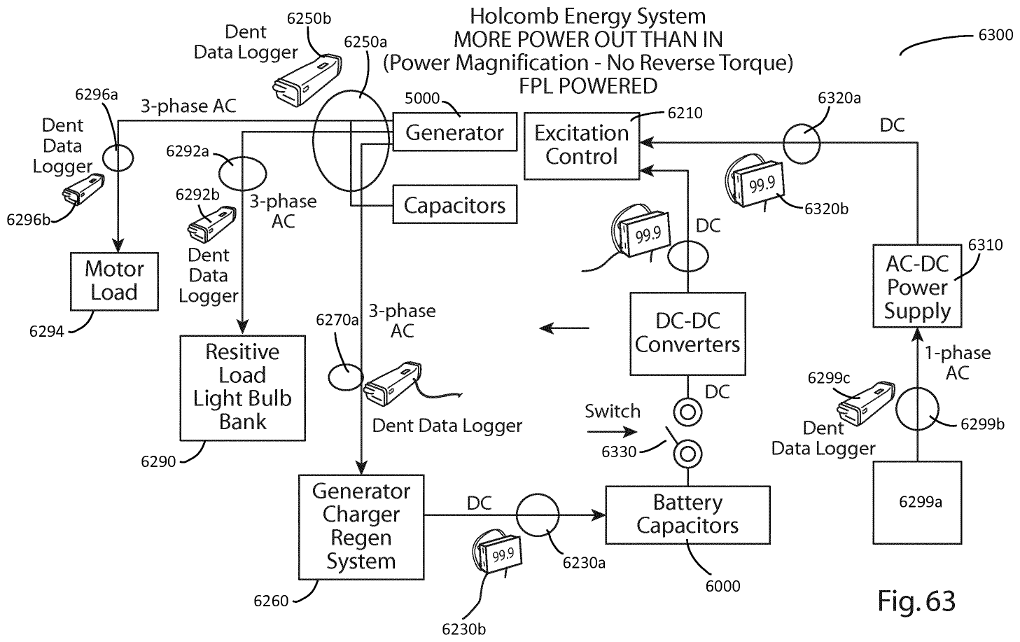

FIG. 62 is a block diagram 6200 of measurement points with volt meters, amp meters and Data Loggers for a self-charging, self-sustaining run, consistent with embodiments of the present disclosure. All data presented in this disclosure and referenced in the claims was taken as per this FIG. on the Holcomb Energy System (HES). It will be readily understood that the selection of measurement points as presented in FIG. 62 is in no way intended to be limiting in nature, but is provided by way of example as an exemplary embodiment. Other selections of measurement points are envisaged as being feasible. The generator excitation control 6210 sends DC current to the rotor coils in a pulsed and sequenced fashion to generate the AC 3-phase power. The DC-DC converters 6220 receive DC power from the battery/capacitor bank 6000. The input to the DC-DC converters 6220 is measured at 6230a with a DC volt and amperage meter 6230b. The voltage and amperage from the DC-DC converters 6220 to the excitation control 6210 is measured at 6240 with DC volt meters and amp meters. The total power output by the generator 5000 is measured at point 6250a by the Data Logger 6250b. The power to the generator charger regeneration system 6260 is measured at point 6270a by Data Logger 6270b. Power from the generator charger regeneration system 6260 to the battery/capacitors 6000 is measured at point 6230a by meter 6230b and possibly additionally a handheld DC amp meter. The power from the battery/capacitors 6000 into the DC-DC power supplies is measured at point 6280.
Power to resistive load (3-phase light bulb bank) 6290 is measured at point 6292a by Data Logger 6292b. Power to 3-phase motor load 6294 is measured at point 6296a by Data Logger 6296b.
For measuring power input to power output switch 6298a is opened and 6298b is closed. The generator 5000 may be powered in this structure by local utility power 6299a. This structure will be discussed in FIG. 63 below. The power input from utility supply 6299a may be measured at point 6299b with a DC meter 6229c.

FIG. 63 is a block diagram 6300 of measurement points with volt meters, amp meters and Data Loggers for the power magnification experiment, consistent with embodiments of the present disclosure. Local utility power 6299a may be connected to AC-DC power supply 6310. AC-DC power supply 6310 feeds the excitation control 6210 which may route current through the rotor coils of the generator 5000. The current from the utility 6299 is measured at point 6299b with Data Logger. The input current from AC-DC power supply 6310 may be measured at point 6320a with a DC meter 6320b and a handheld DC amp meter. The current and voltage output at point 6250a is measured by the Data Logger 6250b. The self-looping self-generation circuit for this experiment is switched off by opening switch 6330. The current from the utility supply 6299a may be passed through the rotor coils of the generator 5000. The current through the rotor coils forms relatively weak magnetic poles which align the magnetic domains of the metal to form powerful moving sequenced rotating magnetic poles which generates more power from the magnetic domains than is required to align the fields. Therefore the harvested energy from the moving magnetic fields as the domains are aligned allows more usable electric energy output than energy input for the system.

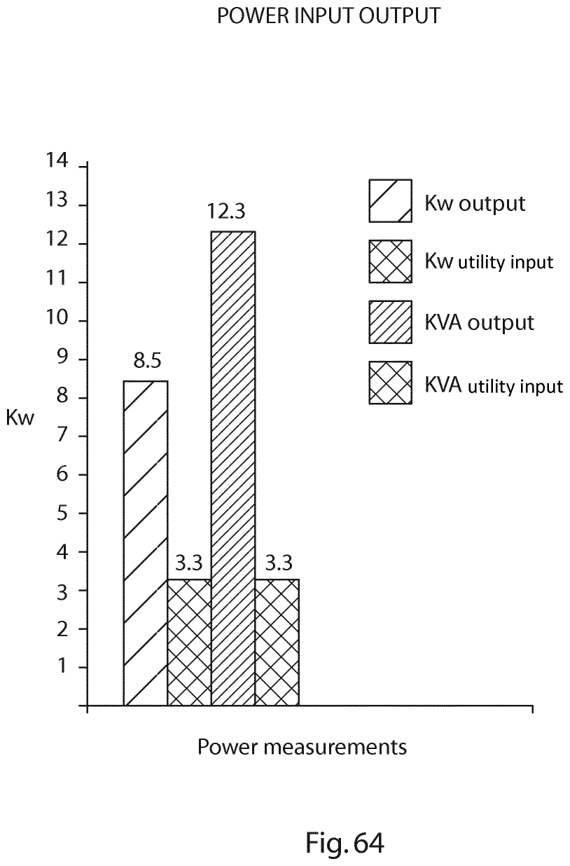

FIG. 64 is a graph of data taken from measurement points with volt meters as described in FIG. 63, consistent with embodiments of the present disclosure. The data in this FIG. reveals that the input power from point 6299b was 3.3 KVA and 3.3 KW PF 1.0 and output from the generator 5000 at point 6250a was 8.5 KW and 12.30 KVA PF 0.70. It is apparent that the magnification of energy harvested from the electron spin of unpaired electrons of the pole piece materials has occurred.

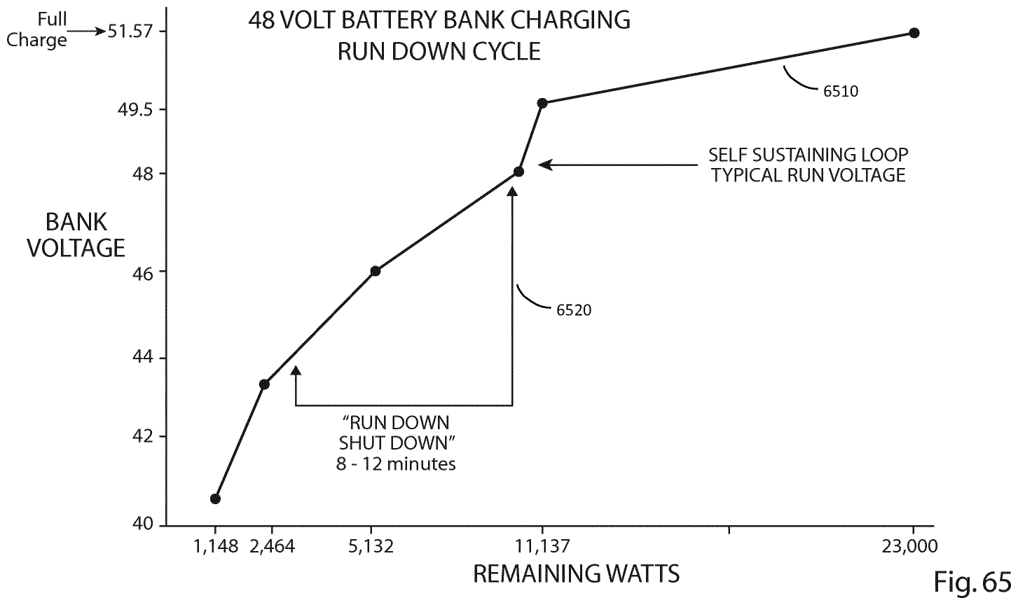

FIG. 65 is a diagram from a battery bank with voltage drop under load plotted against watts of remaining usable energy, consistent with embodiments of the present disclosure. In the exemplary embodiment, the battery bank is a 48V battery bank, however other potential differences are anticipated as being feasible in consideration of varying power requirements. This FIG. reveals the stability of the exemplary 48 volt battery/capacitor interface as long as the self-sustaining power loop is operating 6510. When the loop is disconnected 6520 the voltage drops to a system failure in 8 to 12 minutes.

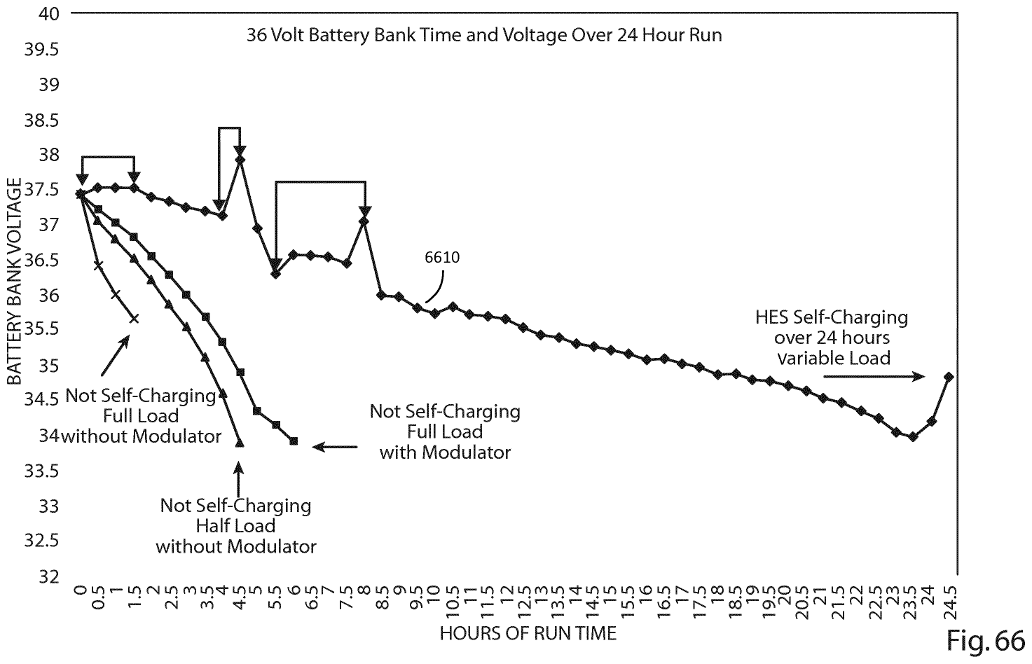

FIG. 66 is a diagram of voltage change with time from a battery/capacitor bank, in the example a 36V battery/capacitor bank 6000 such as that presented in FIG. 60. The run is over a 24-hour period, consistent with embodiments of the present disclosure. This run is to demonstrate the erratic charging pattern when the isolated battery charging system 5700 of FIG. 57 is not utilized. It is difficult to control the charging rate when the AC-DC chargers are charging directly off the stator connection to the AC-DC power supplies for the rotors. This FIG. also demonstrates very clearly the stabilizing effect of the oscillating modulator 4400. Curve 6610 reveals the rapidly deteriorating voltage when the unit is not charging, at full load without the modulator 4400. With the oscillating modulator 4400 in the circuit the efficiency is about 260% greater in that the equivalent voltage drop took 4 hours with the modulator 4400 in the circuit and 1.5 hours without the modulator 4400 in the circuit.

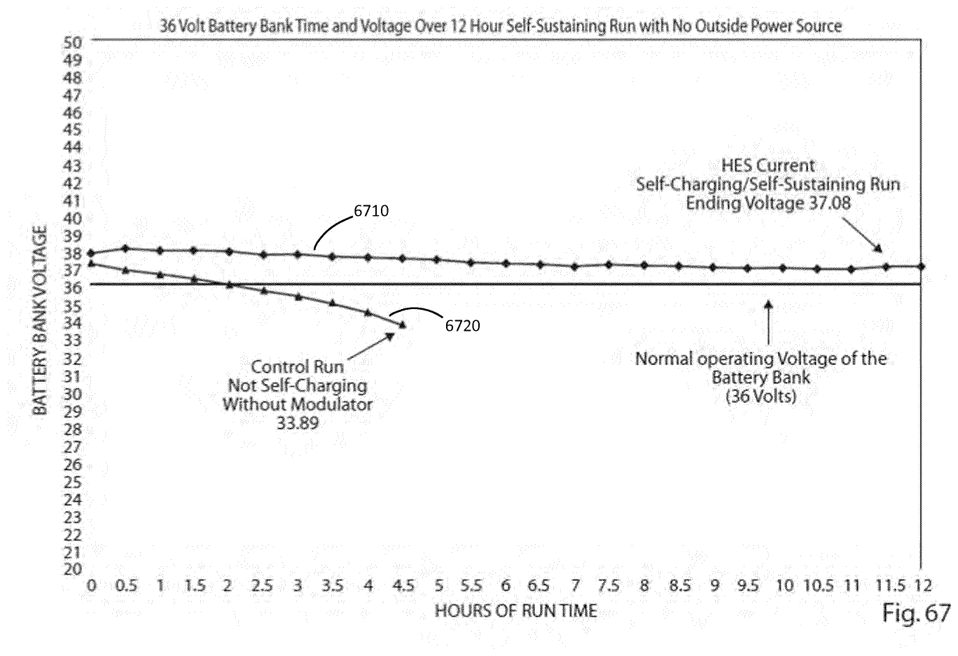

FIG. 67 is a diagram of data plotted from a 36V battery bank time versus voltage over a 12-hour self-sustaining run with no external power source, consistent with embodiments of the present disclosure. The unit was operated in a self-charging fashion for 12 hours 6710 with a 3 kW load and oscillating modulator 4400 out of the system. The unit was subsequently operated under the same conditions but with the self-charging unit turned off 6720.

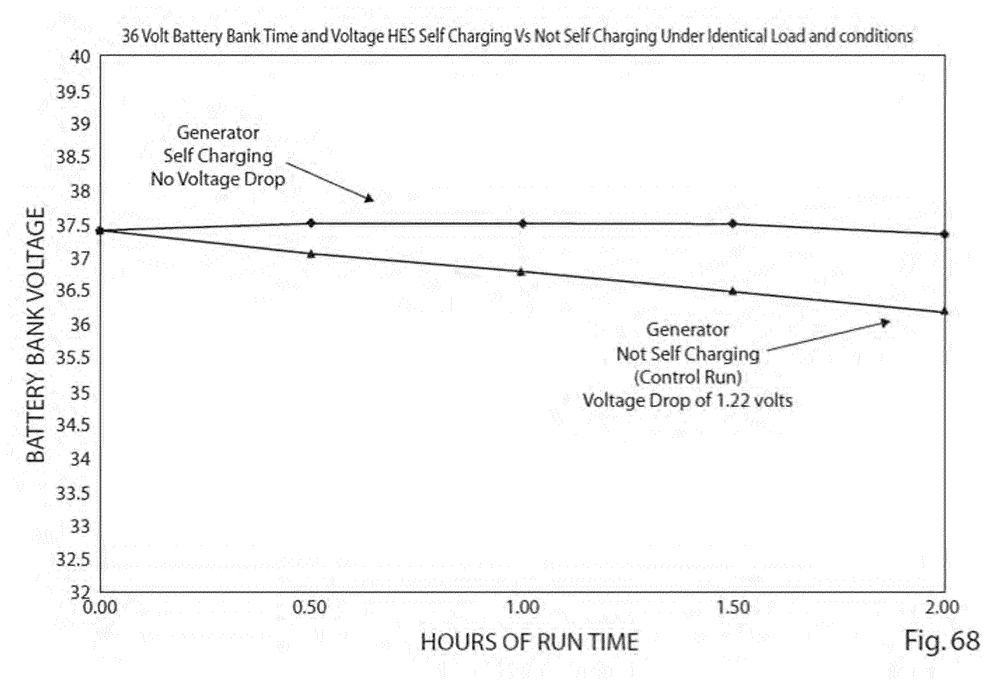

FIG. 68 is a diagram of plotted data from a 36V battery bank. The plot is of time versus battery bank voltage over a 2-hour period in which data was recorded from a self-charging self-sustaining operation versus non self-charging, consistent with embodiments of the present disclosure. The voltage during the self-sustaining run did not drop because the isolated charging system 5700 was operating and the oscillating modulator 4400 was in the circuit.

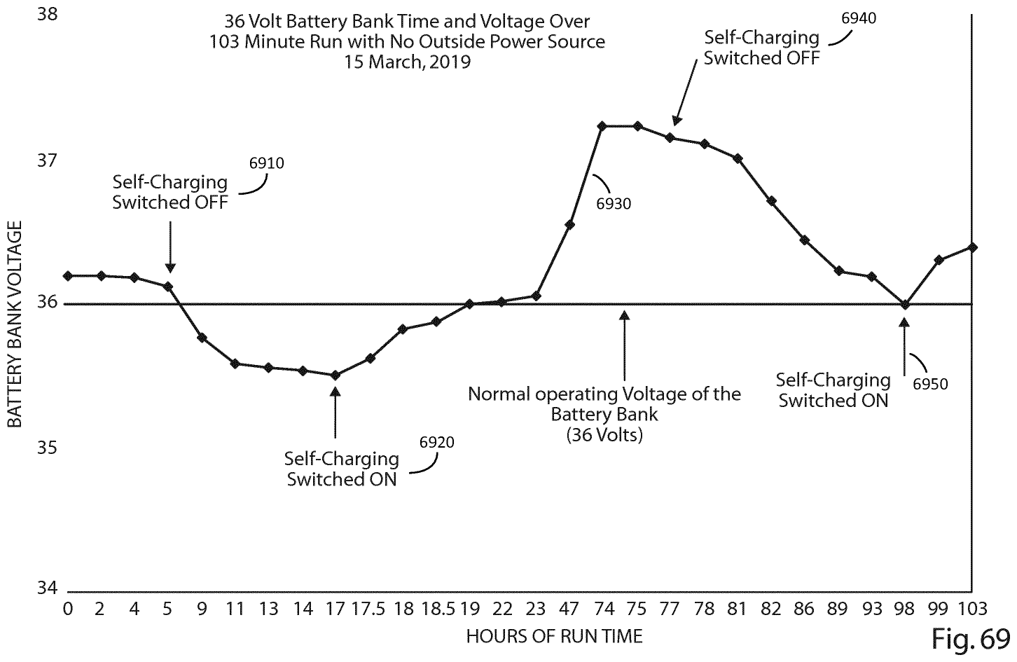

FIG. 69 is a diagram of data plotted from a 36V battery bank time versus voltage over a 103-minute run with no outside power source, demonstrating the self-charging circuit in on and off positions. The circuit is switched off and the battery voltage therefore deteriorates. Next, the self-charging circuit is switched back on and the battery voltage recovers to baseline and above. The cycle is repeated once more for a total of twice in this run. This FIG. clearly demonstrates the self-charging ability of the HES. The self-charging system is switched off 6910 and the voltage drops by approximately 0.5 volts. The charging system 5700 is turned back on 6920 and the voltage steadily increases by approximately 2 volts DC 6930. The self-charging system is again switched off 6940 and the voltage once again drops by approximately 1.2 volts. The charging system is turned on again 6950 and the voltage increases by 0.4 volts before the experiment is discontinued.

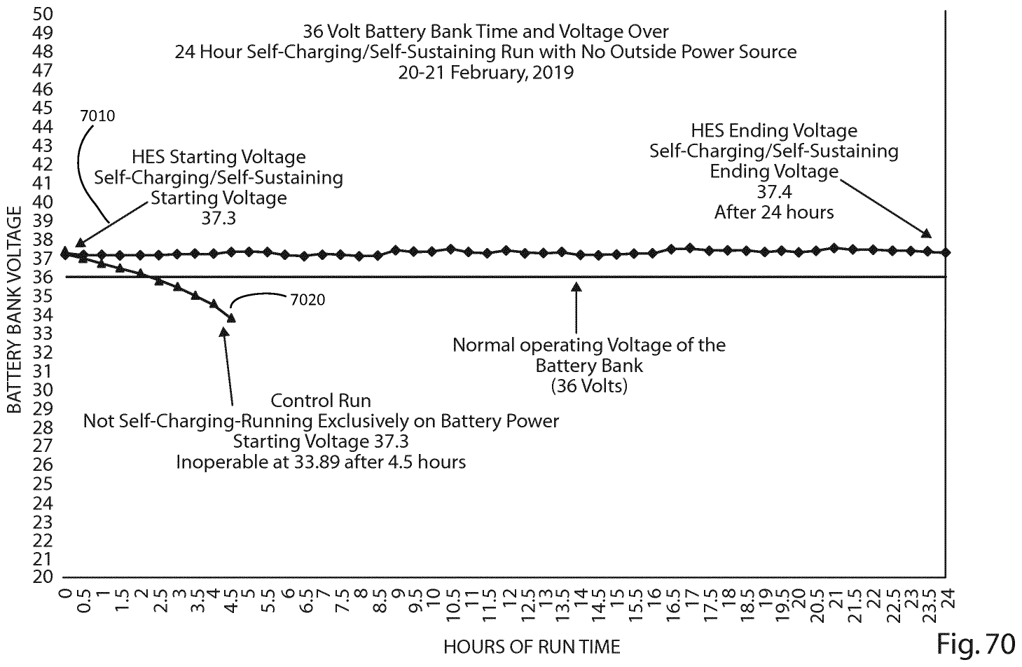

FIG. 70 is a diagram of plotted data from a 36V battery bank time versus voltage over a 24-hour self-charging, self-sustaining run with the isolated charging system 5700 and oscillating modulator 4400 in place. No external power source was used, consistent with embodiments of the present disclosure. The HES starting battery voltage 7010 was 37.3 volts DC. After 24 hours of continuous operation, the HES ending voltage of the 36 volt battery bank was 37.4 volts DC. When the self-charging system was turned off, within 4.5 hours 7020, the system failed as the voltage dropped to 33.89 volts DC.

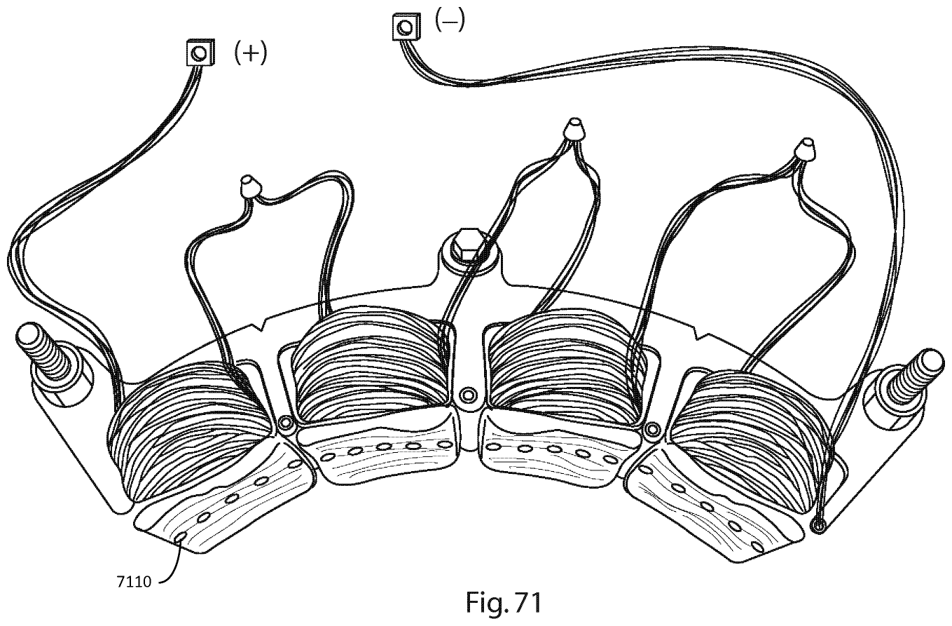

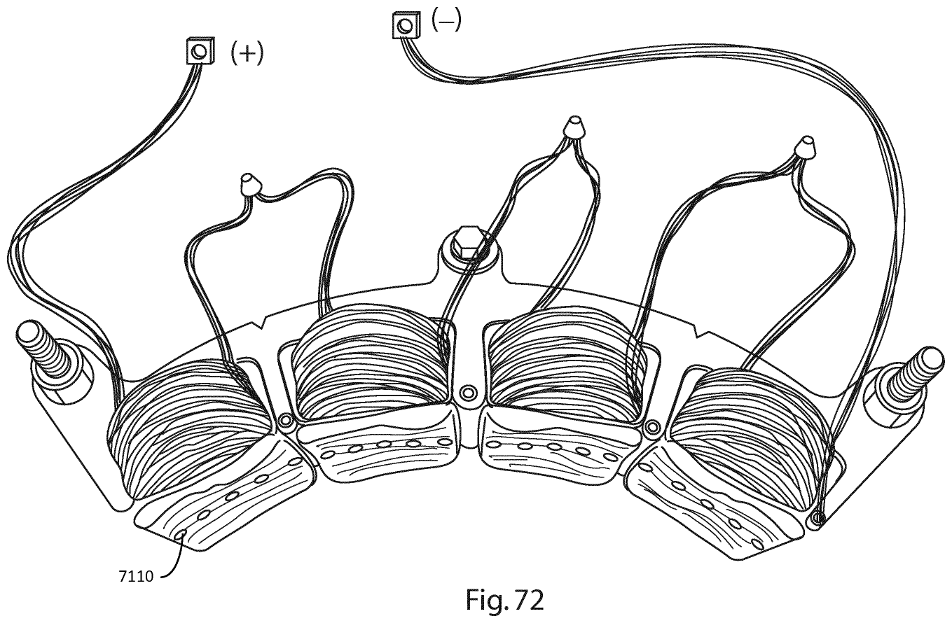

The following figures present data which clearly demonstrates that the energy source of this system evolves from the ability to harness the magnetic domains of the electrical steel. The magnetic domains are smaller groups of atoms which bond together into these areas called domains in which all the electrons in their spin patterns have the same magnetic orientation. The electrons can be considered as being tiny magnets. The spinning of the electrons results in small but extremely significant magnetic fields. In most materials, atoms are arranged such that the magnetic orientation of one electron cancels out the orientation of another. In ferromagnetic substances, their atomic makeup has unpaired electrons, therefore smaller groups of atoms with like-magnetic-orientation bond together into domains in which all the electrons have the same magnetic orientation (spin orientation). Initially, these domains are randomly aligned. However when these domains are exposed to relatively weak magnetic fields they all align in the same direction. There are only four known elements in the world that are ferromagnetic at room temperature. These elements are iron, nickel, cobalt and (in some experiments) gadolinium. The experimental model presented herein clearly reveals that the embodiments of the present disclosure generate greater than 4 times more power that required to excite the magnetic poles. Two experimental coil groups were constructed which were identical except that the laminates of one of the first unit were made of electrical steel (FIG. 72) and the second unit laminates were made of Plexiglas (FIG. 71). Therefore FIGS. 71 and 72 were not ferromagnetic. The electrical steel unit has magnetic domains in the metal and the Plexiglas does not contain magnetic domains.

Two sets of experiments were performed. Both coil groups were North pole wound and connected to each other in series with a 24 volt power supply (FIGS. 71, 72, 73, 74, 75 and 76).

Experiment: Electrical Steel Vs. Plexiglas Magnetic Properties

Note: Readings of both substances were recorded under these identical conditions:
Voltage: 20 VDC
Current: 12.5 A
Resistance: 1.6 Ohms (Ω)
Input Power: 250 W

Plexiglas (North Pole)
1. 46 gauss
2. 39.67 gauss
3. 28.32 gauss
4. 39.78 gauss
Average: 38.44 gauss

Electrical Steel (North Pole)
1. 240 gauss
2. 87.8 gauss
3. 92.0 gauss
4. 246.6 gauss
Average: 166.6 gauss

If one divides the average gauss readings of the Plexiglas (38.44 gauss) into the average gauss readings of the electrical steel (166.6 gauss) one can conclude that the electrical steel produces 4.33 times greater magnetic field strength (gauss) than is required to align the magnetic domains of the steel.

166.6÷38.44=4.33

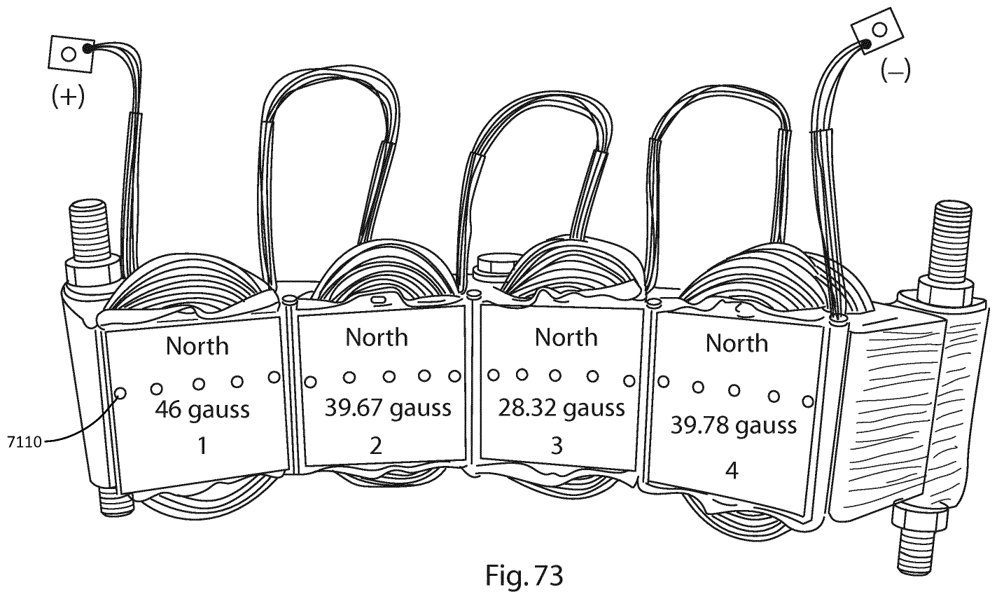

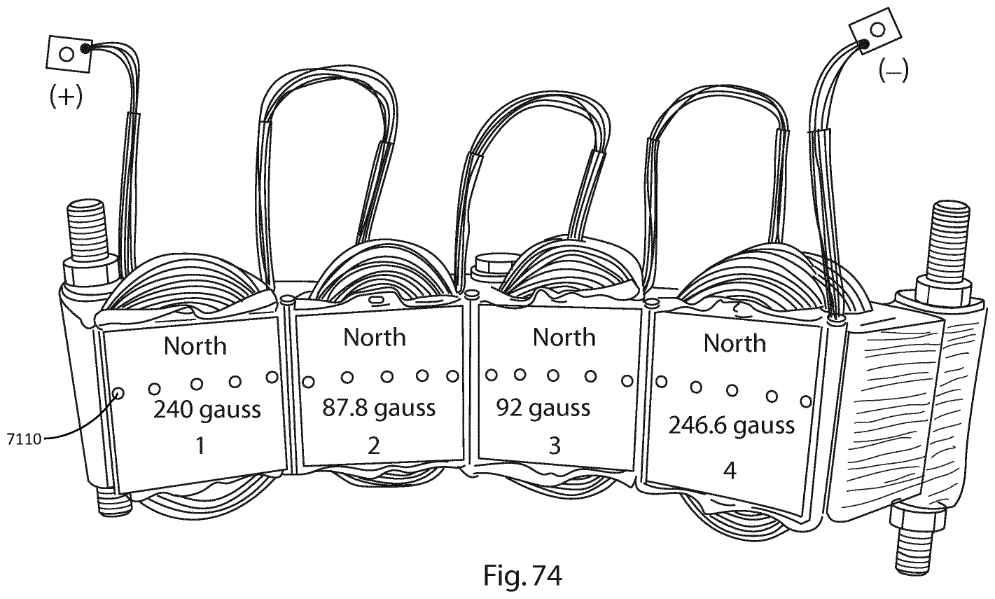

In this experiment, the electrical steel unit FIG. 74 and the Plexiglas unit FIG. 73 were identical except for the materials from which they were constructed. All poles in both units were wound identically with #18 AWG copper insulated magnet wire. They were wound with 5 wires in hand and 65 turns. Both the electrical steel unit and the Plexiglas units were connected in series with each other. They were also in series with two resistive coils, each having a resistance of 0.6 ohms. The resistance of the coils in both the electrical steel and the Plexiglas were 0.2 ohms. Therefore the resistance of the entire circuit was 1.6 ohms. The voltage applied across the terminals by the 24 volt power supply was 20.0 volts DC, the amperage going through both the Plexiglas coils and electrical steel coils simultaneously was 12.5 amps. The only difference between the two coil units is the material used to cut the laminates of the super structure. Gauss readings were taken at all of the 7110 spots on the coil face of FIGS. 73 and 74. The five gauss readings were then averaged. The four pole averages were then averaged. When the Plexiglas gauss readings were compared to the electrical steel readings, the electrical steel readings were 4.33 times higher than the Plexiglas readings. The same identical current was flowing through both units but the magnetic flux in the electrical steel was four times greater because the magnetic domains in the electrical steel are aligned by the relatively weak fields from the coil. This is the same mechanism which powers the electrical unit of the present disclosure. As the domains are aligned the evolving moving field generates an electrical energy output greater than 4 times the electrical energy input. If the generator 5000 of the present disclosure has multiple rotors and stators in a laminated fashion, the output to input ratio may be even greater.

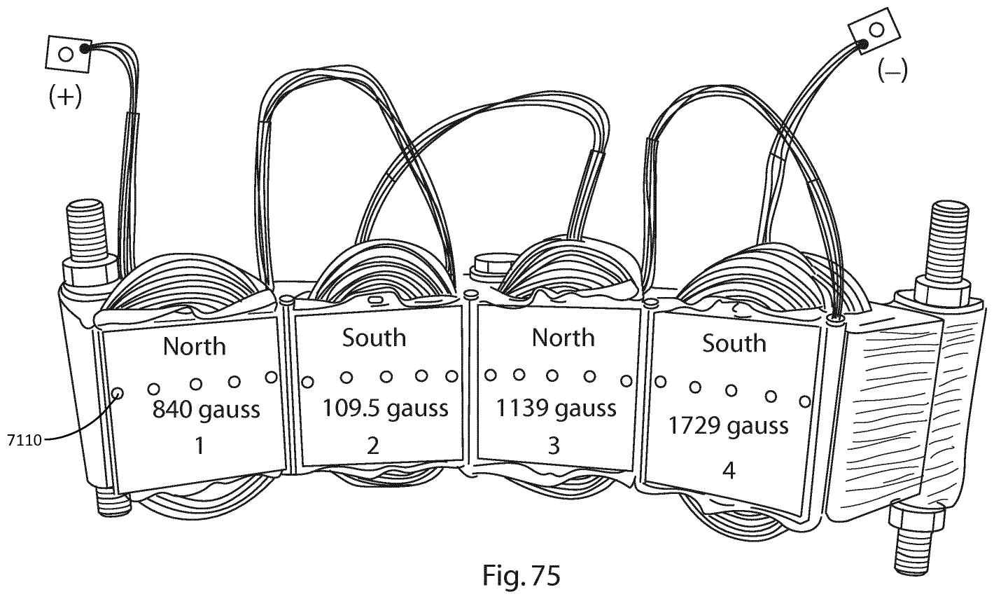

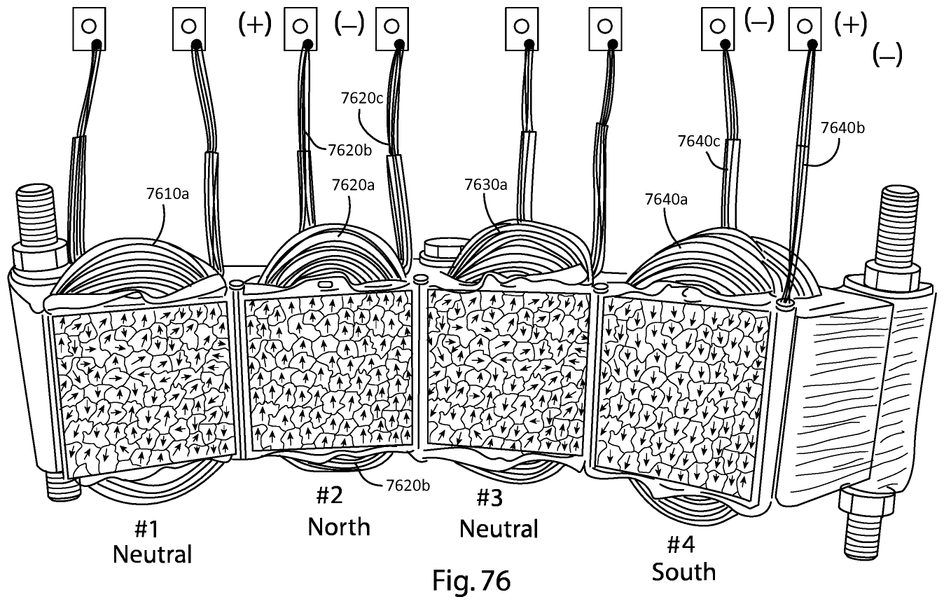

When all of the magnetic domains in the metal are aligned, the metal is said to be saturated. Due to this saturation phenomenon, the hysteresis is somewhat “S” shaped, whereas the Plexiglas curve is a straight line. As can be noted from a comparison of FIGS. 74 and 75 which illustrate Plexiglas and electrical steel units respectively, and also FIG. 50A, much more magnetic flux (greater than 4 times) is generated in the electrical steel than in the Plexiglas when both have the same number of turns of copper magnet wire and see the same amperage in the same circuit at the same time. This greater than 4-fold increase in magnetic energy output is translated into over 4 times more electrical energy output than energy input to operate it as presented in the present disclosure. As the magnetic domains are aligned by the electromagnetic coil, they “recruit” and align additional domains. As the domains align, the evolving moving flux field generates power in the stator coils of the 3-phase stator. As will be noted in FIG. 76 #1-7610a has no current going through the coils, therefore the magnetic domains 7610b are oriented in random fashion. Arrows in FIG. 76 indicate different spin alignments of magnetic domains, said domains being indicated by random partitioning. As will be noted coil #2-7620a has current passing through lead 7620b through the coil and out through the neutral 7620c. This counter clockwise current flow produces a North pole electromagnetic flux which aligns the magnetic domains producing an evolving moving flux which is greater than four times as much energy as the energy required to align the magnetic domains. The current is turned off in coil #3-7630a and the domains are once again random. In coil #4-7640a the current from lead 7640b is run through the coil in a clockwise fashion and out through lead 7640c. This current flow in the clockwise fashion generates a South pole field which aligns the magnetic domains in a South pole orientation. For demonstration purposes, the arrows point up for North and down for South. In reality the arrows should point into and out of the surface of the paper.

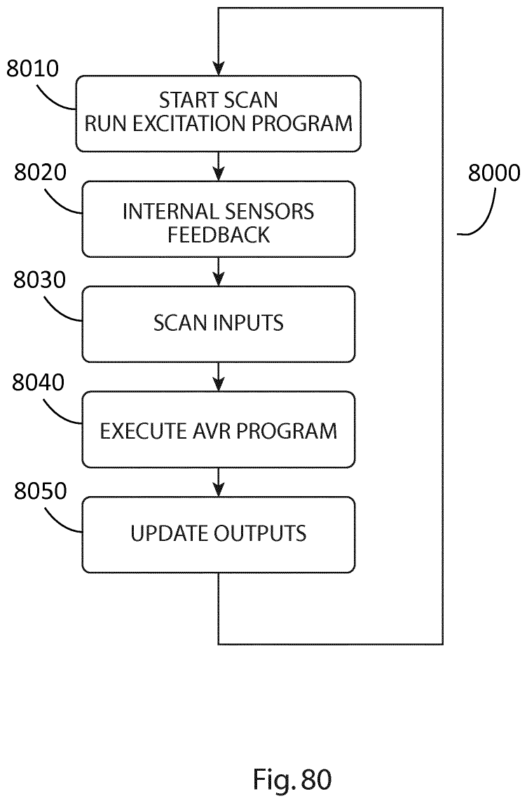

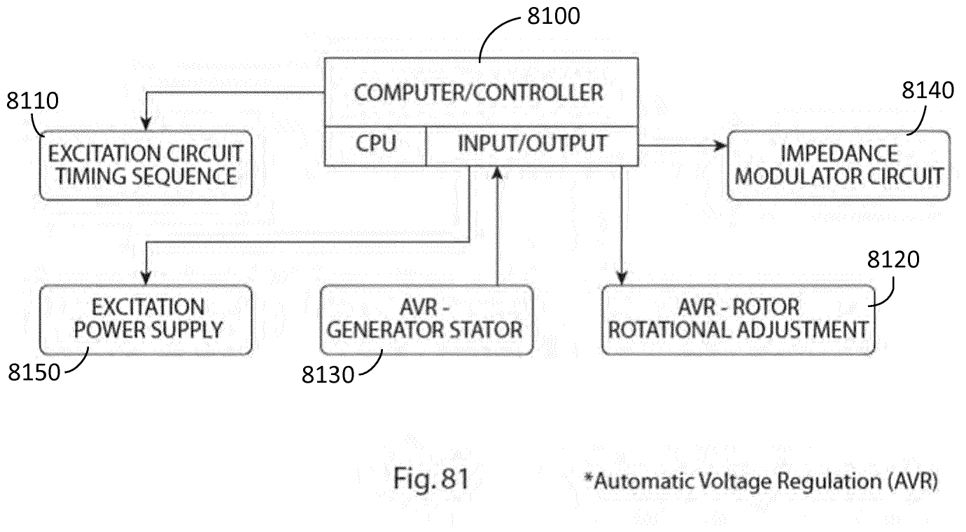

The 3-phase voltage is balanced and maximized by the computer controller 8100 FIG. 81 which contains the central processing unit (CPU) and the in and out (I/O) module which connects the CPU to the sensors and actuators of the system. The response time from the sensor input to actuator output for this system is approximately 1 microsecond. The desirable response time capability for the I/O system is 1 microsecond. The digital inputs and outputs are input signals from sensors and outputs to actuators such as relays. The CPU operating cycle is revealed in FIG. 80. Signals are received from amp transformer sensors as well as AC and DC voltage meter signals. The purpose of this control system is to automate the voltage regulation in the 3 phase legs of the stator output. The system keeps voltage at optimum levels and keeps the phase legs balanced one to another. There is a logic ladder or sequence. The first circuit to be optimized is the excitation circuit timing sequence 8110. This setting is changed by the touch pad on the HMI. Next adjustment is rotational adjustment 8120 by rotating each rotor in reference to the stators. The rotation i.e. tuning of the rotor and stator is accomplished by rotating the rotors with respect to the stators until the voltage is maximized and balanced in the phase legs with reference one phase leg to the other. The balance should be within +/−5 AC volts.

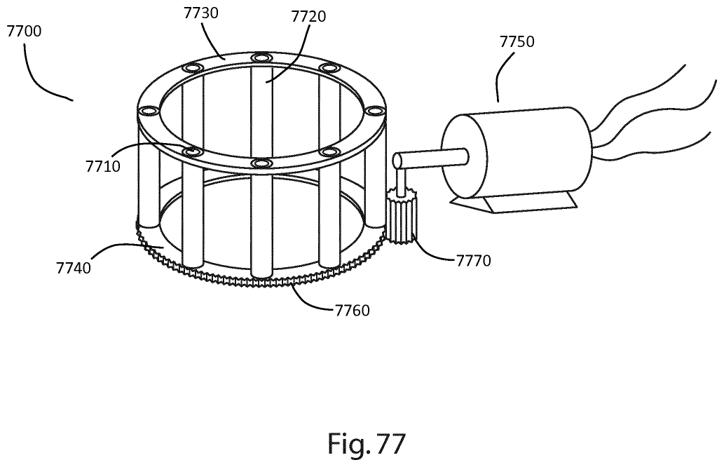

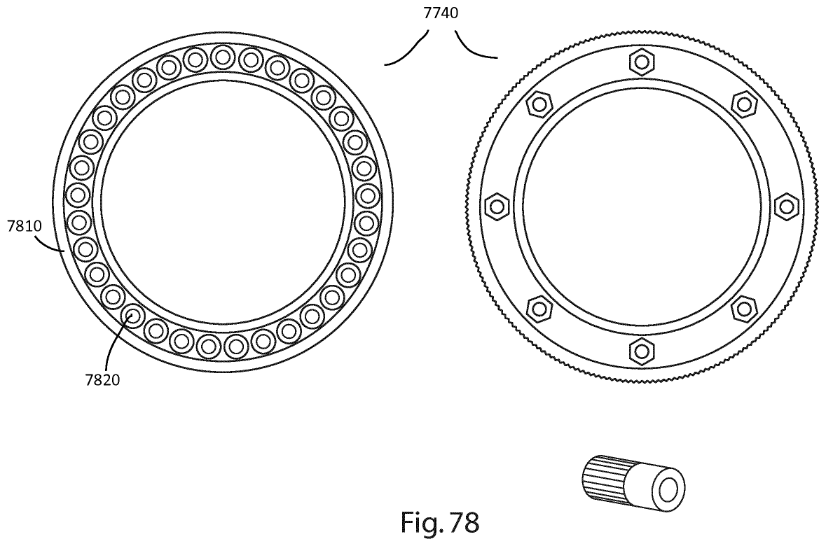

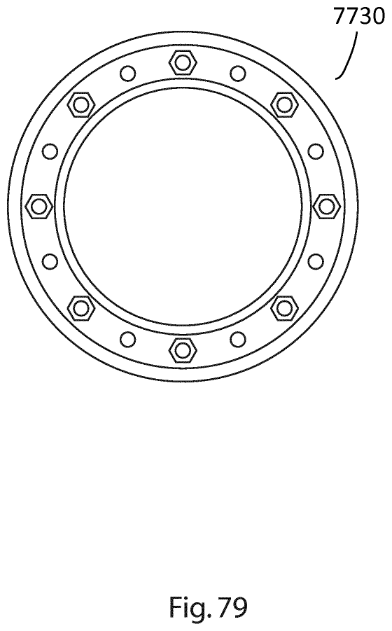

Structure 7700 in FIG. 77 is bolted to the bottom of each rotor structure through bolt holes 7710. Support post 7720 is bolted to ring 7730 and 7740. A motor 7750 such as a servo motor is also visible. In the exemplary embodiment, a cog 7760 which may be configured for interacting with a complimentary gear 7770 (which the motor 7750 may actuate the rotation of) is positioned on the ring 7740, best presented in FIG. 78, is also visible. In FIG. 78 bearing race 7810, with ceramic ball bearings 7820 accepts rings 7740 which contain cog 7760. The servo 7750 rotates the rotors through the interaction of a complimentary gear 7770 with the cog 7740. The servo motor 7750 rotates the rotors clockwise and counterclockwise with a signal from the CPU-I/O controller of the current disclosure. The rotational adjustment occurs until the voltage level and balance fall within predefined/programmed parameters. It will be understood that the number of ball bearings 7820 disposed around the ring 7740 in FIG. 78 is presented by way of example only, and other numbers of ball bearings 7820 are anticipated as being feasible. The dimensions of the rings 7730; 7740, the holes 7710 and the support posts 7720 may be selected based on the desired power output of the generator 5000 and are not isolated to a single embodiment/set of values. Moreover, the number of teeth of the gears, as well as their diameters, may be chosen in consideration of desired power output or a desired angular velocity of the gears. FIG. 79 is an isolated cross-sectional view of the ring 7730 of FIG. 77.

FIG. 80 is a diagram of the exemplary scan cycle of the computer/controller operating cycle of one of the embodiments of the present invention. The automatic voltage regulation (AVR) system is coordinated and controlled by the CPU-I/O cards and the associated voltage, amperage and frequency sensors. The logic sequence is programmed into each sequence scan 8000. The scan comprises: running the excitation program 8010; internal sensors feedback 8020; scan inputs 8030; execute AVR program 8040; and update outputs 8050. At startup, the logic ladder sequence priority 8100 as in FIG. 81 is (1) excitation circuit—timing sequence 8110; (2) AVR—rotor rotational adjustment 8120; (3) AVR—generator stator capacitance 8130; (4) modulator capacitance/rotor impedance 8140; (5) excitation power supply voltage 8150. In the operating mode after initial startup the logic sequence priority goes in reverse. (5) excitation power supply voltage 8150; (4) modulator capacitance/rotor impedance 8140; (3) AVR—generator stator capacitance 8130; (2) AVR—rotor rotational adjustment 8120; (1) excitation circuit—timing sequence 8110.

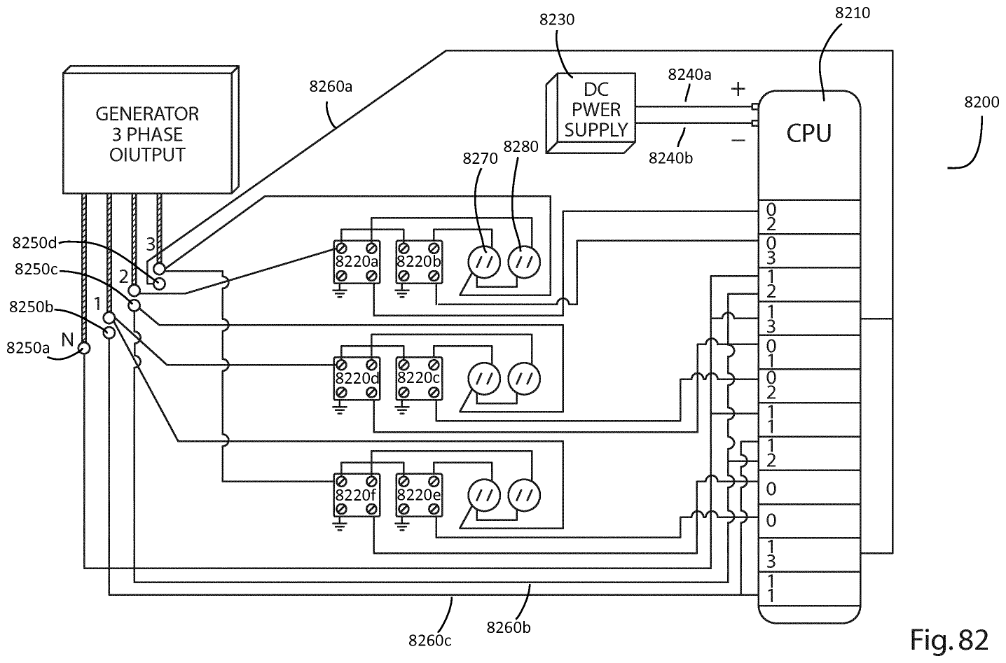

FIG. 82 is a diagram illustrating a relay control system 8200 which may balance the capacitance across the legs of a 3-phase generator in a “low wye,” “high wye,” and “delta” connection, but not limited to “high wye,” “low wye” and “delta” connections. The CPU and I/O 8210 processing cards sense the 3-phase voltage L-L and L-N through voltage sensors and amperage transformers. These signals arrive into the I (input cards). The signals are then sent to the CPU where they are processed according to the program which has been entered into the CPU and the appropriate actuator signal is sent out by the output card to one or more of the relays 8220a; 8220b; 8220c; 8220d; 8220e; 8220f.

The power for the CPU and I/O 8210 modules is supplied by DC power supply 8230 and is carried through positive conductor 8240a and negative conductor 8240b. Voltage sensors 8250a; 8250b; 8250c; 8250d send signals to the appropriate input module through conductors 8260a; 8260b; 8260c. The signal is sent to the CPU which may scan once per microsecond. Inputs are then scanned 8030 and when the voltage changes, the AVR program executed 8040 compares the input to the desired range. If it is out of range, the appropriate outputs are updated 8050 to an appropriate output actuator card which sends signals to relays for example, 8220a and 8220b to open relay to L-2 and L-3 which opens conduction of capacitors 8270 and 8280 across 3 phase leads L-2 and L-3. The same process may occur for each lead including L1-N, L2-N, L3-N, L1-2, L1-L2, L2-L3 and L1-L3.

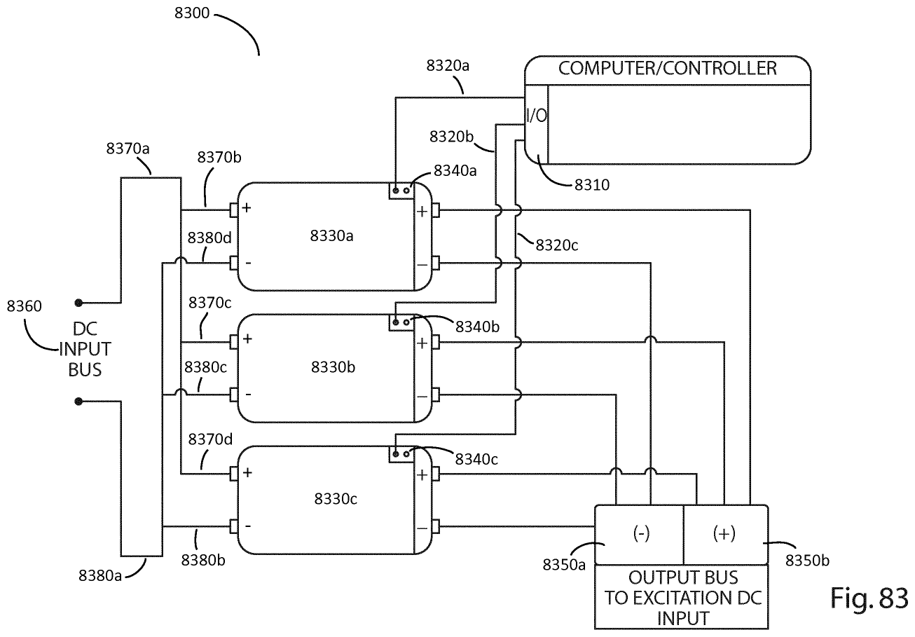

FIG. 83 is a diagram illustrating the excitation power supply control circuit 8300. When phase output voltage of the relay control system 8200 drops, the actuator cards 8310 sends DC signals through conductors 8320a; 8320b; 8320c to DC-DC power supplies 8330a; 8330b; 8330c. If there is an AC voltage drop, one or more of control circuits 8340a; 8340b; 8340c increase the DC input voltage to the output bus 8350a (−) and 8350b (+). This makes up the output bus to the excitation relays such as the excitation relays of FIG. 52. The power to input bus 8360 is supplied by batteries/capacitors along with the charging interface of FIGS. 57 and 58. Conductor 8370a supplies DC-DC power supply (+) 8330a through lead 8370b, power supply 8330b through lead 8370c and 8330c through lead 8370d. The negative supply 8380a supplies power supply 8330c through conductor 8380b, power supply 8330b through conductor 8380c and power supply 8330a through conductor 8380d.

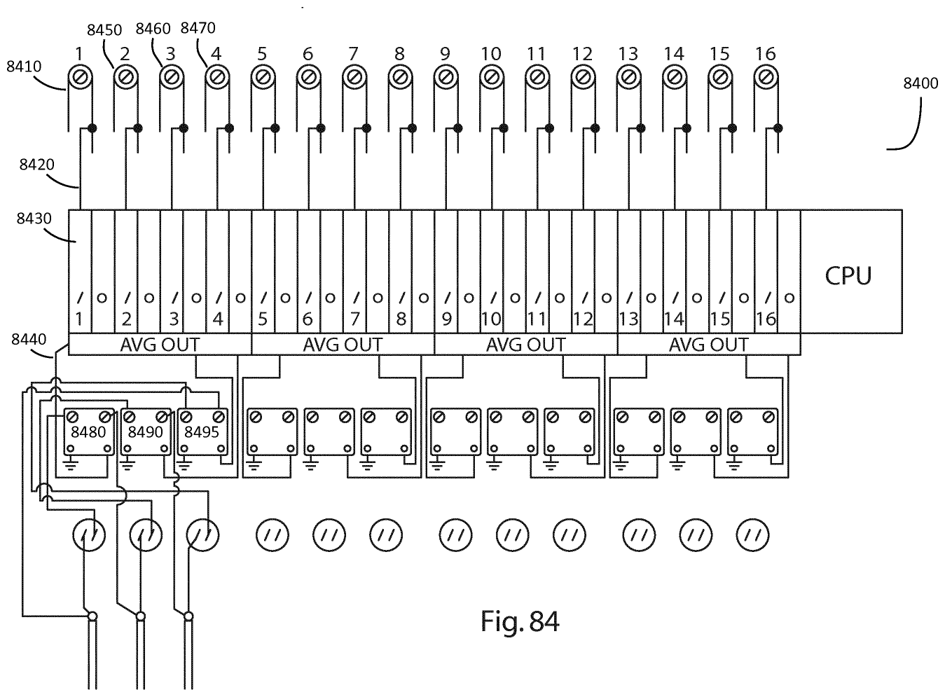

FIG. 84 is a diagram illustrating the rotor impedance modulator control circuit 8400. The purpose and function of this system is to stabilize the stator output voltage by reducing and stabilizing the rotor impedance. One or more of the capacitors across the phase legs of the modulator core absorb energy from the rotating motor 3-phase motor field. On the first half of the cycle (180°) power is absorbed and the power is kicked back into the system on the second half of the cycle (the second 180°). This FIG. 84 is a diagrammatic depiction of the rotor coils 1-16 with amperage loops or transformers in place to detect current flow which is a reflection of the impedance of the rotor coils. Only the first quadrant of the rotor is detailed here but in the exemplary embodiment the circuitry 8400 may be applicable to all four quadrants. Each quadrant may contain four poles. The rotor coil #1-8410 is monitored by current transformer 8420 which is connected to input card 8430. According to embodiments of the scan method of FIG. 80, the CPU 8210 scans the inputs 8030 once every microsecond and, as the input changes, the output 8050 sends an average output signal via 8440. The signal is the average from the processed signals originating from rotor coils 1-8410, 2-8450, 3-8460, and 4-8470. The output signal opens the proper relays 8480; 8490; 8495 to connect the proper capacitance across the phase legs of the modulator core. This system is operated in a fashion compatible with the automatic voltage regulation (AVR) program to maximize the output of the system.

The system may be turned on and off from a touchpad on the human machine interface (HMI). The output signal goes to a series of relays which in turn opens these relays from the power supplies for the pole modules. The system may be turned off and on by the same switch.

The HES of the present disclosure was independently tested and verified by a third party from DNV GL from August 13-14, 2019.

It will be understood that while exemplary features of an apparatus for aligning magnetic domains and generating power have been described that such an arrangement is not to be construed as limiting the invention to such features. The method for generating power may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method for aligning magnetic domains and generating power and the like. The processor(s) is a hardware device for executing software, particularly software stored in memory. Processor(s) can be any custom made or commercially available processor, a primary processing unit (CPU), an auxiliary processor among several processors associated with a computer, a semiconductor based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this disclosure, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

The above detailed description of embodiments of the disclosure is not intended to be exhaustive nor to limit the disclosure to the exact form disclosed. While specific examples for the disclosure are described above for illustrative purposes, those skilled in the relevant art will recognize various modifications are possible within the scope of the disclosure. For example, while processes and blocks have been demonstrated in a particular order, different implementations may perform routines or employ systems having blocks, in an alternate order, and some processes or blocks may be deleted, supplemented, added, moved, separated, combined, and/or modified to provide different combinations or sub-combinations. Each of these processes or blocks may be implemented in a variety of alternate ways. Also, while processes or blocks are at times shown as being performed in sequence, these processes or blocks may instead be performed or implemented in parallel or may be performed at different times. The results of processes or blocks may be also held in a non-persistent store as a method of increasing throughput and reducing processing requirements.

What is claimed is:

1. A solid-state electromagnetic rotor, comprising:
a plurality of salient pole pieces arranged around a supporting structure wherein a first end of each salient pole piece is attached to the support structure and a second end of each salient pole piece points outward away from the supporting structure, wherein the pole pieces include ferromagnetic and/or paramagnetic materials;
a plurality of wires wound around each salient pole piece; and
an excitation circuit configured to provide a current to the wires according to a predefined sequence to align magnetic domains of the salient pole pieces to produce a magnetic flux field, such that the current provided to the wires according to the predefined sequence provides a moving polar magnetic field in the form of distinct magnetic poles as desired to accomplish power generation, wherein the field strength of the moving polar magnetic field is proportional to the density of the magnetic domains of the salient pole piece material.

2. The solid-state electromagnetic rotor of claim 1, wherein the plurality of salient pole pieces are divided into N-groups, and the salient pole pieces within each group are configured to be sequentially excited each for a predetermined amount of time and/or with a predefined delay between excitations of salient pole pieces in each group to achieve a target frequency of an excitation cycle.

3. The solid-state electromagnetic rotor of claim 1 or claim 2, wherein the wires wound around each salient pole piece include an inner wire proximal to the supporting structure and an outer wire distal to the supporting structure, wherein the inner wire and the outer wire are excited so that the salient pole piece forms a dipole magnet.

4. The solid-state electromagnetic rotor of any previous claim, wherein the excitation circuit comprises an electronic gating system.

5. A power generator comprising the solid-state electromagnetic rotor of any preceding claim, and further comprising:
an electric power generator stator having a stator housing; and
wherein the solid-state electromagnetic rotor is disposed in, or around, and attached to the stator housing, such that the magnetic flux field generated by the solid-state electromagnetic rotor excites the stator coils and produces electric power.

6. The power generator of claim 5, wherein the stator further comprises a cavity or radial surface, and further comprising stator wires configured to direct power to an output port.

7. The power generator of claim 6, wherein the cavity of the stator is configured to receive the solid-state electromagnetic rotor.

8. The power generator of claim 7, further comprising a processor configured to execute one or more of:
determining an excitation cycle based on a desired target frequency of the power generator; and
switching the excitation circuit connected to the wires wound around the salient pole pieces to excite the wires to align the magnetic domains of the plurality of salient pole pieces according to a predefined sequence such that the magnetic domains of a salient pole piece in an N^{th} group of the N-groups of salient pole pieces are aligned in a first polarity in a first half of the excitation cycle and aligned in a second polarity in a second half of the excitation cycle.

9. The power generator of claim 8, wherein the processor is further configured to receive a signal from a solid-state frequency generator and determine the target frequency of the power generator based on the signal.

10. The power generator of claim 8 or claim 9, wherein the processor is configured to sequentially switch on and off a plurality of switching elements of the excitation circuit within the excitation cycle.

11. The power generator of any one of claims 5-10, wherein a portion of the output power from the power generator is fed back into the excitation circuit.

12. The power generator of any one of claims 5-11, wherein a portion of the output power is routed to an energy storage device.

13. The power generator of claim 12, wherein the energy storage device comprises one or a combination of a battery and a capacitor.

14. The power generator of any one of claims 5-13, further comprising:
a plurality of the electric power generator stator, wherein each electric power generator stator of the plurality of the electric power generator stators comprises a stator housing; and
a plurality of the solid-state electromagnetic rotor each placed into and/or attached to each of the stator housings, concentrically in an alternating manner either rotor-stator-rotor-stator or stator-rotor-stator-rotor.

15. The power generator of any one of claims 5-14, wherein the stator housing comprises a motor stator housing.

16. The power generator of claim 14 or claim 15, wherein the motor stator housing comprises a four-pole electric motor stator housing.

17. The power generator of claim 16, wherein the four-pole electric motor stator housing comprises a rotor insert, wherein the rotor insert is wound with conductors in the winding pattern of a four-pole generator.

18. The power generator of claim 16, wherein the four-pole electric motor stator housing comprises a motor stator winding with a four-pole motor winding pattern.

19. The power generator of claim 18, wherein the motor stator winding is connected in the pattern of a four-pole electric motor.

20. The power generator of claim 16 or claim 17, wherein the four-pole electric motor is configured to generate a four-pole rotating magnetic field at a predefined frequency.

21. The power generator of claim 20, wherein the predefined frequency is 1800 rpm for 60 Hz power from the power generator and 1500 rpm for 50 Hz power from the power generator.

22. The power generator of claim 21, wherein the four-pole rotating magnetic field generates 3-phase voltage in the rotor insert.

23. The power generator of any one of claims 17-22, further comprising an oscillating modulator for stabilizing voltage and power output of the power generator, said oscillator modulator comprising:
the four-pole electric motor stator housing containing the rotor insert, wherein the rotor insert is wound with conductors in the winding pattern of a four-pole generator, connected in either a “high-wye” hook-up, a “low-wye” hook-up or a delta hook-up.

24. The power generator of claim 23, wherein the leads from the rotor hook-up of the oscillator modulator are connected with a plurality of capacitors; and the motor stator is connected to a 3-phase output of the power generator.

25. The power generator of claim 24, wherein the 3-phase voltage and current from the rotor insert oscillates into and out of the capacitors across the leads, thereby stabilizing the power output of the power generator.

26. A method of generating power using the power generator of any one of claims 5-25, comprising the steps of:
determining an excitation cycle based on a target frequency of the power generator;
executing the excitation cycle by providing a current to one or more of the wires according to a predefined sequence to align magnetic domains of the salient pole pieces of the rotor to produce an evolving moving magnetic flux field; and
routing a resultant current, generated by the magnetic flux field, to a power output;
wherein the strength of the magnetic flux field is evolving and increasing as the magnetic domains align; and
wherein the maximum strength of the evolving magnetic flux field is at least four times greater than the strength of the electromagnetic alignment field providing the energy for the moving magnetic poles which power the stator.

27. The method of claim 26, further comprising the step of routing a portion of the resultant current to the energy storage device.

28. The method of claim 27, further comprising routing a portion of the output power from the power generator back into the excitation circuit.
